(19) United States
(12) Patent Application Publication
(10) Pub. No.: US 2026/0030283 A1
(43) Pub. Date: Jan. 29, 2026

(54) SYSTEM AND METHOD FOR FACILITATING EXPANSION OF KNOWLEDGE

(71) Applicant: Eubalaena LLC, Middletown, DE (US)

(72) Inventors: James Webster, New Bedford, MA (US); Patrick G. Heck, Needham, MA (US); Amnon Meyers, Los Angeles, CA (US)

(21) Appl. No.: 19/118,318

(22) PCT Filed: Oct. 4, 2023
(86) PCT No.: PCT/US2023/075939

§ 371 Date: Apr. 3, 2025

Related U.S. Application Data
(60) Provisional application No. 63/378,559, filed on Oct. 6, 2022.

(51) Int. Cl. G06F 16/35; G06F 16/334; G06F 40/284

(52) U.S. Cl. CPC G06F 16/35; G06F 16/334; G06F 40/284

(57) ABSTRACT

A system and computer-implemented method facilitate expansion of knowledge. The system allows for characterization of natural language documents and of search queries to locate those documents. A natural language processing (NLP) analyzer finds subject-verb-object (SVO) triplets in received text and assigns initial hierarchical classifications to word components of the SVO triplets. An SVO analyzer generates variation hierarchical classifications by varying the initial hierarchical classifications assigned, selects at least one hierarchical classification from the initial hierarchical classifications and variation hierarchical classifications, and produces a token stream of tokens. The tokens represent respective hierarchical classifications of the at least one hierarchical classification selected. The token stream produced may represent a natural language (NL) document to be stored to facilitate matching the NL document to a subsequently independently specified query. Alternatively, the token stream produced may represent a query and the token stream is used for generating a response to the query.

### RELATED APPLICATION

This application claims the benefit of U.S. Provisional Application No. 63/378,559, filed on Oct. 6, 2022. The entire teachings of the above application are incorporated herein by reference.

### BACKGROUND

More and more information is becoming digitized and stored by databases, servers, and other storage media, and accessible to users via networks, including the Internet. When a user seeks certain information, it is useful to provide the most relevant information in the shortest time. As a result, search engines have been developed in an attempt to provide same in response to a user query.

Some search engines operate by indexing keywords in documents. These documents may include, for example, web pages, and other electronic documents. A typical search engine may find these documents on public networks, such as the World Wide Web (WWW), newsgroups, and the like. Users typically enter words, phrases or the like, sometimes with Boolean connectors, as queries, on an interface, such as a Graphical User Interface (GUI), associated with a particular search engine. A typical search engine may isolate certain words (i.e., keywords) in the queries and search for occurrences of those keywords in its indexed set of documents. Keywords are words or groups of words that are used to identify data or data objects. As a result of the search, the search engine may then return one or more listings to the GUI. Such listings typically include a hypertext link to a targeted web site or document. Such a hypertext link, if clicked by the user, directs a browser in use by the user to the targeted web site or document.

Some search engines have moved away from keyword searching by allowing a user to enter a query in natural language. Natural language includes groups of words that humans use in their ordinary and customary course of communication, such as in normal everyday communication (general purpose communication) with other humans. Search engines that allow a query to be entered in natural language may employ a template-based system, knowledge-based system, or combination thereof. Template-based systems employ a variety of question templates, each of which is responsible for handling a particular type of query. These templates take the natural language entered and couple it with keywords for performing a search.

Conventional knowledge-based systems are similar to template-based systems and utilize knowledge that has been previously captured to improve on searches that would utilize keywords in the query. For example, a search using the keyword “cats” might be expanded by a knowledge-based system by adding the word “feline” from a knowledge base that associates “cats” with “felines.” In another example, the keyword “veterinarians” and the phrase “animal doctor” may be synonymous, in accordance with the knowledge base.

### SUMMARY

A system and computer-implemented method facilitate expansion of knowledge. The system allows for characterization of natural language documents and of search queries to locate those documents. A natural language processing (NLP) analyzer finds subject-verb-object (SVO) triplets in received text and assigns initial hierarchical classifications to word components of the SVO triplets. An SVO analyzer generates variation hierarchical classifications by varying the initial hierarchical classifications, selects at least one hierarchical classification from the initial hierarchical classifications and variation hierarchical classifications and produces a token stream of tokens, the tokens representing respective hierarchical classifications of the at least one hierarchical classification selected. The token stream may represent a query or a natural language document to be searched in response to the query.

According to an example embodiment, a system comprises a natural language processing (NLP) analyzer configured to find subject-verb-object (SVO) triplets in received text, assign initial hierarchical classifications to word components of the SVO triplets found, and output the initial hierarchical classifications assigned. The system further comprises an SVO analyzer configured to generate variation hierarchical classifications by varying the initial hierarchical classifications assigned and output by the NLP analyzer. The SVO analyzer is further configured to select at least one hierarchical classification from the initial hierarchical classifications and variation hierarchical classifications and produce a token stream of tokens, the tokens representing respective hierarchical classifications of the at least one hierarchical classification selected. It should be understood that an SVO triplet referenced herein covers a quadruple and larger tuple of words including the SVO triplet.

The system may be an ingestion engine configured to output the token stream produced. The SVO analyzer may be further configured to select the at least one hierarchical classification based on at least one configuration parameter of the system or based on user input. The token stream produced may represent a natural language (NL) document to be stored to facilitate matching the NL document to a subsequent independently specified search query, wherein the search query is not known at the time the token stream is produced. It should be clear that the system accepts arbitrary queries, and is not processing data to find answers for a known query or set of known queries.

The system may be a search engine configured to generate a response to a query. The token stream produced may represent the query and may be used for generating the response to the query. The query may represent an entire NL document or a portion of the NL document for non-limiting example.

An initial hierarchical classification of the initial hierarchical classifications assigned may include an initial subject hierarchical classification, initial verb hierarchical classification, and initial object hierarchical classification assigned to a subject, verb, and object, respectively, of a SVO triplet of the SVO triplets found. The initial subject, verb, and object hierarchical classifications may represent an initial subject sense, initial verb sense, and initial object sense for the subject, verb, and object, respectively, of the SVO triplet.

The NLP analyzer may be further configured to access a lexical database to assign the initial hierarchical classifications. In an event the at least one hierarchical classification selected includes an initial hierarchical classification of the initial hierarchical classifications, the token stream produced may include a token that represents the initial subject, verb, and object hierarchical classifications, in combination. In an event the at least one hierarchical classification selected includes at least one variation hierarchical classification generated by varying the initial hierarchical classification, the token stream produced may include at least one other token representing the at least one variation hierarchical classification. The at least one other token may precede or follow the token in the token stream in an event the token and at least one other token are produced in the token stream. The at least one variation hierarchical classification may represent at least one of: a different subject hierarchical classification, different verb hierarchical classification, or different object hierarchical classification. The different subject, verb, and object hierarchical classifications are different from the initial subject, verb, and object hierarchical classifications, respectively. The different subject, verb, and object hierarchical classifications represent a different subject sense, different verb sense, and different object sense, respectively, for the subject, verb, and object, respectively. The different subject, verb, and object senses are different from the initial subject, verb, and object senses, respectively. The different subject, verb, and object senses may be classified in the lexical database as being more commonly used subject, verb, and object senses relative to the initial subject, verb, and object senses, respectively.

An initial hierarchical classification of the initial hierarchical classifications assigned may include an initial subject hierarchical classification, initial verb hierarchical classification, and initial object hierarchical classification assigned to a subject, verb, and object, respectively, of a SVO triplet of the SVO triplets found. In an event the at least one hierarchical classification selected includes the initial hierarchical classification, the token stream produced may include a token that represents the initial subject, verb, and object hierarchical classifications assigned, in combination. In an event the at least one hierarchical classification selected includes at least one variation hierarchical classification generated by varying the initial hierarchical classification, the token stream produced may include at least one other token representing the at least one variation hierarchical classification. In an event the token and the at least one other token are produced in the token stream, the at least one other token may precede or follows the token in the token stream.

For non-limiting example, a variation hierarchical classification of the at least one variation hierarchical classification may represent the initial subject hierarchical classification assigned in combination with the initial verb hierarchical classification assigned and the initial object hierarchical classification assigned (e.g., SVO).

The variation hierarchical classification may represent a variation of the initial subject hierarchical classification assigned in combination with the initial verb hierarchical classification assigned and the initial object hierarchical classification assigned (e.g., S*VO, where ‘*’ denotes variation in the present disclosure).

The variation hierarchical classification may represent the initial subject hierarchical classification assigned in combination with a variation of the initial verb hierarchical classification assigned and the initial object hierarchical classification assigned (e.g., SV*O).

The variation hierarchical classification may represent the initial subject hierarchical classification assigned in combination with the variation of the initial verb hierarchical classification assigned and a variation of the initial object hierarchical classification assigned (e.g., SV*O*).

The variation hierarchical classification may represent the variation of the initial subject hierarchical classification assigned in combination with the variation of the initial verb hierarchical classification assigned and the initial object hierarchical classification assigned (e.g., S*V*O).

The variation hierarchical classification may represent the initial subject hierarchical classification assigned in combination with the initial verb hierarchical classification assigned and the variation of the initial object hierarchical classification assigned (e.g., SVO*).

The variation hierarchical classification may represent the variation of the initial subject hierarchical classification assigned in combination with the initial verb hierarchical classification assigned and the variation of the initial object hierarchical classification assigned (e.g., S*VO*).

The variation hierarchical classification may represent the variation of the initial subject hierarchical classification assigned in combination with the variation of the initial verb hierarchical classification assigned and the variation of the initial object hierarchical classification assigned (e.g., S*V*O*).

The variation hierarchical classification may represent the initial subject hierarchical classification assigned in combination with the initial verb hierarchical classification assigned (e.g., SV). The variation hierarchical classification may represent the variation of the initial subject hierarchical classification assigned in combination with the initial verb hierarchical classification assigned (e.g., S*V). The variation hierarchical classification may represent the initial subject hierarchical classification assigned in combination with the variation of the initial verb hierarchical classification assigned, namely (e.g., SV*). The variation hierarchical classification may represent the variation of the initial subject hierarchical classification assigned in combination with the variation of the initial verb hierarchical classification assigned (e.g., S*V*).

The variation hierarchical classification may represent the initial subject hierarchical classification assigned in combination with the initial object hierarchical classification assigned (e.g., SO). The variation hierarchical classification may represent the variation of the initial subject hierarchical classification assigned in combination with the initial object hierarchical classification assigned (e.g., S*O). The variation hierarchical classification may represent the initial subject hierarchical classification assigned in combination with the variation of the initial object hierarchical classification assigned (e.g., SO*). The variation hierarchical classification may represent the variation of the initial subject hierarchical classification assigned in combination with the variation of the initial object hierarchical classification assigned (e.g., S*O*).

The variation hierarchical classification may represent the initial verb hierarchical classification assigned in combination with the initial object hierarchical classification assigned (e.g., VO). The variation hierarchical classification may represent the variation of the initial verb hierarchical classification assigned in combination with the initial object hierarchical classification assigned (e.g., V*O). The variation hierarchical classification may represent the initial verb hierarchical classification assigned in combination with the variation of the initial object hierarchical classification assigned (e.g., VO*). The variation hierarchical classification may represent the variation of the initial verb hierarchical classification assigned in combination with the variation of the initial object hierarchical classification assigned (e.g., V*O*).

The variation hierarchical classification of the at least one variation hierarchical classification may represent the initial subject hierarchical classification assigned or variation thereof (e.g., S or S*). The variation hierarchical classification may represent the initial verb hierarchical classification assigned or variation thereof (e.g., V or V*). The variation hierarchical classification may represent the initial object hierarchical classification assigned or variation thereof (e.g., O or O*).

A variation hierarchical classification of the variation hierarchical classifications generated may be generated for an initial hierarchical classification of the initial hierarchical classifications assigned. The initial hierarchical classification may have a depth (e.g., number of delimiters for non-limiting example) in a hierarchy. The variation hierarchical classification may include a portion of the initial hierarchical classification and may have a different depth relative to the depth in the hierarchy.

The variation hierarchical classifications generated may include at least one higher-level hierarchical classification. The at least one higher-level hierarchical classification may be higher in a hierarchy relative to an initial hierarchical classification of the initial hierarchical classifications assigned. The initial hierarchical classification may be assigned to a subject, verb, or object of a SVO triplet of the SVO triplets found.

At least one higher-level hierarchical classification may be a truncated version of the initial hierarchical classification.

The NLP analyzer may be further configured to access a lexical database to assign the initial hierarchical classifications. The hierarchy may be associated with entries of the lexical database. The at least one higher-level hierarchical classification and initial hierarchical classification may be associated with a same syntactic category associated with the hierarchy.

The system may comprise an inverted index. The tokens may be pre-analyzed tokens. The SVO analyzer may be further configured to pre-analyze the text to produce the pre-analyzed tokens for indexing in the inverted index and produce the token stream in JavaScript Object Notation (JSON) format or other data format, the token stream including the pre-analyzed tokens. The system may be configured to decode the JSON format or other data format to extract the pre-analyzed tokens from the token stream produced and store the tokens in the inverted index for use in responding to a query. The other data format may be yet another markup language (YAML), extensible markup language (XML), or a custom text or binary format for non-limiting examples.

The text may be from a natural language (NL) document. The SVO analyzer may be further configured to include metadata in the token stream produced. The metadata may include information specifying where the NL document can be obtained. The system may be further configured to store the metadata in association with the tokens in the inverted index.

The NLP analyzer may be further configured to determine absolute and relative locations of the word components of the SVO triplets found in the text. The SVO analyzer may be further configured to select absolute and relative locations from the absolute and relative locations determined and include the selected absolute and relative locations in the token stream produced. The selected absolute and relative locations may be associated with respective word components of a SVO triplet associated with the at least one hierarchical classification selected.

The text may be from a query, the SVO triplets may be query SVO triplets, the tokens may be query tokens, the token stream may be a query token stream, and the inverted index may be created from document token streams. The document token streams include document tokens derived from document SVO triplets in documents and relating the document tokens to the documents. The system may be further configured to generate the response to the query based on matching the query tokens of the query token stream against the document tokens of document token streams via the inverted index.

The query may be received from a user and the system may be further configured to employ a similarity method configured to match the query tokens against the document tokens via the inverted index. The system may be further configured to output a response to the query. The response may allow at least a portion of a document of the documents to be located by the user in an event the similarity method determines that the at least a portion of the document is similar to the query. The similarity method may be a standard best matching (BM) 25 method, other standard best matching method, or custom similarity method.

The at least a portion of the document may include at least one statement from the document, at least one paragraph from the document, a combination of the at least one statement and at least one paragraph from the document, or the document itself.

The NLP analyzer may be further configured to employ a lexical database to assign the initial hierarchical classifications and the hierarchical classifications may be assigned based on respective categories to which the component words of the SVO triplets belong in the lexical database. The initial hierarchical classifications assigned may be represented by respective delimiter-separated numbers. The respective delimiter-separated numbers indicate respective hierarchical classifications of a plurality of hierarchical classifications of a hierarchical classification system. The plurality of hierarchical classifications capture relationships within and across hypernymic levels of words of the lexical database.

The system may further comprise a lexical database of semantic relations between words. Entries of the lexical database may be assigned respective hierarchical classifications of a plurality of hierarchical classifications based on the semantic relations between the words. The NLP analyzer may be further configured to access the lexical database to assign the initial hierarchical classifications to the word components of the SVO triplets and the initial hierarchical classifications assigned may be among the plurality of hierarchical classifications. The entries may include WordNet® (lexical database) entries and supplemental entries. The supplemental entries may include word content sourced from at least one language resource specific to at least one type of knowledge domain.

The NLP analyzer may be a multi-pass text analyzer. Multiple passes of the NLP analyzer may be configured to execute sequentially or in parallel to elaborate a parse tree. The multiple passes may be further configured to cooperate, enabling the NLP analyzer to process the text in order to find the SVO triplets.

The parse tree represents patterns found within the text by the NLP analyzer. The multiple passes may include respective rules. The multiple passes may be configured to execute respective methods, the respective methods may be configured to employ the respective rules.

The multiple passes are configured to access the parse tree, modify the parse tree, access a knowledge base (KB), modify the KB, or combination thereof. The KB is a lexical database serving as a repository of lexical information. The NLP analyzer may be further configured to employ the KB to assign the hierarchical classifications.

The NLP analyzer may be configured to modify the KB, dynamically, based on information derived by the NLP analyzer via processing of the text by the multiple passes.

The NLP analyzer may be a multi-pass text analyzer. The multiple passes of the NLP analyzer may be configured to execute respective methods and a method of the respective methods may be configured to output the SVO triplets found to the SVO analyzer. The method may be further configured to output the SVO triplets in JSON format or another data format.

At least one method of the respective methods may be configured to process the text based on at least one grammatical context. The at least one grammatical context may include noun phrases.

The system may further comprise a text extractor configured to extract the text from a document received by the system. The SVO analyzer may be further configured to provide the text extracted to the NLP analyzer. The text may be from an NL document and the system may further comprise an NL input component configured to store content of the NL document in a data structure. The content may include the text and metadata. The text extractor may be configured to extract plain text from the data structure. The text may be the plain text extracted. The system may further comprise a field manipulator configured to alter fields of the data structure by renaming field content of the fields, formatting field content of the fields, or a combination thereof. The system may further comprise a field aggregator and duplicator configured to aggregate and duplicate fields of the data structure.

The data structure may include at least one multimap or other data structure that encodes a relationship between a key and at least one value. The SVO triplets may be stored as the at least one value for the key in the multimap or other data structure.

The text may be from an NL document. The NL document may be stored in a data source. The system may further comprise an NL input component configured to store content of the NL document in a data structure in response to pulling the NL document from the data source or in response to a push of the NL document to the NL input component.

The text may be from an NL document to be searched to determine similarity to a query. The text may be at least one statement from the NL document, a paragraph from the NL document, or text of the entire document. Alternatively, the text may be from a query. The query may be at least one statement, a paragraph, or an entire document.

According to another example embodiment, a computer-implemented method comprises finding subject-verb-object (SVO) triplets in received text, assigning initial hierarchical classifications to word components of the SVO triplets found, and outputting the initial hierarchical classifications assigned. The computer-implemented method further comprises generating variation hierarchical classifications by varying the initial hierarchical classifications assigned and output. The computer-implemented method further comprises selecting at least one hierarchical classification from the initial hierarchical classifications and variation hierarchical classifications. The computer-implemented method further comprises producing a token stream of tokens, the tokens representing respective hierarchical classifications of the at least one hierarchical classification selected.

The computer-implemented method may further comprise outputting the token stream produced. The selecting may be based on at least one configuration parameter or user input. The token stream produced may represent a natural language (NL) document to be stored to facilitate matching the NL document to a subsequent independently specified search query, wherein the search query is not known at the time the token stream is produced.

The computer-implemented method may further comprise generating a response to a query, wherein the token stream produced represents the query and is used for generating the response to the query. The query may represent an entire NL document or a portion of the NL document for non-limiting example.

Alternative method embodiments parallel those described above in connection with the example system embodiment.

According to another example embodiment, a system comprises an ingestion engine including an ingestion instance of a natural language processing (NLP) analyzer. The ingestion instance is configured to find document subject-verb-object (SVO) triplets in document text of a natural language (NL) document and assign initial document hierarchical classifications to the document SVO triplets found. The ingestion engine is further configured to generate variation document hierarchical classifications by varying the initial document hierarchical classifications, select at least one document hierarchical classification from the initial and variation document hierarchical classifications, and produce document tokens, the document tokens representing respective document hierarchical classifications of the at least one document hierarchical classification selected. The system further comprises a search engine including a search instance of the NLP analyzer. The search engine is configured to store the document tokens in an inverted index. The search instance is configured to find query SVO triplets in query text of a query and assign initial query hierarchical classifications to the query SVO triplets found. The search engine is further configured to generate variation query hierarchical classifications by varying the initial query hierarchical classifications, select at least one query hierarchical classification from the initial and variation query hierarchical classifications, and produce query tokens representing respective query hierarchical classifications of the at least one query hierarchical classifications selected. The search engine is further configured to respond to the query based on results of matching the query tokens against the document tokens via the inverted index. According to an example embodiment, the ingestion engine and search engine may be implemented on a single device or computer platform and may, for non-limiting example, be implemented by at least one processor executing on the single device or computer platform. Alternatively, processing of the ingestion engine and search engine may be distributed amongst a plurality of devices or computer platforms.

The ingestion engine may be further configured to pre-analyze the document SVO triplets for indexing in the inverted index and output a document token stream (i.e., stream of tokens) including the document tokens. The document token stream may be encoded in JavaScript Object Notation (JSON) format or another data format and the search engine may be further configured to decode the JSON format or other data format to extract the document tokens from the document token stream and store the pre-analyzed document SVO triplets in the inverted index. It should be understood, however, that the document token stream is not limited to being encoded in JSON format.

The document token stream may include metadata. The metadata may include information specifying where the NL document can be obtained. The search engine may be further configured to store the metadata in association with the document SVO triplets in the inverted index.

The document token stream may further include absolute and relative locations of component words of the document SVO triplets found in the document text and associated with the at least one document hierarchical classification selected. The ingestion instance of the NLP analyzer may be further configured to determine the absolute and relative locations.

The search engine may be further configured to produce a query token stream. The query token stream includes the query tokens produced. The query token stream may further include absolute and relative locations of component words of the query SVO triplets found in the query text and associated with the at least one query hierarchical classification selected. The search instance of the NLP analyzer may be further configured to determine the absolute and relative locations.

The search instance of the NLP analyzer is further configured to process the query text in a same manner used by the ingestion instance to process the document text. The search instance enables the query tokens to represent the query SVO triplets and query hierarchical classifications assigned thereto to be produced in a format that is comparable to the document tokens for the matching.

The query may be received from a user. The search engine may be further configured to employ a similarity method configured to match the query tokens against the document tokens via the inverted index and output a response to the query. The response may allow at least a portion of the NL document to be located by the user in an event the similarity method determines that the at least a portion of the NL document is similar to the query based on the document and query hierarchical classifications assigned to the document SVO triplets and query SVO triplets, respectively.

The similarity method may be a standard best matching (BM) 25 method, other standard best matching method, or custom similarity method.

The at least a portion of the NL document may include at least one statement from the NL document, at least one paragraph from the NL document, a combination of the at least one statement and at least one paragraph from the NL document, or the NL document itself.

The NLP analyzer may be configured to employ a lexical database to assign the initial document hierarchical classifications. The initial document hierarchical classifications may be assigned to enable the document SVO triplets to be indexed in the inverted index based on respective categories to which component words of the document SVO triplets belong in the lexical database.

The initial and variation document hierarchical classifications and initial and variation query hierarchical classifications may be represented by respective delimiter-separated numbers. The respective delimiter-separated numbers may be dot-notation expressions for non-limiting example. It should be understood that numbers of the respective delimiter-separated numbers need not be separated by a dot (i.e., period) and may be separated by any character that serves as a delimiter. The respective delimiter-separated numbers may indicate respective hierarchical classifications of a plurality of hierarchical classifications of a hierarchical classification system. The plurality of hierarchical classifications may capture relationships within and across hypernymic levels of words of a lexical database.

The system may further comprise a lexical database of semantic relations between words. Entries of the lexical database may be assigned respective hierarchical classifications of a plurality of hierarchical classifications based on the semantic relations between the words. The ingestion and search instances of the NLP analyzer may be configured to access the lexical database to assign the initial document hierarchical classifications and initial query hierarchical classifications to the document SVO triplets and query SVO triplets, respectively. The initial document hierarchical classifications and initial query hierarchical classifications assigned are among the plurality of hierarchical classifications.

The entries may include WordNet® entries and supplemental entries. The supplemental entries include word content sourced from at least one language resource specific to at least one type of knowledge domain.

The NLP analyzer may be a multi-pass text analyzer. Multiple passes of the NLP analyzer may be configured to execute sequentially or in parallel to elaborate a parse tree. The multiple passes may be further configured to cooperate to enable the ingestion and search instances of the NLP analyzer to process the document text and query text, respectively, in order to find the document SVO triplets or query SVO triplets, respectively.

The parse tree may represent patterns found within the document text or query text by the NLP analyzer. The multiple passes may include respective rules. The multiple passes may be configured to execute respective methods. The respective methods may be configured to employ the respective rules.

The multiple passes may be configured to access the parse tree, modify the parse tree, access a knowledge base (KB), modify the KB, or combination thereof. The KB is a lexical database serving as a repository of lexical information. The NLP analyzer may be further configured to employ the KB to assign the document or query hierarchical classifications.

The NLP analyzer may be configured to modify the KB, dynamically, based on information derived by the NLP analyzer via processing of the document text or query text by the multiple passes.

The NLP analyzer may be a multi-pass text analyzer. Multiple passes of the NLP analyzer may be configured to execute respective methods. A method of the respective methods may be configured to output the document or query SVO triplets found. The method may be further configured to output the document or query SVO triplets in JSON format or another data format. At least one method of the respective methods may be configured to process the document text or query text based on at least one grammatical context. The at least one grammatical context may include noun phrases.

The ingestion engine may be further configured to employ an ingestion instance of an SVO analyzer and the ingestion instance of the NLP analyzer. The ingestion engine may include a text extractor configured to extract the document text of the NL document. The ingestion engine may be configured to provide the document text extracted to the ingestion instance of the NLP analyzer. The ingestion instance of the SVO analyzer may be configured to produce a document token stream including the document tokens produced.

The search engine may be further configured to employ a search instance of the SVO analyzer and the search instance of the NLP analyzer. The search engine may be configured provide the query text to the search instance of the NLP analyzer and the search instance of the SVO analyzer may be configured to produce a query token stream including the query tokens based on query SVO triplets found by the search instance of the NLP analyzer.

The ingestion engine may include an NL input component configured to store content of the NL document in a data structure. The content may include the document text and metadata. The ingestion engine may further include a text extractor configured to extract plain text from the data structure, wherein the document text is the plain text extracted. The ingestion instance may further include a field manipulator configured to alter fields of the data structure by renaming field content of the fields, formatting field content of the fields, or a combination thereof. The ingestion instance may further include a field aggregator and duplicator configured to aggregate and duplicate fields of the data structure.

The data structure may include at least one multimap or other data structure that encodes a relationship between a key and at least one value. The SVO triplets may be stored as the at least one value for the key in the multimap or other data structure.

The NL document may be stored in a data source. The ingestion engine may include an NL input component. The NL input component may be configured to store content of the NL document in a data structure in response to pulling the NL document from the data source or in response to a push of the NL document to the NL input component.

The query may be at least one statement, a paragraph, or an entire document.

The query may be received from a user. The search engine may be further configured to output a response to the query, the response directing the user to retrieve the NL document in an event matching the query tokens against the document tokens via the inverted index produces a match result indicating that the NL document and query have similar text.

The ingestion engine may be implemented via multiple compute machines. The multiple compute machines may be coupled in a manner enabling the multiple compute machines to cooperate and perform functions of the ingestion engine.

The ingestion engine may be further configured to select the at least one document hierarchical classification based on at least one configuration parameter of the ingestion engine or based on user input.

The search engine is further configured to select the at least one query hierarchical classification based on at least one configuration parameter of the search engine or based on user input.

According to another example embodiment, a computer-implemented method may comprise employing an ingestion instance of a natural language processing (NLP) analyzer to find subject-verb-object (SVO) triplets in document text of a natural language (NL) document and assigning initial hierarchical classifications to the SVO triplets found. The computer-implemented method may further comprise generating variation document hierarchical classifications by varying the initial document hierarchical classifications assigned. The computer-implemented method may further comprise selecting at least one document hierarchical classification from the initial document hierarchical classifications and the variation document hierarchical classifications. The computer-implemented method may further comprise producing document tokens representing respective document hierarchical classifications of the at least one document hierarchical classification selected. The computer-implemented method may further comprise employing a search instance of the NLP analyzer to find query SVO triplets in query text of a query and assigning initial query hierarchical classifications to the query SVO triplets found. The computer-implemented method may further comprise generating variation query hierarchical classifications by varying the initial query hierarchical classifications assigned. The computer-implemented method may further comprise selecting at least one query hierarchical classification from the initial query hierarchical classifications and the variation query hierarchical classifications The computer-implemented method may further comprise producing query tokens representing respective query hierarchical classifications of the at least one query hierarchical classification selected, storing the document tokens in an inverted index, and responding to the query based on results of matching the query tokens against the document tokens via the inverted index.

Alternative method embodiments parallel those described above in connection with the example system embodiment.

According to another example embodiment, a system may comprise an input interface and a processor. The processor may be configured to employ a natural language processing (NLP) analyzer to find subject-verb-object (SVO) triplets in document text of a natural language (NL) document and assign initial hierarchical classifications to the SVO triplets found. The NL document is received via the input interface. The processor may be further configured to generate variation hierarchical classifications by varying the initial hierarchical classifications assigned. The processor may be further configured to select at least on hierarchical classification from the initial hierarchical classifications and variation hierarchical classifications. The processor may be further configured to produce a token stream including tokens, the tokens representing respective hierarchical classifications of the at least one hierarchical classification selected and output the document token stream produced.

According to another example embodiment, a system comprises an inverted index created from received token streams, the received token streams including subject-verb-object (SVO) derived tokens relating the SVO derived tokens to documents. The system further comprises a processor configured to load document tokens into the inverted index. The document tokens are included in a document token stream received by the system. The document tokens represent respective document hierarchical classifications of document SVO triplets found in a natural language (NL) document. The processor is further configured to implement a natural language processing (NLP) analyzer. The NLP analyzer is configured to find query SVO triplets in query text of a query and assign initial query hierarchical classifications to the query SVO triplets found. The processor is further configured to generate variation query hierarchical classifications by varying the initial query hierarchical classifications assigned and to select at least one query hierarchical classification from the initial query hierarchical classifications and the variation query hierarchical classifications. The processor is further configured to produce query tokens representing respective hierarchical classifications of the at least one query hierarchical classification selected, and respond to the query based on results of matching the query tokens against the document tokens via the inverted index to determine relevancy of the NL document to the query.

According to another example embodiment, a computer-implemented method comprises transforming a natural language (NL) document into an electronic transmission based on spatio-temporal relationships (e.g., linguistic positional, proximity, and ordering relationships) of subject-verb-object (SVO) triplets in the NL document. The electronic transmission includes hierarchical classifications assigned to component words of the SVO triplets. The spatio-temporal relationships are represented by positional and ordering relationships of the SVO triplets in the NL document. The computer-implemented method further comprises transmitting the electronic transmission to a search engine for storage in an inverted index. The hierarchical classifications enable the search engine to determine, via the inverted index, relevancy of the NL document to a query and direct a user to the NL document based on the relevancy to the query determined.

According to yet another example embodiment, a computer-implemented method for word-sense disambiguation comprises deriving a plurality of subject-verb-object (SVO) triplets from a SVO triplet of a natural language (NL) document. The SVO triplet has a subject, verb, and object component. The deriving of the plurality of SVO triplets is based on respective multi-sense meanings for the subject, verb, and object components. The computer-implemented method further comprises determining a least ambiguous SVO triplet from among the plurality of SVO triplets derived. The least ambiguous SVO triplet represents respective meanings for the subject, verb, and object components of the SVO triplet as used within a context of the NL document.

The deriving of the plurality of SVO triplets may be based on respective hierarchical classifications assigned to the respective multi-sense meanings in a lexical database.

The lexical database may include entries from a WordNet® database.

The entries may include noun entries, wherein the noun entries include a first set of entries describing abstractions and a second set of entries describing physical entities. The first set may be numbered prior to the second set effecting the first set of entries, describing the abstractions, to be at a higher hierarchical level relative to the second set of entries, describing the physical entities.

The noun entries may include a third set of entries describing causal agents. The third set may be numbered as a last hierarchical level of the second set of entries describing the physical entities.

The entries may include verb entries in each of the fifteen WordNet® verb categories. The verb entries may be numbered in an ascending numerical sequence from one to fifteen representing relative transitivity levels of the verb entries relative to one another.

The deriving may include creating a matrix in memory. The matrix may depict at least a portion of all possible permutations resulting from the respective multi-sense meanings for the subject, verb, and object components of the SVO triplet.

The computer-implemented method may further comprise applying standard Hamiltonian mechanics to each SVO permutation in the matrix, the Hamiltonian mechanics ranking the SVOs from highest to least according to combinations of respective potential energies assigned to the subject and object components of the SVO triplet and a kinetic energy assigned to the verb component of the SVO triplet.

The determining may include applying mathematical optimization techniques to the matrix. The mathematical optimization techniques may be related to currency arbitraging. The applying enables the least ambiguous SVO triplet to be determined.

It should be understood that example embodiments disclosed herein can be implemented in the form of a method, apparatus, system, or computer readable medium with program codes embodied thereon.

Further example embodiments and details are provided in a document entitled “Supplement: System and Method for Facilitating Expansion of Knowledge,” filed as part of U.S. Provisional Application No. 63/378,559 filed on Oct. 6, 2022, the entire teachings of which are incorporated herein by reference.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example embodiment of a system.

FIG. 1B is a block diagram of an example embodiment of a system in a computing environment.

FIG. 2 is a block diagram of another example embodiment of components of a computing environment.

FIG. 3A is a block diagram of an example embodiment of a system that may be employed as an ingestion engine disclosed herein.

FIG. 3B is a block diagram of an example embodiment of a system that may be employed as an ingestion engine disclosed herein.

FIG. 3C is a table of example hierarchical classifications assigned to WordNet® entries in accordance with an example embodiment.

FIG. 4 is a block diagram of an example embodiment of cross-mapping among life sciences language resources.

FIG. 5-1 is a table of WordNet® entries cross-mapped to semantic network entries according to an example embodiment.

FIGS. 5-2 through 5-20 are continuations of the table of FIG. 5-1.

FIG. 6A is a block diagram of an example embodiment of a natural language processing (NLP) analyzer with multiple passes.

FIG. 6B is a block diagram of the NLP analyzer of FIG. 6A and an example embodiment of a knowledge base management system.

FIG. 7 is a labeled screen shot of an example embodiment of a development environment for the NLP analyzer of FIGS. 6A and 6B.

FIG. 8A is a data flow diagram of an example embodiment of data flow and processing.

FIG. 8B is a flow diagram of an example embodiment of a method that may be implemented by an ingestion engine disclosed herein.

FIG. 9 is a flow diagram of an example embodiment of a method for producing a response to a query.

FIG. 10A is a high-level flow diagram of an example embodiment of a computer-implemented method.

FIG. 10B is a flow diagram of another example embodiment of a computer-implemented method.

FIG. 10C is a flow diagram of yet another example embodiment of a computer-implemented method.

FIG. 10D-1 is a flow diagram of an example embodiment of a computer-implemented method for producing a token stream.

FIG. 10D-2 is a continuation of the flow diagram of FIG. 10D-1.

FIG. 10D-3 is a continuation of the flow diagram of FIG. 10D-2.

FIG. 11 is a listing of example JavaScript object notation (JSON) produced for an example subject-verb-object (SVO) triplet according to an example embodiment.

FIG. 12-1 is a listing of example JSON representing a token stream for the SVO triplet of FIG. 11 according to an example embodiment.

FIGS. 12-2 through 12-18 are continuations of the listing of FIG. 12-1.

FIG. 13 is a table of example WordNet® verb categories reordered to reflect transitivity according to an example embodiment.

FIG. 14 is a block diagram of an example embodiment of reordering for the WordNet® noun categories “abstract entity” and “physical entity.”

FIG. 15 is a block diagram of an example embodiment of reordering for the WordNet® noun category “causal_agent.”

FIG. 16 is a matrix with example disambiguated results for an SVO triplet according to an example embodiment.

FIG. 17 is a prior art arbitraging graph.

FIGS. 18A-C are tables with example conversions of Unified Medical Language System (UMLS) “T” categories to WordNet® categories according to an example embodiment.

FIG. 19 is a table of example lexicographic relationships of nouns in the WordNet® database.

FIG. 20A is a table of example lexicographic relationships of verbs in the WordNet® database.

FIG. 20B is a continuation of the table of FIG. 20A.

FIG. 21 is a schematic diagram of a Bloch sphere representation of a qubit.

FIG. 22 is a schematic diagram of an example embodiment of spin-orbit mapping of an SVO.

FIG. 23 is a prior art equation with clauses for quantum annealing.

FIG. 24 is a table of entries showing cross mapping from WordNet® names to Medical Subject Headings according to an example embodiment.

FIG. 25 is a flow diagram of another example embodiment of a computer-implemented method.

FIG. 26 is a block diagram of an example internal structure of a computer optionally within an embodiment disclosed herein.

### DETAILED DESCRIPTION

A description of example embodiments follows.

In the context of the disclosure, “push,” “pushed,” “pushing,” or variations thereof, causes data to be sent without a request being made for such data, whereas “pull,” “pulls,” “pulled,” “pulling,” and variations thereof, includes the request for the data. A “document” may be any structured digitized information, including textual material or text, and existing as a single sentence or portion thereof, for example, a phrase, to multiple sentences or portions thereof, and may also include images, graphs, or other non-textual material. “Sentences” include formal sentences having subjects and verbs, as well as fragments, phrases, and combinations of one or more words. A “word” includes a known dictionary defined word, a slang word, acronym, words in contemporary usage, words specific to a domain, such as a medical domain, etc. A hierarchical classification disclosed herein may be described or represented as a hierarchical “numeric” classification. It should be understood however, that a hierarchical classification is not limited to a numeric representation and may be represented via numerical characters, alphabetical characters, alphanumeric characters, or other characters. Further, it should be understood that numerical descriptors, such as “first,” “second,” “third,” etc., are used herein to differentiate, generically, elements with a same name. Such numerical descriptors do not designate order of such elements unless explicitly stated herein.

Most of the world's current knowledge is stored in electronic repositories and much of that knowledge is stored as unstructured text. Information systems for retrieving such knowledge rely on artificially or manually crafted databases or probabilistic single-word based techniques to deliver query responses. The failure of current systems to leverage structure already existing in language offers significant opportunities for improvement over traditional information retrieval (IR) systems.

Specifically, traditional IR systems fail to account for structure arising from the fact that knowledge is not merely information contained in “key words” but is derived from the assembly of subject, verb, and object words into complete thoughts, namely subject-verb-objects (SVOs). While statements which lack one or more of these components (dependent clauses) often contain valuable information, the most structured and reliable source for conveying knowledge is the complete thought statement (the “independent clause”). An example embodiment disclosed herein captures complete thought statements in the form of SVOs (whose component words are keyed to retain their absolute and relative relationships) while at the same time extracting value from parsing dependent clauses related to SVOs.

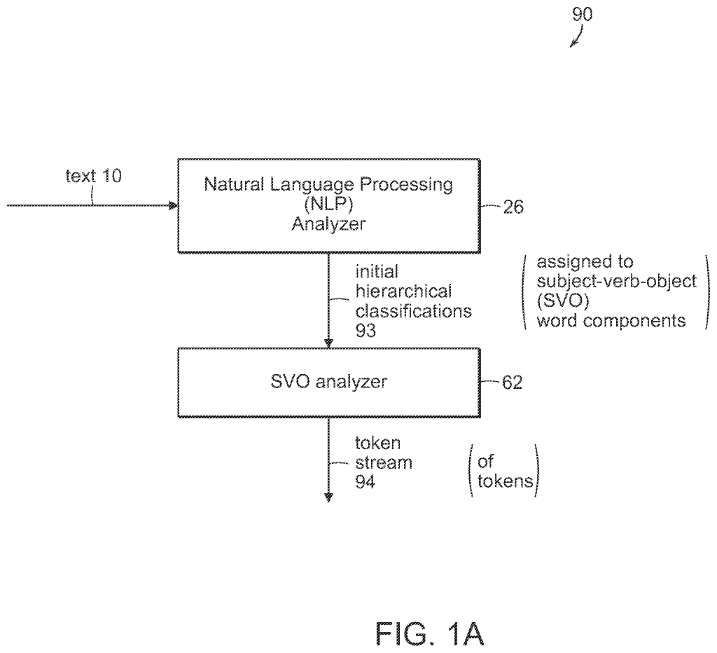

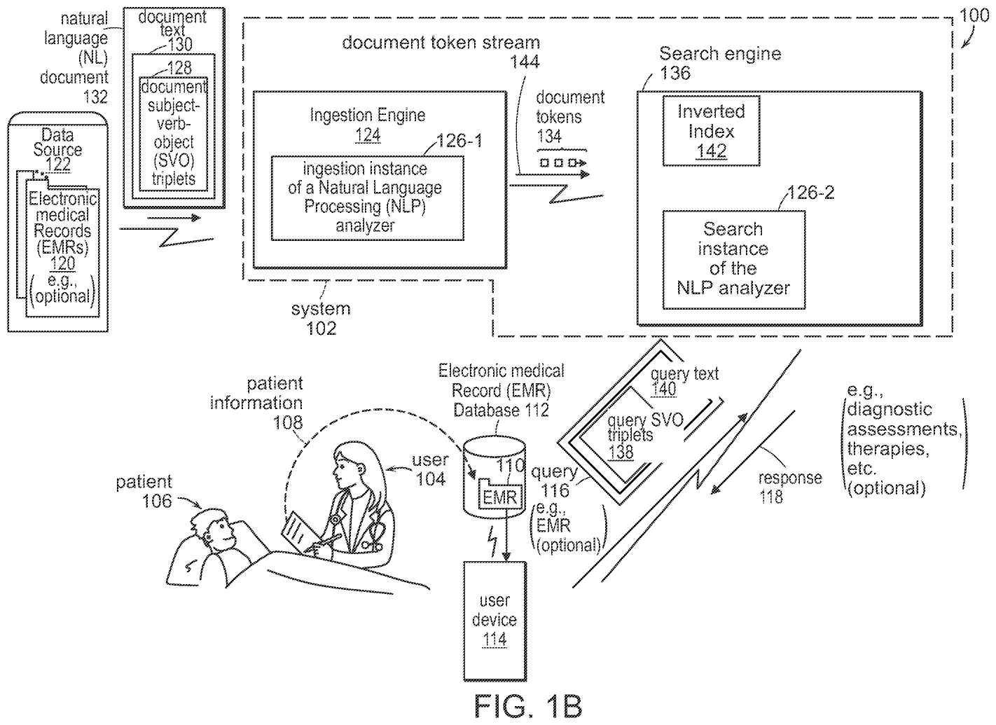

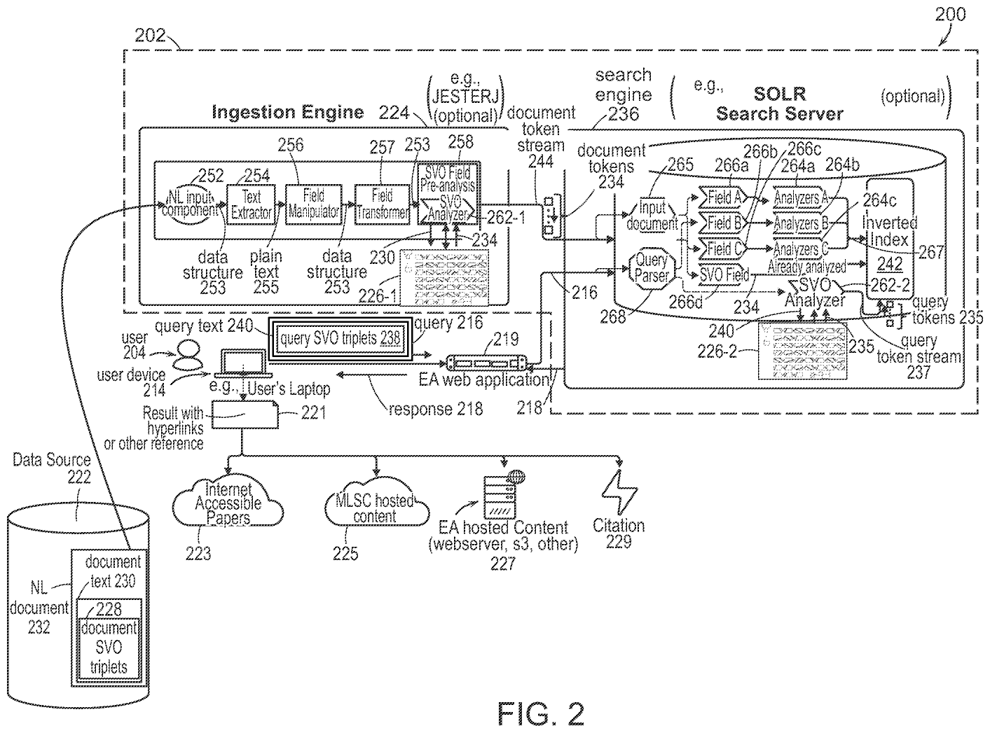

Artificial intelligence—machine learning—is a highly desired goal for nearly all knowledge domains. It is, however, gained sequentially in a linear fashion pursuant to which important knowledge components are “learned” and then added to acquire additional knowledge. A priori knowledge, knowledge on which language is based, can best be produced by evaluating SVOs in the context in which they occur. To achieve this, an SVO may be treated by an ingestion engine, disclosed further below with regard to FIG. 1A, 1B, and FIG. 2, in the context of each paragraph in which it occurs. In effect, this allows the SVO to be viewed as a subsystem of a larger system (paragraph) which, in turn, can be treated as a subsystem of the document in which it occurs; documents can in turn be treated as subsystems of the entire system (repository) in which they occur.

An example embodiment remedies a failure of traditional IR systems to capture structure produced by the relationships among the words which comprise knowledge assemblies. In traditional IR systems, because retrieval is viewed as the execution of focus on a specific word (or common concatenations of words in standard phrases), there is no perceived need to retain the hierarchical heritage explicit in the natural language, such as the English language for non-limiting example. An example embodiment permits a user to query a document in a format known to the user and returns statements and documents using that format but expressed in relationally relevant (that is, similar) formats. Among the many benefits of example embodiments disclosed herein, an example benefit of employing an example embodiment disclosed herein is the ability to query individual statements as well as entire documents to determine both exact and similar responsive statements and documents.

Philosopher Immanuel Kant's articulation of the mind's use of syntheses to produce knowledge from spatio-temporal relationships (e.g., linguistic positional, proximity, and ordering relationships) remains a leading candidate for understanding how understanding occurs and how knowledge is created.
By the word synthesis, in its most general signification, I understand the process of joining different representations to each other and of comprehending their diversity in one cognition.
   Immanuel Kant, Critique of Pure Reason
      An example embodiment disclosed herein is an automated knowledge tool that implements Kant's template for synthetic knowledge building through integrated processes which capture, organize, and analyze the spatio-temporal relationships—structure—which are explicit in language and classification systems applicable to a document repository. An example embodiment uses these relationships to produce accurate responses to queries seeking identical as well as similarity-based results; and the responses are presented in a familiar perspective that enhances the likelihood of recognition, thus automatically creating knowledge and facilitating its acquisition and transfer. An example embodiment comprises components that provide:
Structuring (generating spatio-temporal relationships) by parsing and converting natural language into machine language that retains the structure of spatio-temporal relationships explicit in language and which are fundamental to knowledge creation and exchange. This process may be performed through a combination of language resource preparation and natural-to-machine language conversion by an ingestion engine, such as the ingestion engine 102 and ingestion engine 202 of FIG. 1B and FIG. 2, respectively, as disclosed further below.
Association (associating spatio-temporal relationships of items) through a storage system whose structure is based on those relationships and not on mathematical engineering. Such association may be performed through an ingestion process which preserves and also pre-analyzes the relationships for use by a search engine, such as the search engine 136 and search engine 236 of FIG. 1B and FIG. 2, respectively, as disclosed further below.
Recognition (recognizing items' spatio-temporal structures) through analytical procedures which allow a user to evaluate query responses (unknown structure) in the context of the user's existing knowledge structure and, thus, enable the user to compare and create additional knowledge. Such recognition may be performed by a search tool, such as a Solr search tool for non-limiting example, which has been configured according to an example embodiment. Such configuration enables the search tool to quickly and accurately find identical and similar matches to queries which are created by applying natural language conversion in the search tool, such as the search engine 136 and search engine 236 of FIG. 1B and FIG. 2, respectively, as disclosed further below.

Using spatio-temporal relationships (structure inherent in language) to create knowledge from knowledge serves as a substitute for the unfulfilled reasoning power of raw logic which must submit ultimately to the inevitable inconclusiveness of recursion because there is no separate language to describe language. Kant's syntheses provide a powerful-albeit intuitive-alternative to “dead-end” or “circular” knowledge queries, such as disclosed further below with regard to FIG. 1B and the known liar paradox.

Most of the world's current knowledge is stored in electronic repositories premised on the proposition that text is unstructured. IR systems created to retrieve that knowledge rely on artificially crafted structuring devices implemented by mathematical techniques to deliver query responses and do not leverage existing structure of language.

An example embodiment enables creation of synthetic knowledge by leveraging Kant's significant contributions to the millennia-long search for understanding how the universality of relationships can be accommodated in thinking. A word represents a component of thought. A thought is a concept statement which collects interrelationships among words. A document is a series of concepts organized according to the purpose of its author. A classification system organizes documents according to a collection structure intended to capture relationships.

These “nesting” hierarchies produce two-dimensional (what comprises the document and where is the document's knowledge located in comparison to knowledge in other documents) and three-dimensional (what does it mean) relationships among concepts and their intended recipients. An example embodiment's approach to structure retains these dimensions and its query mechanisms create synthetic knowledge that, in turn, becomes universally available (e.g., among authorized users) by correlating individual knowledge and vocabulary with the collective knowledge and lexicons of others in a user's initial domain and in other domains. Such universality underlies the development of both understanding and of knowledge acquired through understanding. Existing (what an inquirer knows) is synthetically combined with new (what others know) and from that combination come even further syntheses, thereby facilitating knowledge expansion.

An example embodiment encodes natural language documents into machine language founded on the spatio-temporal relationships explicit in language and classification, preserves the documents in a manner which conforms to the relationships, and employs query techniques which allow a user to transfer and exchange documentary knowledge using a familiar navigation system, such as English for non-limiting example.

Humans grasp the relationships within their physical universe through mapping units and a mapping system which provide a means to navigate it even though they have not constructed anything more than theoretical assessments of its existence. Kant's spatio-temporal structures provide a comparable system for our coming to see, organize, and expand knowledge. An example embodiment leverages spatio-temporal structures to create a virtual universe of knowledge which can be synthesized into additional knowledge.

### Structuring

Relationships are understood through the lens of mapping coordinates (e.g., classification systems) and mapping units (e.g., statements in documents). The latter represent the fundamental items which are found in an example embodiment of a system and the former indicate the respective locations of the units and, thus, impart knowledge of their spatio-temporal relationships. The English language is premised on such structure which an example embodiment may capture via actions taken by the ingestion engine 102 and ingestion engine 202 of FIG. 1B and FIG. 2, respectively, as disclosed further below.

### Preparation of Language Resource

In part because of its ubiquity and in larger part because its creators insured that the hierarchical relationships among words (hypernymy) were preserved in its form and lexicographic connections, the WordNet® database may be selected as the fundamental “skeletal” structure of the language resources employed by an example embodiment disclosed herein. According to an example embodiment, adjustments S1 and S2 may be applied to entries of the WordNet® databases as disclosed below. Such adjustments are disclosed below.

### S1: WordNet® Hierarchy Capture

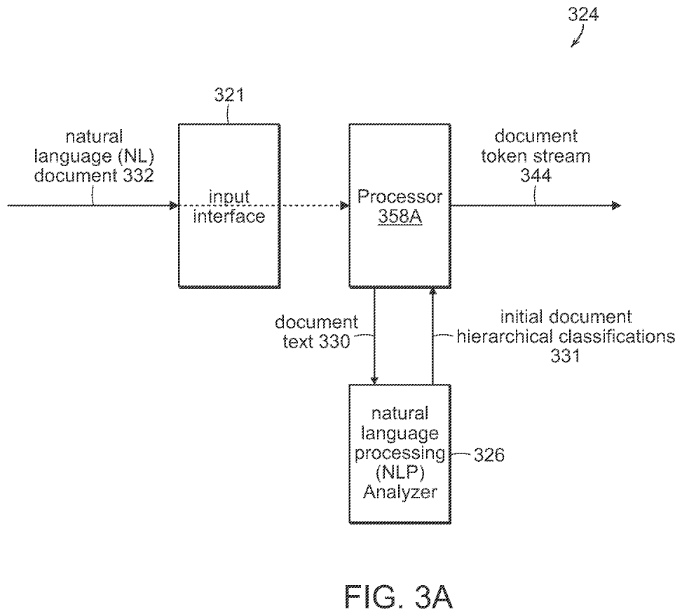

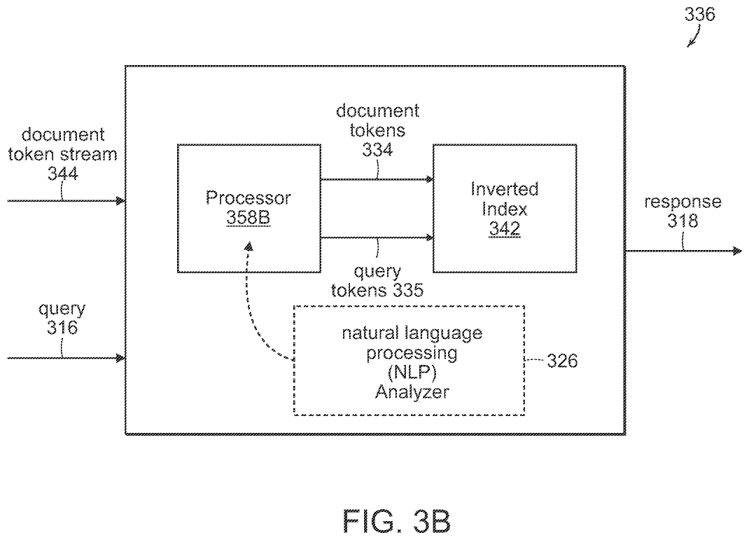

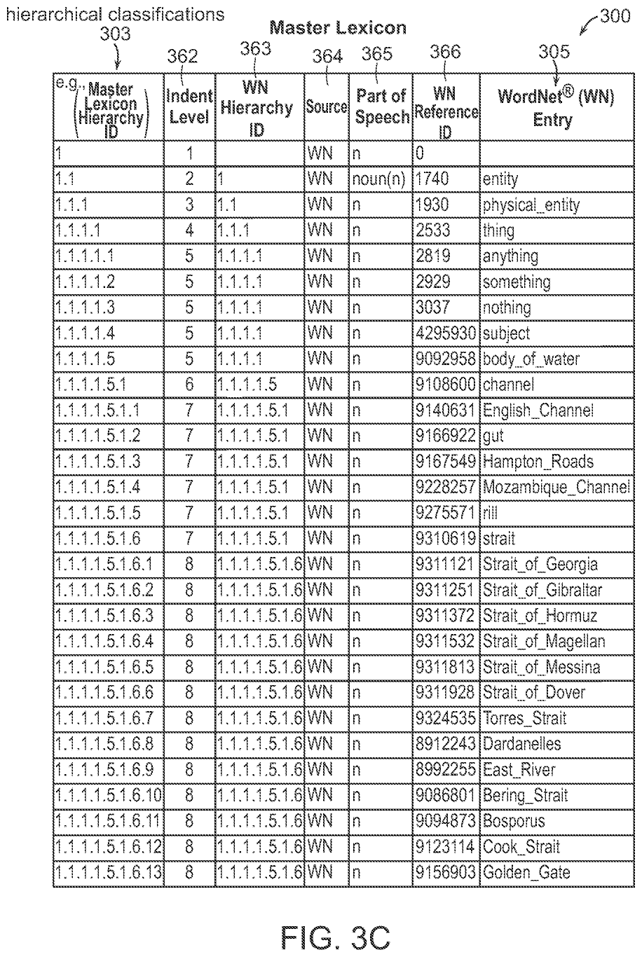

According to an example embodiment, hierarchical classifications, such as numeric designations for non-limiting example, for every WordNet® entry are applied to capture relationships within and across hypernymic levels in the lexicon. FIG. 3C, disclosed further below, is a table of example hierarchical classifications assigned to WordNet® entries and provides an illustration of the hierarchical numbering system applied to WordNet® according to an example embodiment.

### S2: Additional Lexicon Mapping

While the WordNet® database can serve as a framework for language resources, an example embodiment enriches same via additions from language resources which are specific to knowledge domains. Using cross-mapping among WordNet® entries and such lexicons, an example embodiment preserves the relationships (e.g., within and across hypernymic levels in a lexicon) while at the same time making it possible for a user, expert in one domain but not in another, to nevertheless query and obtain other-domain results whose similarity (syntheses) become evident through delivery of responses via an example embodiment of a system, such as the system 102 and system 202 of FIG. 1B and FIG. 2, respectively, disclosed further below. Such cross-mapping is disclosed further below with regard to FIG. 4 and FIGS. 5-1 through 5-20.

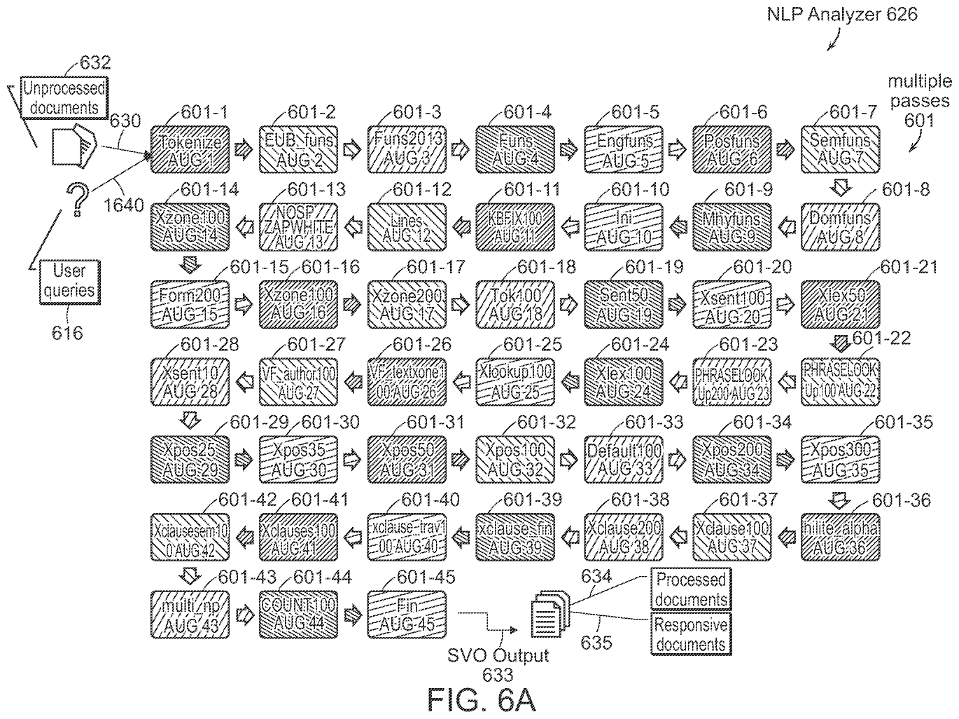

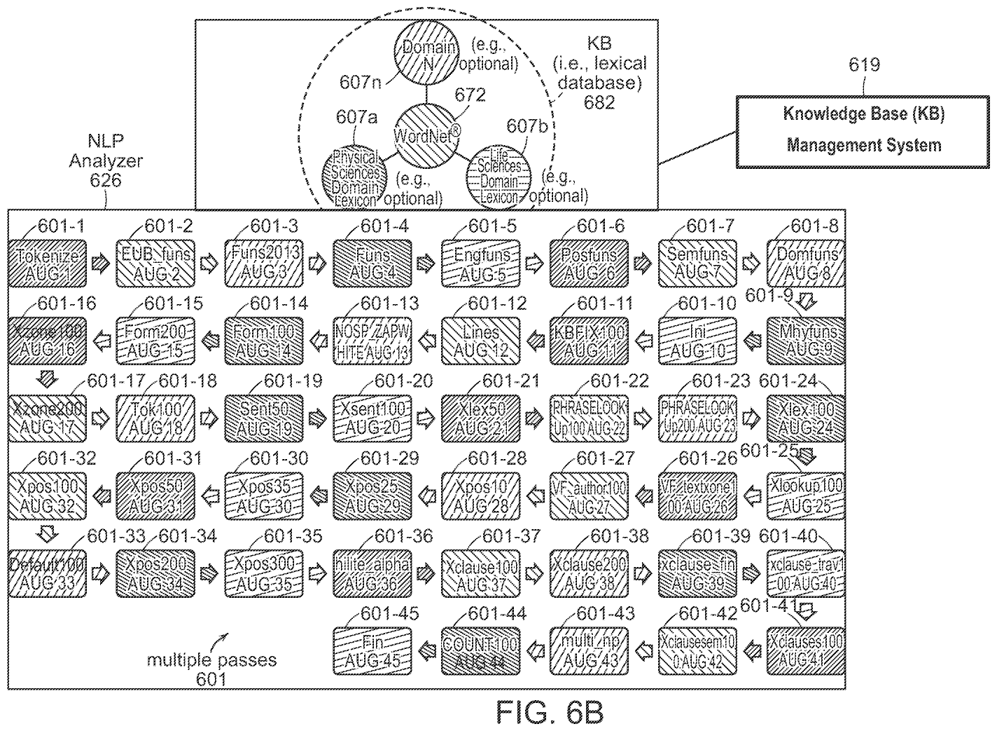

Following completion of the preceding S1 and S2 adjustments, the resulting language resources may be deposited into a knowledge base management system of a natural language processing (NLP) analyzer, such as the NLP analyzer 626 of FIGS. 6A and 6B, disclosed further below, that is employed by a system that creates knowledge by capturing document contents using structure inherent in natural language (NL), such as the system 90, system 102, and system 202 of FIG. 1A, FIG. 1B, and FIG. 2, respectively, disclosed further below.

According to an example embodiment, the output of the NLP analyzer, such as the output 234 and 235 of FIG. 2, disclosed further below, has been organized into an Apache Lucene™ index to make SVO triplets searchable via the open source Apache Solr™ server. An example embodiment of a search engine employs a Solr environment that has been modified and includes the installation of the NLP analyzer for the purposes of converting user queries into formats comparable to the novel previously indexed repository contents produced by an ingestion engine.

According to an example embodiment, SVO entries are indexed (the SVO Token Category Index) according to a classification structure based on the WordNet® lexicon data file (i.e., “lexfile”) category to which the SVO components belong, such as the hierarchical classification 503 of FIGS. 5-1 through 5-20 disclosed further below for non-limiting example. According to an example embodiment, the SVO triplets from the NLP analyzer may be embedded in an Apache Lucene index (inverted index) of a search engine and leveraged to improve the relevancy of search results and provide conceptual search. Such a search may be an SVO triplet search that enables the use of full paragraphs or documents as queries, such as the query 116 of FIG. 1B, disclosed further below. Text of such a query may be processed by a natural language processing (NLP) analyzer, such as the NLP analyzer 26 of FIG. 1A, disclosed below.

FIG. 1A is a block diagram of a system 90 that comprise comprises an NLP analyzer 26 that is configured to find subject-verb-object (SVO) triplets (not shown) in received text 10, assign initial hierarchical classifications 93 to word components of the SVO triplets found, and output the initial hierarchical classifications 93 assigned. The system 90 further comprises an SVO analyzer 62 configured to generate variation hierarchical classifications (not shown) by varying the initial hierarchical classifications 93 assigned and output by the NLP analyzer 26. The SVO analyzer 62 is further configured to select at least one hierarchical classification (not shown) from the initial hierarchical classifications 93 and variation hierarchical classifications and produce a token stream 94 of tokens (not shown), the tokens representing respective hierarchical classifications of the at least one hierarchical classification selected. Generation of such variation hierarchical classifications is disclosed further below with regard to FIG. 11 and FIGS. 12-1 through 12-18. It should be understood that an SVO triplet referenced herein covers a quadruple and larger tuple of words including the SVO triplet.

The SVO analyzer 62 may be further configured to select the at least one hierarchical classification based on at least one configuration parameter (not shown) or based on user input (not shown). The at least one configuration parameter or user input may affect specificity of the at least one hierarchical classification. The at least one configuration parameter or user input may be associated with a domain. For example, verbs may be useful for a particular domain and, as such, the at least one hierarchical classification selected may include variation hierarchical classifications that include variations on an SVO triplet's verb component. The at least one configuration parameter or user input may include a tuning parameter to tune relevancy, such as disclosed further below with regard to FIGS. 12-2 through 12-18.

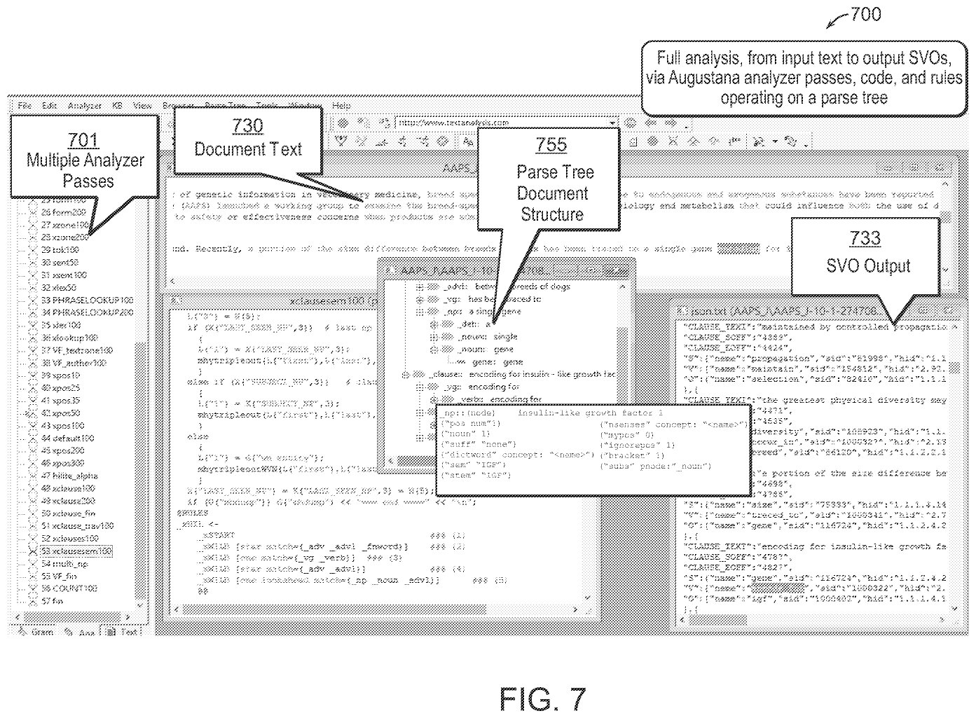

The NLP analyzer 26 may be a multi-pass analyzer further configured to access a lexical database to assign the initial hierarchical classifications 93, such as disclosed further below with regard to FIG. 6A, FIG. 6B, and FIG. 7. The system 90 may be an ingestion engine configured to output the token stream 94 produced, such as the ingestion engine 124 or ingestion engine 224 disclosed below with regard to FIG. 1B and FIG. 2, respectively. The token stream 94 may represent a natural language (NL) document, such as the NL document 132 or NL 232 disclosed below with regard to FIG. 1B and FIG. 2, respectively, to be stored to facilitate matching the NL document to a subsequent independently specified search query, wherein the search query is not known at the time the token stream 94 is produced.

The system 90 may be a search engine configured to generate a response to a query, such as the search engine 136 or search engine 236 disclosed below with regard to FIG. 1B and FIG. 2, respectively. The token stream 94 may represent the query or an NL document to be searched for generating the response to the query. It should be understood that a single system may employ multiple instances of the system 90 to generate both a token stream that represents a NL document(s) to be stored and another token stream that represents a query to match against the NL document(s) to determine similarity thereto. As such, a single system may employ multiple instances of the system 90 to perform the functions of the ingestion engine (132, 232) in combination with functions of the search engine (136, 236) disclosed below with regard to FIG. 1B and FIG. 2.

FIG. 1B is a block diagram of an example embodiment of a system 102 in a computing environment 100. In the computing environment 100, the system 102 facilitates expansion of knowledge. Such a system may be referred to herein as a RosettaWirx™ (Knowledge-Facilitator) system or Eubalaena system. Unlike an information retrieval (IR) system, an example embodiment of the system 102 may create knowledge by capturing document contents using structure inherent in natural language (NL).

### Knowledge-Facilitator Language Resources

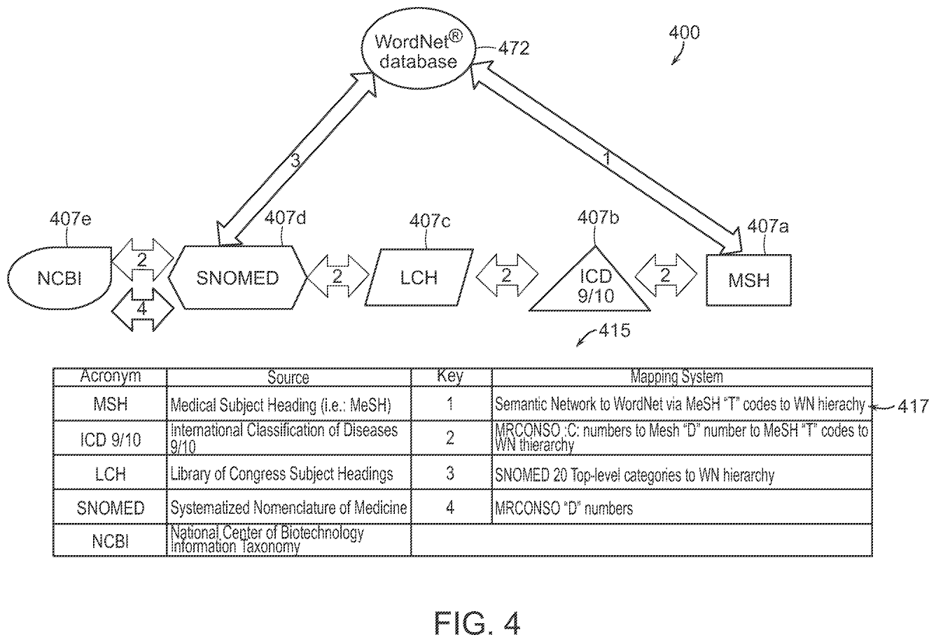

In the system 102, words are appropriately identified in a manner which evidences their inter-definitional relationships; because the mind recognizes both the word and its hierarchical structure, it is useful for the system 102 to do so as well. When mathematical symbols represent words, it is useful to reflect both the identity of the words and their position in the structure of language. An example embodiment of the system 102 may be used for automated knowledge creation and employs an identification (numbering) system, such as the hierarchical classification 503 of FIGS. 5-1 through 5-20, disclosed further below for non-limiting example, which differentiates the attempt at collection from a bag of words, where the listing order is irrelevant (except for accelerating query response times). An example embodiment of the system 102 employs an interrelated lexicon of general and domain-specific language resources to achieve this goal, such as disclosed further below with regard to FIG. 4 for non-limiting example.

An example embodiment of the system 102 employs a WordNet® database which was crafted as an electronic lexicon with a quasi-ontological ordering of nouns, verbs, adjectives, adverbs, and miscellaneous descriptive linguistic attributes: the structuring is hypernymic when possible, categorical when necessary. An example embodiment of the system 102 may employ the WordNet® database as its central “backbone” because, to the extent the English language offers knowledge opportunities from leveraging its hypernymic structure, the WordNet® database is the current optimal starting point. It should be understood, however, that another lexical database may be employed and that embodiments disclosed herein are not limited to employing the WordNet® database.

According to an example embodiment, each WordNet® entry may be assigned a unique identifier (ID) which reflects its position in any applicable hypernymy (ordering structure) as well as its “definitional contents” category. Entries from a plurality of knowledge domains, such as disclosed below with regard to FIG. 4, may be attached to the appropriate portion of the WordNet® tree or category. This process of attaching additional branches to the original word tree maintains the original structure while significantly expanding knowledge creation possibilities. What this means for a user of the system 102, such as the user 104, is that they don't have to ask a question (e.g., query 116) in a certain way in order to find a responsive answer (e.g., response 118). Often, because detailed answers come primarily from highly-specific collections, the “silent intermediary” is the assumption that a user will be familiar with its contents. Knowledge-Facilitator users can ask their questions without concern that a failure to include a “key word” will preclude a meaningful answer. language resources may be included in schemas and indices that “inform” search solutions that the system 102 may offer.

### Natural Language Structure

While IR techniques register “contusion” as a slightly variant of “confusion,” the system 102 may quickly demonstrate the vast difference between the two words, which follows from their definitional differences: one is physical, the other abstract, and neither is related to the other except by the word lengths. As such, a query based on mathematical values produces sense-misleading results. An example embodiment of the system 102 expands its advantage by incorporating additions to domain-specific vocabularies by indexing new entries according to the original hierarchy: every Knowledge-Facilitator language resource entry retains its interrelated mapping location.

### Text Analysis and Subject-Verb-Objects (SVOs) in a Knowledge-Facilitator System

The independent clause (“SVO”: Subject, Verb, and Object), that is, an SVO triplet, is the most atomic but complete object of thought in language. A thought cannot be considered complete without these components but needs no additions to communicate a proposition. The SVO is the fundamental building block of the automated knowledge creation process in a Knowledge-Facilitator system which can “extract” thoughts in a document and use them to assemble identical and similar responses to a user query, such as the query 116 disclosed further below.

An example embodiment of the system 102 employs a natural language processing (NLP) analyzer (text analyzer), such as the NLP analyzer 626 of FIGS. 6A and 6B, disclosed further below, that uses a definition and knowledge base built on the Knowledge-Facilitator language resources to extract SVOs (SVO triplets). The NLP analyzer definition is written in a novel programming language that treats each set of rules and their associated code actions as a single pass in a multi-pass text analyzer, such as disclosed further below with regard to FIGS. 6A and 6B. In effect, the NLP analyzer cascades multiple systems to support the processing of natural language text.

An example embodiment of the NLP analyzer may begin with a parse tree, such as the parse tree 755 disclosed further below with regard to FIGS. 6A, 6B, and 7, that captures the document structure of a document, such as the natural language (NL) document 102 of FIG. 1B, created by its author. The atomic components (SVOs) of each “branch” of the parse tree may be identified and processed by rules based on the language resources in the NLP analyzer; these can execute selectively in contexts (for example, in particular parts of the parse tree) and can recursively nest analyzers within other analyzers. According to an example embodiment, one set of code actions builds and modifies the parse tree for the text being analyzed. Another set of code actions may build semantics, that is, data structures for holding the content discovered in text that is being analyzed.

### Understanding Statements, not Words

According to an example embodiment, the system 102 captures statements as rule-based chains of language resources. The system 102 may leverage the structure-based approach by capturing entire statements. Since each language resource component in a statement is structural, every captured statement is definitionally structural. As such, an example embodiment of the system 102 captures words as well as the interrelationships among statements. This results in the ability to compare all statements against each other and to rank their relevance among themselves, even if the language resources used in their individual formulations are not identical.

### Queries in a Knowledge-Facilitator System

An example embodiment of the system 102 may use the Apache Solr search platform, referred to interchangeable herein as “Solr,” for its search capabilities. It should be understood, however, that a search platform/engine disclosed herein is not limited to the Apache Solr search platform. Extremely popular for keyword search, search-related features, and analytics, Solr is used as the basis of large search and big-data platforms at major companies and governments. It is based on Apache Lucene, which is used even more broadly.

Solr comes with a large suite of text analysis components (tokenizers, stemmers, etc.), but it doesn't know about the particular machine forms of the Knowledge-Facilitator language resources nor does it know about SVO forms or how to query them. An example embodiment of the system 102 includes a plug-in to Solr with the following components:
a custom analyzer that communicates with the text analysis technology mentioned previously. This produces SVOs and some other part of speech forms. For each word, the custom analyzer, such as the ingestion instance of the NLP analyzer 126-1 disclosed further below, produces identifiers and metadata as found in the language resources. As a Lucene Analyzer for non-limiting example, this analyzer ultimately produces tokens, position numbers, and other metadata that ultimately get indexed into Lucene in ways designed to be searched efficiently; and
a custom query parser that uses an instance of the aforementioned NLP analyzer, namely the search instance of the NLP analyzer 126-2 disclosed further below, that is used to compose Lucene queries to find similar text. It incorporates various strategies to affect the relevancy score of each match based on how close the indexed document is to the search query—e.g., considering how many levels in the taxonomy there is between the query and indexed word.

In addition to using the rapid query response found in all Solr installations, an example embodiment of a Knowledge-Facilitator implementation of Solr offers many deployment options:
system integrators should be able to plug Knowledge-Facilitator technology into an existing Solr installation (perhaps other Lucene-based platforms as well) with relative ease as the interface to Solr remains unchanged
domain-specific and specialty-purpose environments, housed in enterprise or cloud venues, can provide a unique, secure and proprietary means of creating knowledge for authorized users.

Solr search techniques abound in current query environments. An example embodiment of the system 102 takes Solr to new levels of speed and accuracy with its emphasis on the “naturally occurring” structure of language. An immediate benefit of this emphasis is that there is no need for monolithic data warehousing mechanisms and, as such, no need for a NoSQL (also known as “not only structured query language (SQL)”) database or other type of database for storing same.

### Benefits of a Knowledge-Facilitator System

An example embodiment of the system 102 encodes text produced by any electronic source into machine language which mimics the relationships explicit in language and classification, preserving the text in a manner which conforms to the relationships, and employs query techniques which allow a user, such as the user 104, to transfer and exchange documentary knowledge using a familiar navigation tool, such as English, for non-limiting example. As such, the system 102 may be viewed as performing automated knowledge creation.

As a replacement for or supplement to traditional search engines, an example embodiment of the system 102 offers users knowledge, rather than data. Such knowledge can be provided in the context of specific domains, relationships among specified domains, or across a comprehensive ontology of knowledge networks. When intensive and extensive attribute properties are affixed to its language resources, an example embodiment of the system 102 can be used prospectively for dynamic modeling in both human (for example, intelligence assessment) and non-human (e.g., cancer cell signaling) environments.

Science convinced its followers that anything that could not be proved could not be valued. Therefore, since only numbers could be proved, only numbers-not language-, could be valued. Information retrieval (IR) techniques adopted this tautology and reduced it to “index but don't value words.” This approach could not avoid the dilemmas arising when numbers “meet themselves.” Best illustrated by the known liar paradox, a logical paradox version that results from consideration of statements of the form “This sentence is false.”—If the statement is true, then it is false, whereas if it is false, then it is true.—amply demonstrates the problem—recursion—which happens when the structure of words is not adequately represented. The paradox is a linguistic sleight of hand which disguises the facts that a) while it is a sentence, it is not a statement and b) nothing in it can be true or false, since only statements communicate propositions which can be true of false. Like the paradox, IR systems do not make “sense.” An example embodiment of the system 102 disclosed herein assigns values to the meaning (senses) of words and, thus, avoids the problems that arise from randomly assigning machine code to language entries. The result is greatly improved response values which produce knowledge, thereby facilitating expansion of knowledge.

IR systems convert individual words into machine language which has only the structure added by mathematical and database engineering techniques. In contrast to an IR system, an example embodiment of the system 102 can capture statements as a series of rule-based chains which are fundamental components of knowledge: statements utilize the meaning of words and the rules of communication developed over millennia in human-speech patterns to build documents which, in turn, build knowledge. An example embodiment of the system 102 reverses the decades-long approach used in IR (assign structure to otherwise unrelated machine-code substitutes for individual words) by identifying the knowledge structure in natural-language statements and maintaining that structure with machine language that mimics it.

An example embodiment of the system 102 may produce identical matches in response to a user requesting factual responses, and further excels in answering “what's like this” type user questions. An example embodiment may treat such user questions as conceptual queries which are really asking: “How can I learn more?” In the system 102, conceptual responses may be based on similarities between the known (as expressed in a user query) and the unknown (responses as expressed by others). The system 102 may treat a response to a user's knowledge query as a fundamental opportunity for knowledge transfer: similarities among statements (and documents) and provide a path—determined by logical (hierarchical) comparisons using machine language that mirrors natural language—for delivering relevant content.

Put simplistically, an example embodiment of the system 102 may produce the kind of response to a query which seeks knowledge rather than facts: “here's how others have answered your question, though they might have used different words and examined your question in different ways.” Relevancy—the closeness between query and response—is a function of the inter-definitional relationships. IR systems use forms of mathematical techniques (fuzzy or proximity, for example) to produce responses based on probabilities. Similarity in the system 102 may be based on definitional logic rather than such probability techniques. As a result, a user of the system 102, such as the user 104 of FIG. 1B, gains knowledge from others by combining the previously known with the newly discovered, such as disclosed below.

In the example embodiment of FIG. 1B, the user 104 is a doctor treating a patient 106 for non-limiting example. The doctor is collecting patient information 108 from the patient 106, such as symptoms for non-limiting example, that is stored in an electronic medical record (EMR) 110 of the patient 106. The EMR 110 is stored in an EMR database 112 that is accessible to the user 104 via a user device 114. The user device 114 may be any electronic communications device, such as a tablet, desktop computer, cell phone, etc. for non-limiting example. The EMR 110 may include additional information regarding the patient 106, such as an assessment plan of treatment, diagnostic reports (e.g., imaging, laboratory, pathology, etc.), vital signs, immunizations, history of medical procedures, medications, care team members, patient demographics, etc. for non-limiting example. In the example embodiment, the doctor, that is, the user 104 of the system 102, inputs a query 116 to the system 102 via the user device 114 and receives a response 118 thereto. The response 118 may be produced in HyperText Markup Language (HTML) format, such as HTML5 for non-limiting example, to enable display on a display screen (not shown) of the user device 114 that may be web-enabled electronic device for non-limiting example.

According to a non-limiting example, the query 116 may be the EMR 110 of the patient 106 or portion thereof and the response 118 may include or direct the user 104 to content from other electronic medical records (EMRs) 120 stored in a data source 122 and deemed to be similar to the patient's EMR 110, for example based on a similarity score. Such content may include diagnostic assessments, successful therapies, etc. for non-limiting example. In this way, the system 102 can facilitate knowledge expansion by enabling the user 104 to gain knowledge from others by combining the previously known, for example, content from the patient's EMR 110, with the newly discovered, namely similar content from the other EMRs 120 associated with another patient(s) that may have a similar ailment as the patient 106. It should be understood, however, that the user 104 of the system 102 is not limited to a doctor and that the query 116 and response 118 are not limited to health-related documents or health-related information. The example use case described above is a non-limiting example of a use case for the system 102 which is disclosed in detail below.

The system 102 comprises an ingestion engine 124 and a search engine 136. The ingestion engine 124 and/or search engine 136 may be implemented via respective or shared single or multiple compute machines including respective processor(s). The respective multiple compute machines may be coupled in a manner enabling the respective multiple compute machines to cooperate and perform respective functions of the ingestion engine 124 or search engine 136. The ingestion engine 124 and search engine 136 may be communicatively coupled via a wired or wireless network for non-limiting example. The ingestion engine 124 and search engine 136 may be co-located and implemented via a single computing machine or multiple machines. According to an example embodiment, processing of the ingestion engine 124 and search engine 136 may be divided among machines for non-limiting example. An example embodiment of the ingestion engine 124 and/or search engine 136 may implemented by a central processor unit (CPU), graphics processing unit (GPU), quantum processing unit (QPU), or combination thereof, as disclosed further below.

The system 102 comprises an ingestion engine 124 that includes an ingestion instance of a natural language processing (NLP) analyzer 126-1, such as the NLP analyzer 626 disclosed further below with regard to FIGS. 6A and 6B. Such an instance may be a Java® process being executed by a processor on the ingestion engine 124. It should be understood, however, that the ingestion instance of the NLP analyzer 126-1 is not limited to a Java process and may be another type of process or thread implementing the NLP analyzer, such as the NLP analyzer 626 of FIGS. 6A and 6B disclosed further below, on the ingestion engine 124.

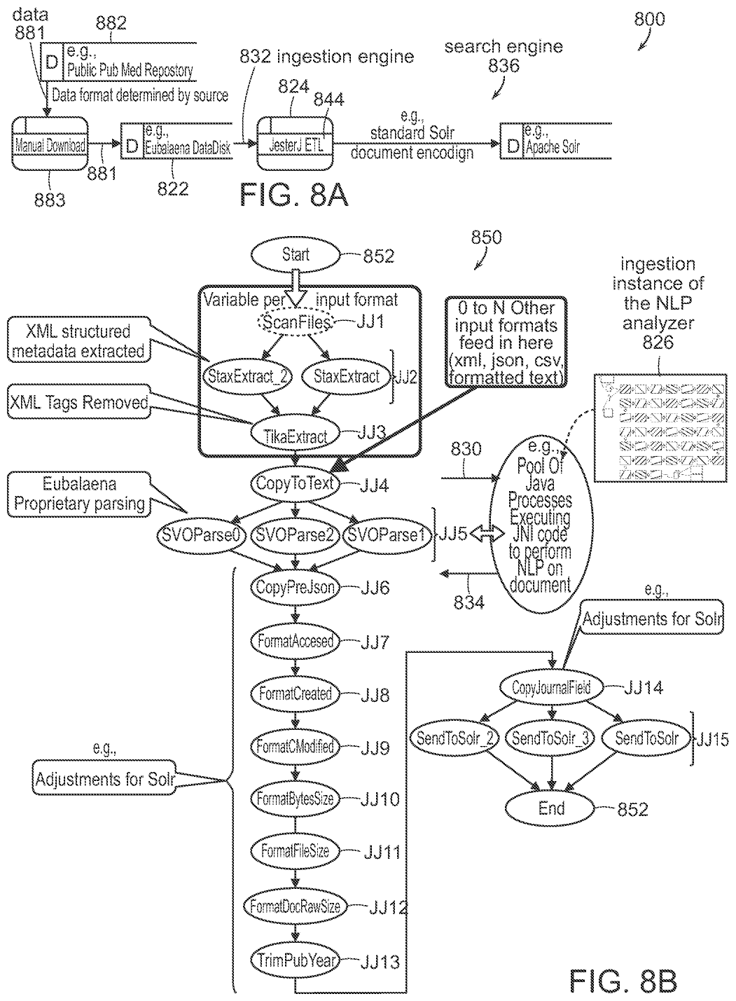

Documents are processed by the ingestion engine 124 (ingestion tool) which has been configured to automate the invocation of the NLP analyzer 626 via spawning of instances thereof across a set of documents, including the creation of a Java Native Interface Binding for the NLP analyzer that can be invoked during document processing for non-limiting example. According to an example embodiment, the ingestion engine 124 (association component) may be configured to acquire additional metadata from xml-structured portions of the processed documents, such as disclosed further below with regard to FIG. 8B.

According to the example embodiment of FIG. 1B, the ingestion instance of the NLP analyzer 126-1 is configured to find document subject-verb-object (SVO) triplets 128 in document text 130 of a natural language (NL) document 132 and assign initial document hierarchical classifications (not shown) to the document SVO triplets 128 found. The ingestion engine 124 is configured to generate variation document hierarchical classifications (not shown) by varying the initial document hierarchical classifications and to select at least one document hierarchical classification (not shown) from the initial and variation document hierarchical classifications. The ingestion engine 124 is further configured to produce document tokens 134 representing respective document hierarchical classifications of the at least one document hierarchical classification selected.

The system 102 further comprises a search engine 136 configured to store the document tokens 134 in an inverted index 142. The search engine 136 includes a search instance of the NLP analyzer 126-2. Such an instance may be a Java process being executed by a processor on the search engine 136. It should be understood, however, that the search instance of the NLP analyzer 126-2 is not limited to a Java process and may be another type of process or thread implementing the NLP analyzer, such as the NLP analyzer 626 of FIGS. 6A and 6B, disclosed further below, on the search engine 136 (recognition component).

According to the example embodiment of FIG. 1B, the search instance of the NLP analyzer 126-2 is configured to find query SVO triplets 138 in query text 140 of a query 116 and assign initial query hierarchical classifications (not shown) to the query SVO triplets 138 found. The search engine 136 is configured to generate variation query hierarchical classifications (not shown) by varying the initial query hierarchical classifications and to select at least one query hierarchical classification (not shown) from the initial and variation query hierarchical classifications. The search engine 136 is further configured to produce query tokens (not shown) representing respective query hierarchical classifications of the at least one query hierarchical classification selected, and to respond to the query 116 based on results of matching the query tokens against the document tokens 134 via the inverted index 142. A similarity score may be determined via means known in the art to the query 116 in a manner that directs the user 104 to the NL document 232 based on its similarity (e.g., similarity score) to the query 116.

The purpose of storing an index is to optimize speed and performance in finding relevant documents for a search query, such as the query 116. Without an index, the search engine 136 would scan every document in a corpus, which would require considerable time and computing power. In contrast to an index in which documents may point to content, in an “inverted” index, such as the inverted index 142, content maps to documents. According to an example embodiment, the search engine 136 may comprise a search cluster to process the query 116. For example, N machines each hosting one or more slices of the inverted index 142 may be employed and each machine may process the query 116 and compare the query 116 to its respective slice of the inverted index 142, sending back M results. Although typically deployed one node per machine, it should be understood that more than one software node may be deployed per machine, such as 16 nodes on 8 machines for non-limiting example. An original receiving (“coordinating”) node of the N machines may, for example, receive the query 116 and then distribute the query to the other machines of the N machines. Such other machines may send respective results back to the coordinating machine which may, in turn, be configured to sort the N×M results and return the top M results from that sort. The search instance of the NLP analyzer 126-2 may, for non-limiting example, run on the coordinating machine, while multiple machines may be involved in the overall processing.

The ingestion engine 124 may be further configured to pre-analyze the document SVO triplets 128 for indexing in the inverted index 142 and output a document token stream 144 including the document tokens 134. The document token stream 144 may be encoded in JavaScript Object Notation (JSON) format or other data format and the search engine 136 may be further configured to decode the JSON format or other data format to extract the document tokens 134 from the document token stream 144 and store the pre-analyzed document SVO triplets 128 in the inverted index 142. It should be understood, however, that the document token stream 144 is not limited to being encoded in JSON format.

The document token stream 144 may include metadata (not shown). The metadata may include information specifying where the NL document 132 can be obtained. The search engine 136 may be further configured to store the metadata in association with the document SVO triplets 128 in the inverted index 142. The document token stream 144 may include absolute and relative locations of component words of the document SVO triplets 128 found in the document text 130 and associated with the at least one document hierarchical classification selected. The ingestion instance of the NLP analyzer 126-1 may be further configured to determine the absolute and relative locations. According to an example embodiment, the document token stream 144 represents at least a portion of all possible SVO permutations which result from multiple sense meanings of the SVO components of the SVO triplets 128 found in the document text 130 and represents the at least one document hierarchical classification selected from the initial document hierarchical classifications assigned to the respective subject, verb, and object components of and SVO and the variation hierarchical classifications of the SVO permutations. Such SVO permutations may be generated by the ingestion instance of the SVO analyzer 162-1.

The search engine 136 may be further configured to produce a query token stream, such as the query token stream 237 that includes the query tokens 235 disclosed further below with regard to FIG. 2. The query token steam 237 may include absolute and relative locations of component words of the query SVO triplets 138 found in the query text 140. The search instance of the NLP analyzer 126-2 may be further configured to determine such absolute and relative locations.

The search instance of the NLP analyzer 126-2 is further configured to process the query text 140 in a same manner used by the ingestion instance of the NLP analyzer 126-1 to process the document text 130. The search instance of the NLP analyzer 126-2 enables the query tokens to represent the query SVO triplets 138 via query hierarchical classifications assigned thereto and produces such query tokens in a format that is comparable to a respective format employed for the document tokens 134 to enable the matching.

The search engine 136 may be further configured to employ a similarity method (not shown) that is configured to match the query tokens against the document tokens 134 via the inverted index 142 and output the response 118 to the query 116. The response 118 may allow at least a portion of the NL document 132 to be located by the user 104 in an event the similarity method determines that the at least a portion of the NL document 132 is similar to the query 116, such similarity determined by a processor (not shown) based on the at least one document hierarchical classification selected and the at least one query hierarchical classification selected with regard to the document SVO triplets 128 and query SVO triplets 138, respectively.

The similarity method may be a standard best matching (BM) 25 method for non-limiting example, other standard best matching method, or custom similarity method. The at least a portion of the NL document 130 may include at least one statement (not shown) from the NL document 130, at least one paragraph (not shown) from the NL document 130, a combination of the at least one statement and at least one paragraph from the NL document 130, or the NL document 130 itself.

To produce the document token stream 144, the ingestion engine 124 may be further configured to employ an ingestion instance of an SVO analyzer, such as the ingestion instance of the SVO analyzer 262-1, disclosed below with regard to FIG. 2.

FIG. 2 is a block diagram of another example embodiment of components of a computing environment 200. In the computing environment 200, such components are visualized as cloud platforms. The computing environment 200 includes a system 202 that may be employed as the system 102 of FIG. 1B, disclosed above. As such, the system 202 comprises an ingestion engine 224 including an ingestion instance 226-1 of an NLP analyzer. The ingestion instance 226-1 is configured to find document SVO triplets 228 in document text 230 of an NL document 232. The ingestion instance of the NLP analyzer 226-1 is further configured to assign initial document hierarchical classifications (not shown) to the document SVO triplets 228 found. The ingestion engine 224 is configured to generate variation document hierarchical classifications (not shown) by varying the initial document hierarchical classifications and to select at least one document hierarchical classification (not shown) from the initial and variation document hierarchical classifications.

The ingestion engine 224 is further configured to produce document tokens 234 that represent respective document hierarchical classifications of the at least one document hierarchical classification selected. The system 202 further comprises a search engine 236 configured to store the document tokens 234 in an inverted index 242. The search engine 236 includes a search instance of the NLP analyzer 226-2. The search instance of the NLP analyzer 226-2 is configured to find query SVO triplets 238 in query text 240 of a query 216. The search instance of the NLP analyzer 226-2 is further configured to assign initial query hierarchical classifications (not shown) to the query SVO triplets 238 found and forward the initial query hierarchical classifications to a search instance of an SVO analyzer 262-2 configured to produce a query token stream 237 including query tokens 235.

According to an example embodiment, the query token stream 235 represents at least a portion of all possible SVO permutations which result from multiple sense meanings of the SVO components of the query SVO triplets 238 found in the query text 216 and represents the query hierarchical classifications assigned to the respective subject, verb, and object components of the at least a portion of the SVO permutations. Such SVO permutations may be generated by the search instance of the SVO analyzer 262-2.

The search engine 236 is configured to generate variation query hierarchical classifications (not shown) by varying the initial query hierarchical classifications and to select at least one query hierarchical classification (not shown) from the initial and variation query hierarchical classifications. The search engine 236 is further configured to produce the query tokens 235. The query tokens 235 represent respective query hierarchical classifications of the at least one query hierarchical classification selected. The search engine 236 is further configured to respond to the query 216 based on results of matching the query tokens 235 against the document tokens 234 via the inverted index 242.

The query 216 may be at least one statement, a paragraph, or an entire document. In the example embodiment of FIG. 2, the query 216 is received from a user 204. The search engine 236 is further configured to output a response 218 to the query 216. The response 218 may direct the user 204 to retrieve the NL document 232 in an event matching the query tokens 235 against the document tokens 234 via the inverted index 242 produces a match result indicating that the NL document 232 and query 216 have similar text.

Responding to the query 216 may be performed by transmitting the response 218 to the user 204 who submitted the query 216 via a user device 214. The user device 214 may be any electronic communications device, such as a laptop, tablet, desktop computer, etc. for non-limiting example. The query 216 may be submitted to the search engine 236 via a web application 219 (e.g., EA web application) that may return the response 218 from the search engine 236 to the user device 214. It should be understood that the query 216 and response 218 are not limited to being communicated via a web application. The response 218 may include a result(s) 221 with hyperlink(s) or other reference(s) for the user 204, thereby facilitating expansion of knowledge of the user 204 with regard to the query 216.

According to a non-limiting example, the result(s) 221 may direct the user 204 to a document(s) located at a location(s), such as a site with Internet accessible papers 223, Massachusetts Life Sciences Center (MLSC) hosted content 225, EA hosted content 227 (e.g., webserver, s3, other), etc. or may be a citation 229 that is sufficient to obtain paper or electronic copies thereof. It should be understood that the site with Internet accessible papers 223, Massachusetts Life Sciences Center (MLSC) hosted content 225, EA hosted content 227 (e.g., webserver, s3, other), etc. or citation 229 may also serve as potential sources for formulating the query 216 for non-limiting example. Alternatively, the query 216 may be sourced from speech (not shown) spoken by the user 204 and converted to text by the user device 214 configured to produce the query 216 therefrom

According to an example embodiment, the ingestion engine 224 may employ open source for Java, such as JesterJ, and may be referred to interchangeably herein as a “JesterJ” ingestion engine/machine. It should be understood, however, that the ingestion engine 224 need not be based on an open source system/code and is not limited to employing JesterJ or Java. According to an example embodiment, the search engine 236 may be a search server that is based on an open-source-enterprise-search platform, such as Apache Solr™, and may implement example embodiments disclosed herein using Apache Lucene. The search engine 236 may be referred to interchangeably herein as a Solr search server/engine. It should be understood, however, that the search engine 236 need not employ an open-source platform, Apache Solr, Apache Lucene, or Java.

According to an example embodiment, the ingestion engine 224 may further include an NL input component 252, text extractor 254, field manipulator 256, field transformer 257, and SVO field pre-analyzer 258. It should be understood that the order of the field manipulator 256, field transformer 257, and SVO field pre-analyzer 258 components is not limited to as shown in FIG. 2. Use of the NL input component 252, text extractor 254, field manipulator 256, field transformer 257, and SVO field pre-analyzer 258 are described below.

While other applications may seek to parse “natural language” contained in a document, such as electronic medical records (EMRs) or Journal Article Tag Suite (JATS) extensible markup language (XML), they may not integrate the additional metadata in the EMR—those which for discussion purposes can be categorized as staging/assessments/diagnosis values. The JesterJ pre-analysis capability provided by the text extractor 254, field manipulator 256, field transformer 257, and SVO field pre-analyzer 258 components, enables the XML tags found in documents to be archived pursuant to the Journal Archiving and Tag Set. This protocol handles two categories of data: metadata-type attributes tagged with a structured data format (such as XML or JSON referencing or encapsulating the document text) and the primary text of the document which contains the “unstructured text.” The Knowledge-Facilitator reduces the information gap between structured and unstructured data via the SVO analysis pre-analysis by leveraging the structure implied by the natural language of the document. English has been used in current embodiments, but the same techniques could be applied to any natural language.

The NL input component 252 may be configured to store content of the NL document 232 in a data structure 253 in response to pulling the NL document 232 from a data source 222 or in response to a push of the NL document 232 from the data source 222 to the NL input component 252. The data source 222 may be any data source, such as a PubMed® database for non-limiting example that comprises more than 32 million citations for biomedical literature from MEDLINE, life science journals, and online books. Such citations may include links to full text content from PubMed Central and publisher web sites. The data source 222 may be an EMR database of a hospital or any other type of data source that stores NL documents or citations thereto and the data source is not limited to a type of data source disclosed herein.

As disclosed above, the NL input component 252 may be configured to store content of the NL document 232 in a data structure 253. The content may include the document text 230 and metadata (not shown). The text extractor 254 may be configured to extract plain text 255 from the data structure 253. The plain text 255 extracted may be the document text 230. The field manipulator 256 may be configured to alter fields of the data structure 253 by renaming field content of the fields, formatting field content of the fields, or a combination thereof. The field transformer 257 may be configured to aggregate fields, duplicate fields, or otherwise transform fields of the data structure 253. The data structure 253 may include at least one multimap (not shown) or other data structure (not shown) that encodes a relationship between a key (not shown) and at least one value (not shown). The document SVO triplets 228 (produced from the document text 230 via the SVO analyzer 262-1) may be stored as the at least one value or values for the key in the multimap or other data structure.

The SVO field pre-analyzer 258 may include an ingestion instance of an SVO analyzer 262-1. The text extractor 254 may be configured to extract the document text 230 of the NL document 232 and the ingestion instance of the SVO analyzer 262-1 may be configured to provide the document text 230 to the ingestion instance of the NLP analyzer 226-1. The ingestion instance of the SVO analyzer 262-1 may be further configured to produce the document token stream 244 (including the document tokens 234) based on the document SVO triplets 228 found by the ingestion instance of the NLP analyzer 226-1. The SVO analyzer 262-1 may be configured to expand the document SVO triplets 228 found by the ingestion instance of the NLP analyzer 226-1 into permutations thereof.

The search engine 236 may be further configured to employ a search instance of the SVO analyzer 262-2. The search instance of the SVO analyzer 262-2 may be configured to provide the query text 216 to the search instance of the NLP analyzer 226-2 and produce the query token stream 237 including the query tokens 235, wherein the query tokens 235 represent respective query hierarchical classifications of the at least one query hierarchical classification selected. The SVO analyzer 262-2 may be configured to expand the query SVO triplets 238 found/produced by the search instance of the NLP analyzer 226-2 into permutations thereof and the variation document hierarchical classifications correspond to same.

According to an example embodiment, the query token stream 237 represents at least a portion of all possible SVO permutations which result from multiple sense meanings of the SVO components of the query SVO triplets 238 found in the query text 240 and represents the query hierarchical classifications assigned to the respective subject, verb, and object components of the SVO permutations which are selected by the SVO analyzer 262-2. Such SVO permutations may be generated by the search instance of the SVO analyzer 262-2.

According to an example embodiment, the search engine 236 may be a Solr search server for non-limiting example. The document token stream 244 may be a respective document token stream for the input document, namely the NL document 232 in the example embodiment, as the document token stream 244 may be produced by the ingestion engine 224 on a document-by-document basis. The document token stream 244 may represent an input document 265 for ingestion by the search engine 236 and may be considered a “Solr” input document for the case of a Solr search server.

The search engine 236 may include a plurality of analyzers, such as the analyzer(s) A 264a, analyzer(s) B 264b, and analyzer(s) C 264c, configured to analyze fields of the input document 265, such as field A 266a, field B 266b, and field C 266c for non-limiting example, and generating a field token stream 267 by examining text of such field. The field A 266a, field B 266b, and field C 266c may be fields defined by Solr, fields defined by another search platform, or custom-defined fields. In the example embodiment of FIG. 2, the SVO field 266d does not need to be analyzed because the ingestion instance of the SVO analyzer 262-1 in combination with the ingestion instance of the NLP analyzer 226-1 have performed such analysis (i.e., pre-analysis) in the ingestion engine 224, thereby increasing performance of the search engine 236 relative to employing an additional SVO analyzer in the search engine 236 to perform same. It should be understood, however, that the pre-analysis function could be moved from the ingestion engine 224 to the search engine 236.

In the example embodiment of FIG. 2, the search engine 236 stores a representation of the NL document 232 in the inverted index 242 without having to analyze the SVO field 266d, as the document tokens 234 for the SVO triplets 228 were already produced by the ingestion engine 224. The document tokens 234, in combination with respective tokens of the field token stream 267 are stored in the inverted index 242 enable similarity matching of the query 216 with respect to same.

The query 216 may be parsed by a query parser 268 of the search engine 236. The query parser 268 may be a standard query parser, such as an Apache Lucene query parser for non-limiting example, that may forward enabled fields of the query 216 to the respective analyzer in the search engine 236 for producing token streams for matching with content of the inverted index 242. In the example embodiment of FIG. 2, Field B 266b is enabled and text of same is analyzed by the analyzer(s) B 264b for producing the field token stream 267 for matching.

The query parser 268 may extract the query text 240, for example, plain text of the query 216, and forward same to the search instance of the SVO analyzer 262-2 which may, in turn, forward the query text 240 to the search instance of the NLP analyzer 226-2. The search instance of the NLP analyzer 226-2 is configured to find the query SVO triplets 238 in the query text 240 and assign initial hierarchical classifications (not shown) to the query SVO triplets 238 found. The search instance of the NLP analyzer 226-2 forwards the initial hierarchical classifications representing the query SVO triplets 238 found. The search instance of the SVO analyzer 262-2, in turn, generates variation query hierarchical classifications by varying the initial query hierarchical classifications and selects at least one query hierarchical classification from the initial and variation query hierarchical classifications. The search instance of the SVO analyzer 262-2 produces the query token stream 237 including the query tokens 235 and compares the query tokens 235 in the query token stream 237 to document tokens 234 in the inverted index 242, thereby enabling the search engine 236 to respond to the query 216 based on results of matching the query tokens 235 against the document tokens 234 via the inverted index 242.

It should be understood that within the search engine 236 (e.g., a search server) there is no conversion to text format, tokens may remain in search software object structures until it written to the inverted index 242. In Lucene (and therefore Solr) these structures are called a “token stream.” It should be further understood that a query, such as the query 216 does not cause any element to be stored in the inverted index 242. Receipt of numerous queries will not alter a size of the inverted index 242. Server log files may fill up a disk but a query is (mostly) a SAFE operation in the same sense as defined in the HTTP/1.0 specification for GET and HEAD (https://www.w3.org/Protocols/HTTP/1.0/spec.html #SafeMethods). Search engines typically cache the results of prior queries so an initial query may cause an increased transient memory storage and decreased latency on subsequent duplicative or partially duplicative requests—but this is entirely orthogonal to persistent storage in the inverted index 242 discussed in this section. The query 216 may be conducted using a Hypertext Transfer Protocol (HTTP) GET request. It should be understood, however, that the query 216 is not limited to being conducted using same.

FIG. 3A is block diagram of an example embodiment of a system 324 that may be employed as the ingestion engine 124 or ingestion engine 224 disclosed above with regard to FIG. 1B and FIG. 2, respectively. The system 324 comprises an input interface 321 and a processor 358A. The processor 358A is configured to employ a natural language processing (NLP) analyzer 326 to find document subject-verb-object (SVO) triplets (not shown) in document text 330 of a natural language (NL) document 332 and assign initial document hierarchical classifications 331 to the document SVO triplets found. The NL document 332 is received via the input interface 321 which may any suitable electronic communications interface known in the art. The processor 358A may be further configured to generate variation hierarchical classifications (not shown) by varying the initial hierarchical classifications 331 assigned. The processor 358A may be further configured to select at least on hierarchical classification (not shown) from the initial hierarchical classifications 331 and variation hierarchical classifications. The processor 358A may be further configured to produce a document token stream 344 including document tokens (not shown) and output the document token stream 344 produced. The document tokens represent respective hierarchical classifications of the at least one hierarchical classification selected. The document token stream 344 may be transmitted to a system, such as the system 336 of FIG. 3B, disclosed below.

FIG. 3B is a system 336 that may be employed as the search engine 136 or search engine 236 disclosed above with regard to FIG. 1B and FIG. 2, respectively. The system 336 comprises an inverted index 342 created from received token streams, such as the document token stream 344. The received token stream, that is, the document token stream 344 in the example embodiment, includes subject-verb-object (SVO) derived tokens (not shown) relating the SVO derived tokens to natural language (NL) documents, such as the NL document 332 of FIG. 3A disclosed above. The system 336 further comprises a processor 358B configured to load document tokens 334 into the inverted index 342. The document tokens 334 are included in the document token stream 344 received by the system 336.

According to an example embodiment, the document token stream 344 may be generated by the system 336 itself. For example, the system 336, while employed as a search engine/server, may be configured, optionally, to perform ingestion functions as disclosed herein. According to such an example embodiment, the system may employ a natural language processing (NLP) analyzer 326 to generate the document token stream 344 from an NL document and, thus, the document tokens 334 for storing in the inverted index 342. In such a case, the system 336 may be configured to output a response 318, such as a message that includes confirmation that the NL document was received and stored in the inverted index 342 without error. In an event the system 336 encounters an error, for example, the inverted index 342 may not have adequate space available for storing the NL document, then the response 318 may represent an error message indicating same. It should be understood that the error is not limited to an error with regard to resource availability in the inverted index 342. It should be further understood that performing ingestion in the system 336 (e.g., search server) is optional.

For example, ingestion may be performed external to the system 336 to move the heavy processing of ingestion out of the search server (engine) to allow for more efficient hardware requirements for the system 336 (e.g., search server). As such, the system 336 may simply receive the document token stream 344, for example, from an ingest processor implemented with JesterJ for non-limiting example, as disclosed above. Regardless of whether or not the system 336 employs the NLP analyzer 326 for ingestion, the system 336 implements or uses the NLP analyzer 326 for responding to a query 316, as disclosed below.

According to an example embodiment, the processor 358B is further configured to implement or use the NLP analyzer 326, wherein the NLP analyzer 326 is configured to find query SVO triplets (not shown) in query text (not shown) of the query 316 and assign initial query hierarchical classifications (not shown) to the query SVO triplets found. The processor 358B is further configured to generate variation query hierarchical classifications (not shown) by varying the initial query hierarchical classifications assigned and to select at least one query hierarchical classification (not shown) from the initial query hierarchical classifications and the variation query hierarchical classifications. The processor 358B is further configured to produce query tokens 335 representing respective hierarchical classifications of the at least one query hierarchical classification selected, and respond to the query 316 based on results of matching the query tokens 335 against the document tokens 334 via the inverted index 342 to determine relevancy of the NL document to the query 316. It should be understood that the query tokens 335 are created in response to the query 316 and are ephemeral and, while the tokens 335 may, occasionally, be cached in memory (not shown), temporarily, the query tokens 335 are not persistent and are not recorded (stored) in the inverted index 342. For such a query use case, the response 318 may be a list or count of matching documents for non-limiting example. The response 318 may also or alternatively include aggregations or statistics relating to the matched documents across the corpus of documents stored via the inverted index 342.

With reference to FIG. 1A, FIG. 1B, and FIG. 2, disclosed above, according to an example embodiment, the system 90, system 102, or system 202 may further comprise, embed, or utilize a lexical database (not shown) with entries from the WordNet® database 672 of FIG. 6B, disclosed further below. It should be understood, however, that the lexical database is not limited to including entries from the WordNet® database. Entries of the lexical database may be assigned hierarchical classifications, such as the hierarchical classifications 303 of FIG. 3C, disclosed below.

FIG. 3C is a table 300 of example hierarchical classifications 303 assigned to WordNet® (WN) entries 305 in accordance with an example embodiment. The table 300 further includes an indent level 362, WN hierarchy ID 363, source 364 for the entry, part of speech 365 of the entry and WN reference ID 366 for the entry. While the part of speech 365 for the entries in the table 300 are nouns, it should be understood that such the entries are not limited thereto and could be other parts of speech, such as a verb, etc. The WN reference ID 366 may correspond to its reference ID in the WN database.

The hierarchical classifications 303 may be assigned to reflect the entry's level in the hierarchical structure. The hierarchical classifications 303 may be referred to as master lexicon hierarchical identifiers (IDs) and are unique identifiers. In the example embodiment of FIG. 3C, the hierarchical classifications 303 are represented in dot notation for non-limiting example. While the hierarchical classifications 303 may be unique delimiter-separated categories denoted by numbers, they need not be separated by a dot (i.e., period) and may be separated by any character that serves as a delimiter.

Furthermore, while numeric names for categories are conveniently terse, categories could be alternately encoded as letters or words or any other notation distinct from the delimiters. The delimiter represents a transition from one level to another in a hierarchy. For example, a top level of the hierarchy may be represented by a hierarchical classification 303 that has zero delimiters, whereas a first level of the hierarchy may be represented by a hierarchical classification 303 with one delimiter. It should be understood that representing a level (depth) is not limited to delimiter-separated numbers and could, for non-limiting example, be based on location of numbers. In the example embodiment of FIG. 3C, the level (depth) in the hierarchy is represented by the index level 362. The hierarchical classifications 303 may be assigned based on the semantic relations between the words. The plurality of hierarchical classifications 303 may capture relationships within and across hypernymic levels of words of the lexical database, as disclosed further below.

With reference to FIGS. 1-3, the ingestion instances of the NLP analyzer (126-1 and 226-1) and the search instances of the NLP analyzer (126-2 and 226-2) may be configured to access the lexical database to assign the initial document hierarchical classifications and initial query hierarchical classifications to the document SVO triplets (128 and 228) and the query SVO triplets (138 and 238), respectively. The initial document hierarchical classifications and initial query hierarchical classifications assigned are among the hierarchical classifications of the lexical database, such as from among the hierarchical classifications 303 for non-limiting example.

The initial document hierarchical classifications may be assigned to enable the document SVO triplets 128 and document SVO triplets 228 to be indexed in the inverted index 142 and inverted index 242, respectively, based on respective categories to which component words of the document SVO triplets 128 and 228 belong in the lexical database. Such SVO triplets are considered herein to be an intrinsic component of sentential text and an example embodiment disclosed herein effectively refines the text into SVO triplets similar to how ore is refined into valuable metals. As such, while the SVO triplets may be shown as part of the original document, the example embodiment captures more than a subset of some literal part of the document. Continuing with reference to FIG. 3C, for non-limiting example, the table 300 includes WordNet® noun categories, such as “entity,” “body of water,” and “strait” for non-limiting example. It should be understood, however, that the component words may be below to other categories, such as verb, etc. The entries of the lexical database may include WordNet® entries, such as disclosed above with regard to FIG. 3C and described in greater detail further below. The lexical database may further include supplemental entries, such as disclosed below with regard to FIG. 4.

FIG. 4 is a block diagram of an example embodiment of cross-mapping among life sciences language resources, such as the Medical Subject Headings (MSH or MeSH) resource 407a, International Classification of Diseases (ICD) 9/10 resource 407b, Library of Congress Subject Headings (LCH) resource 407c, Systematized Nomenclature of Medicine (SNOMED) resource 407d, and National Center for Biotechnology Information (NCBI)

Taxonomy resource 407e. The supplemental entries of the lexical database may include word content sourced from at least one language resource specific to at least one type of knowledge domain, such as the life sciences resources 407a-e for non-limiting example.

While the WordNet® database 472 can serve as a framework for language resources, as described below in further detail, an example embodiment enriches same via additions from language resources which are specific to knowledge domains. Using cross-mapping among WordNet® entries and such lexicons thereof, users, such as the user 104 and user 204 described above, who may be expert in one domain but not in another, to nevertheless query and obtain other-domain results whose similarity (syntheses) become evident through delivery of responses, such as the response 118 and response 218 of FIGS. 1 and 2, respectively. FIG. 4 includes a table 415 with detail regarding such cross-mapping for non-limiting example. A non-limiting example embodiment of Wordnet® entry to a semantic network cross-mapping, namely a mapping system 417 for Key “1” that maps entries of the Wordnet® database 472 with entries of the MSH resource 407a is shown in FIGS. 5-1 through 5-20, described below.

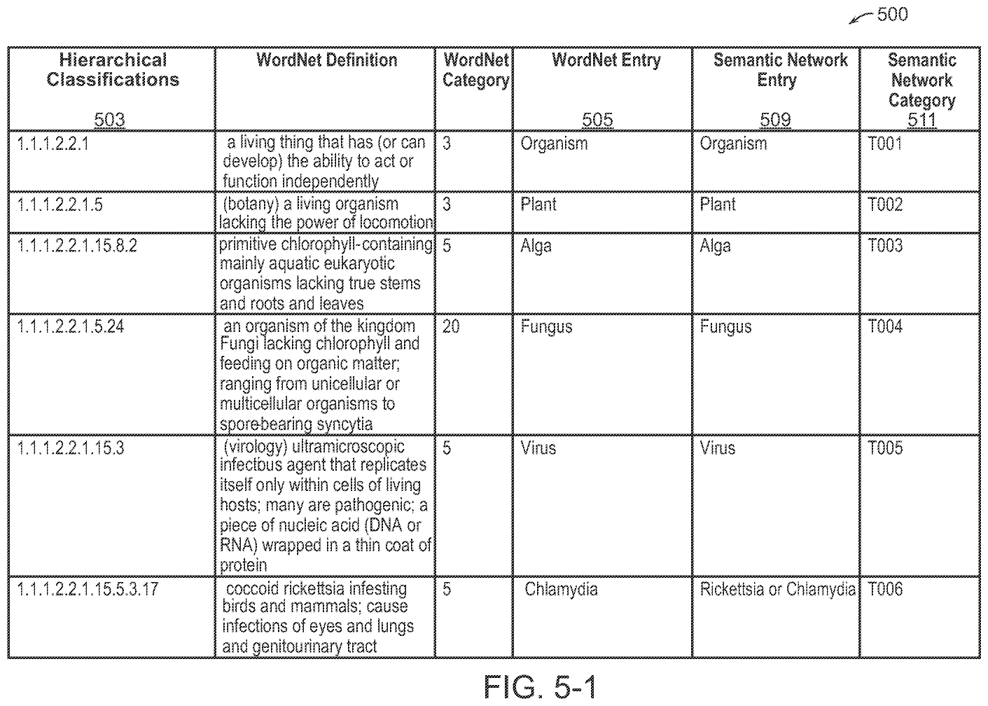

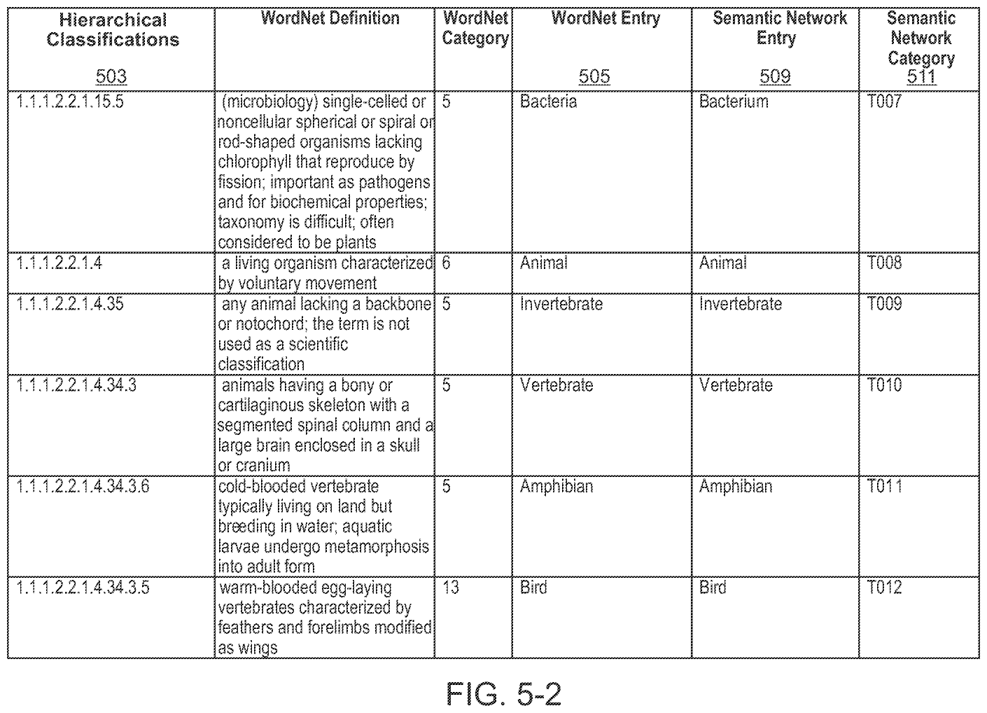

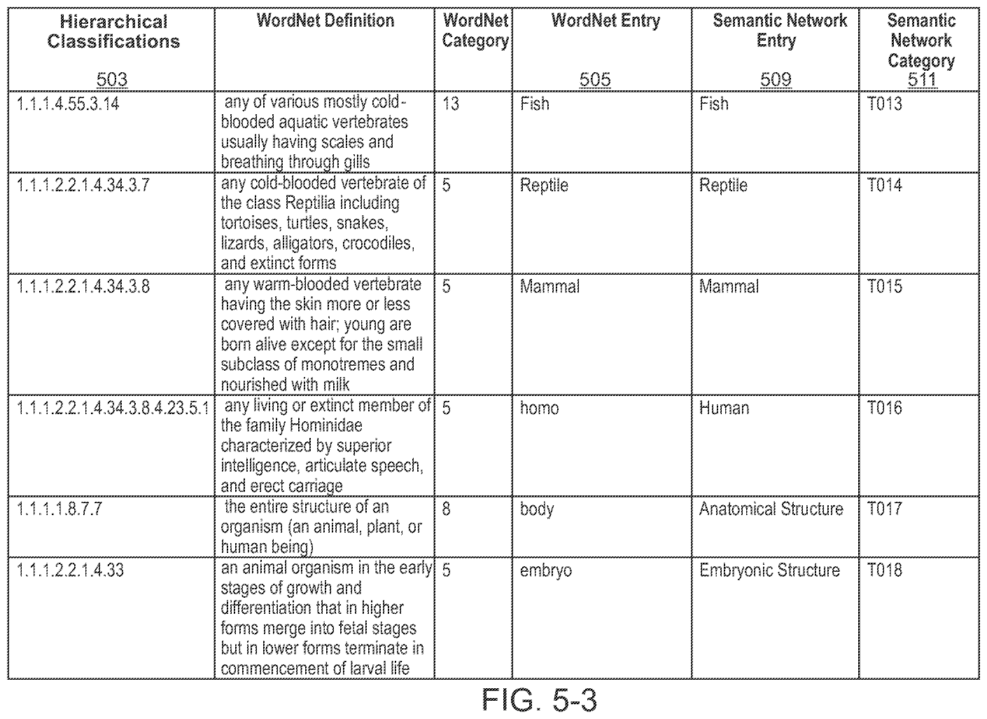

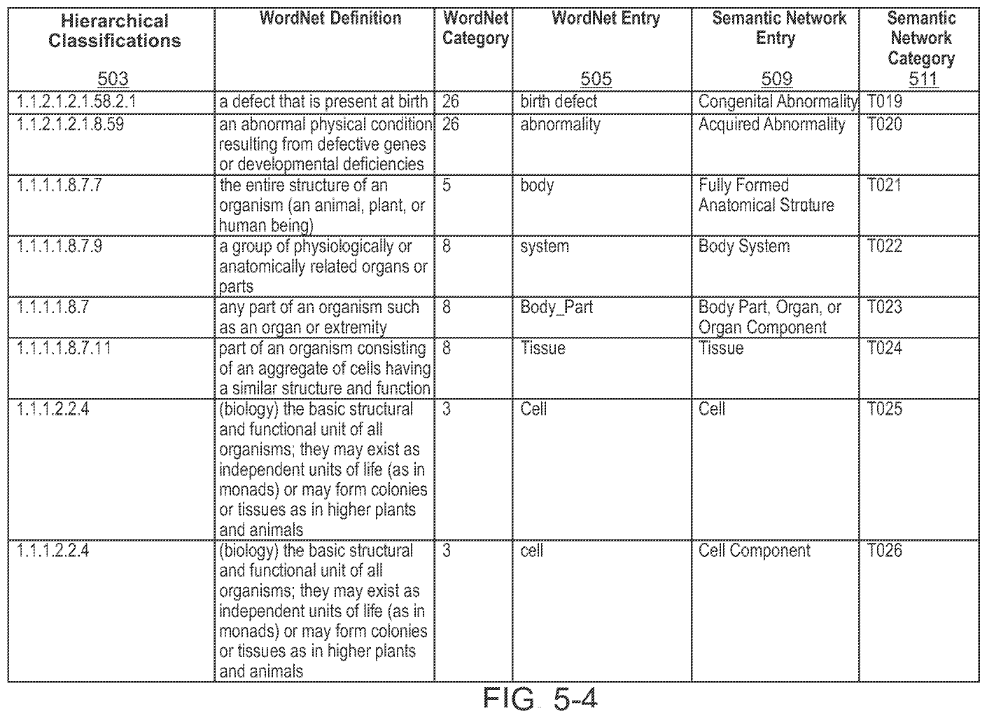

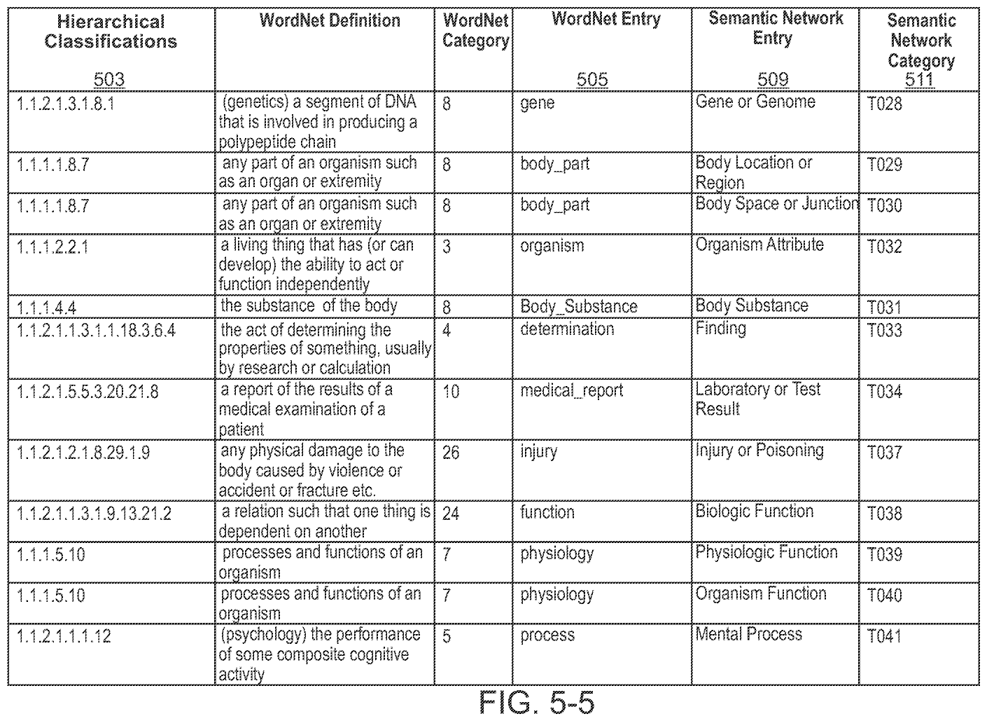

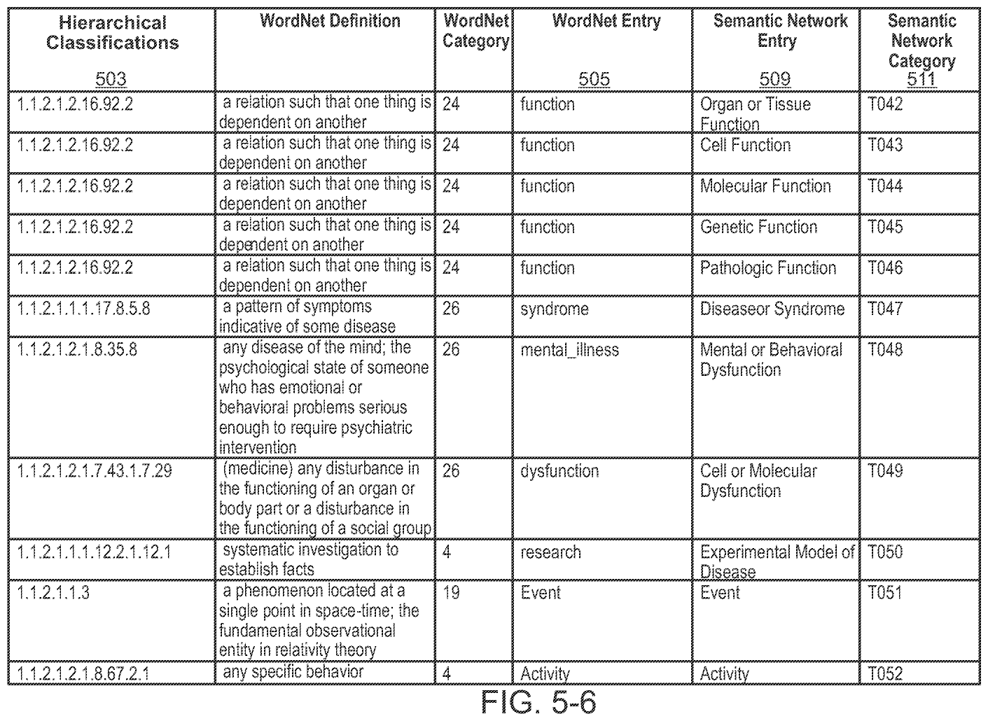

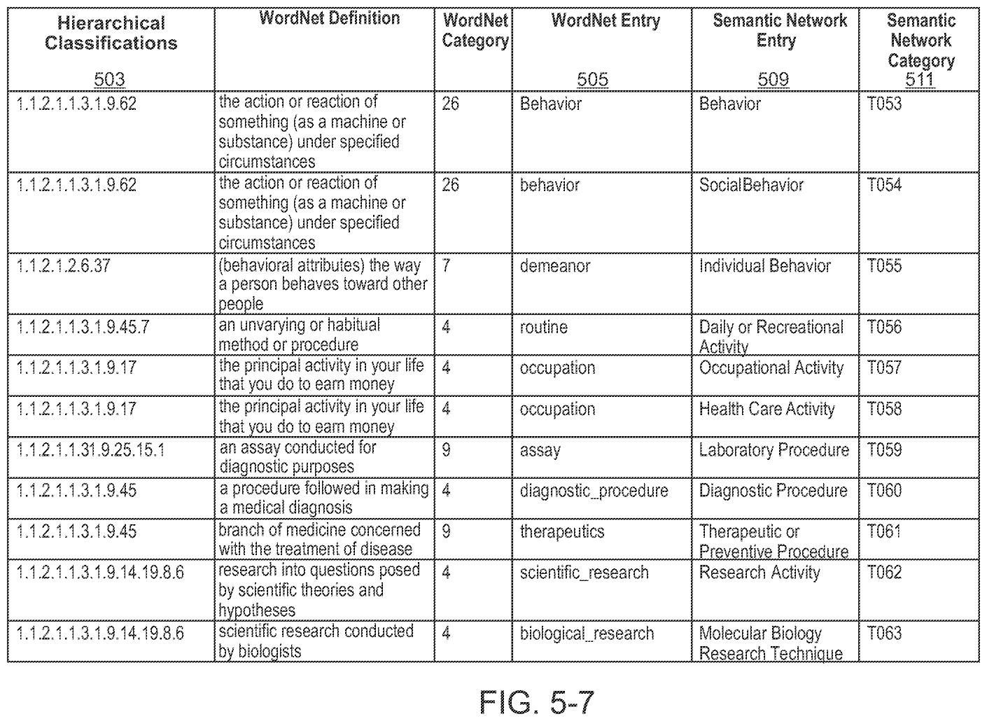

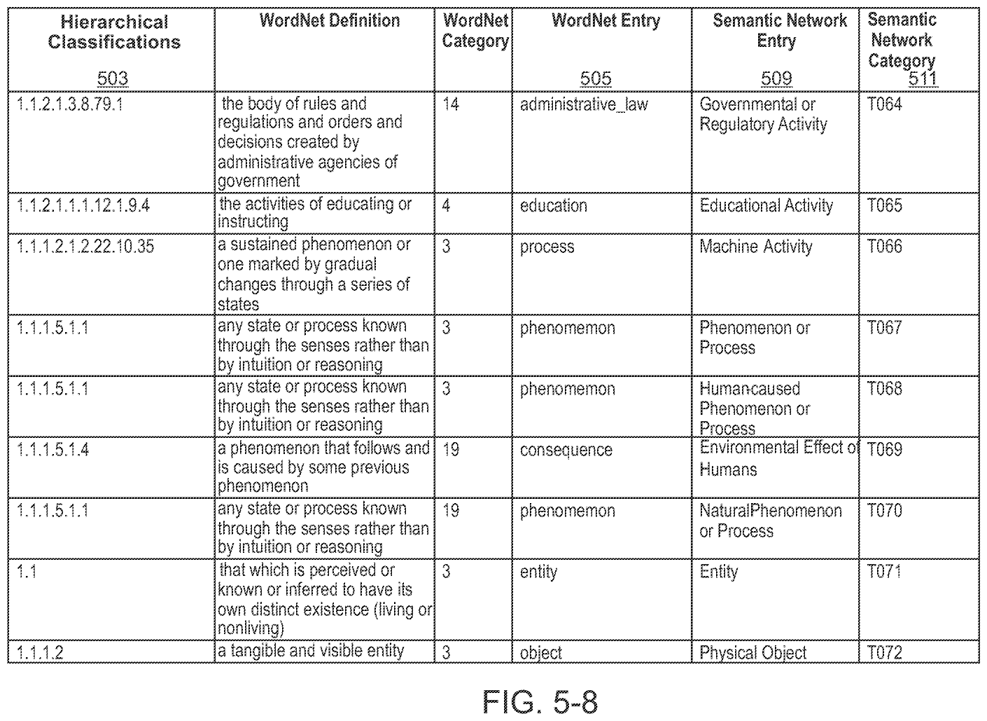

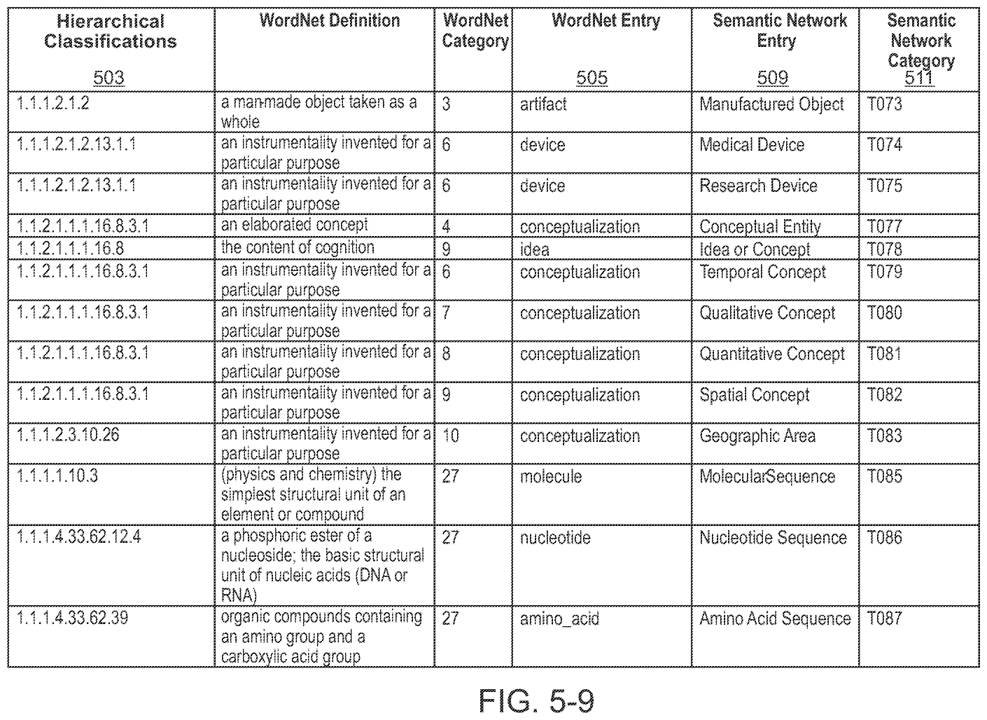

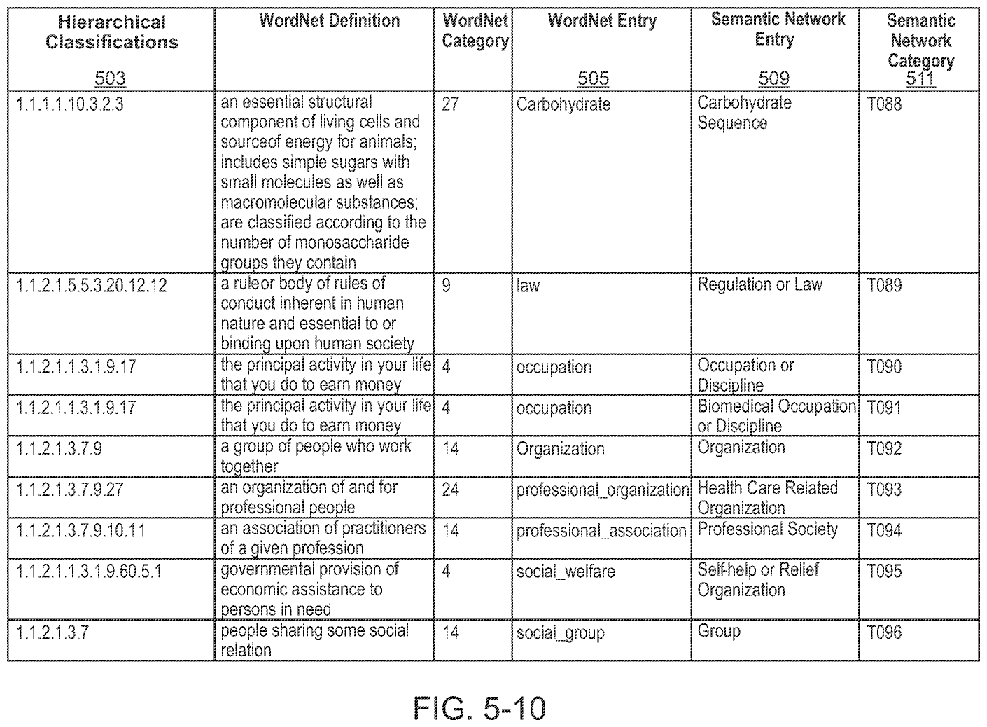

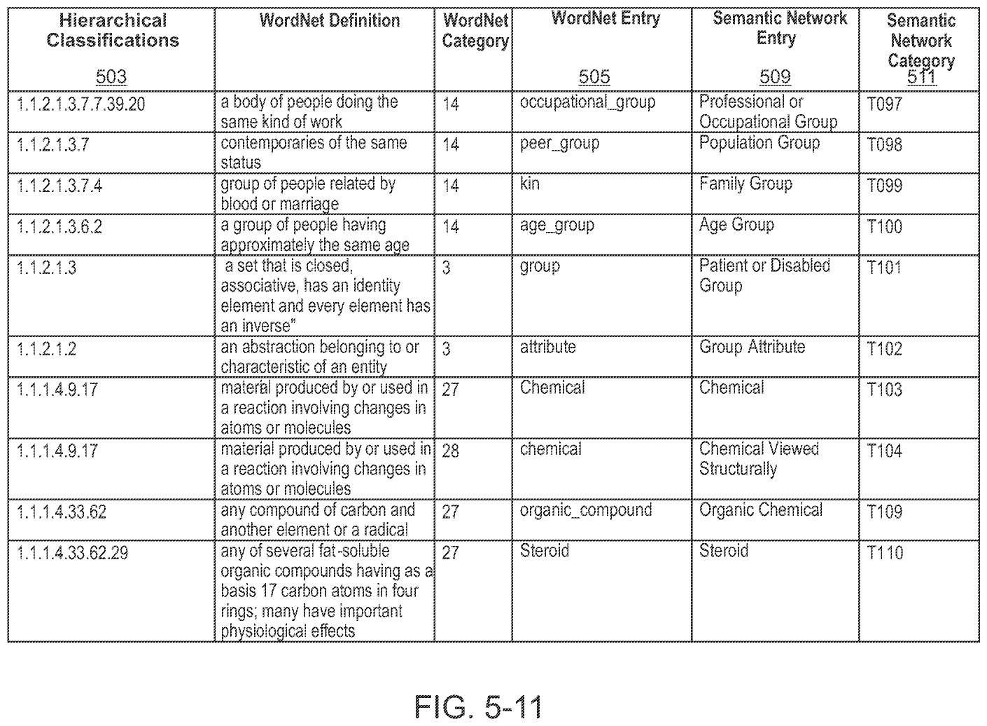

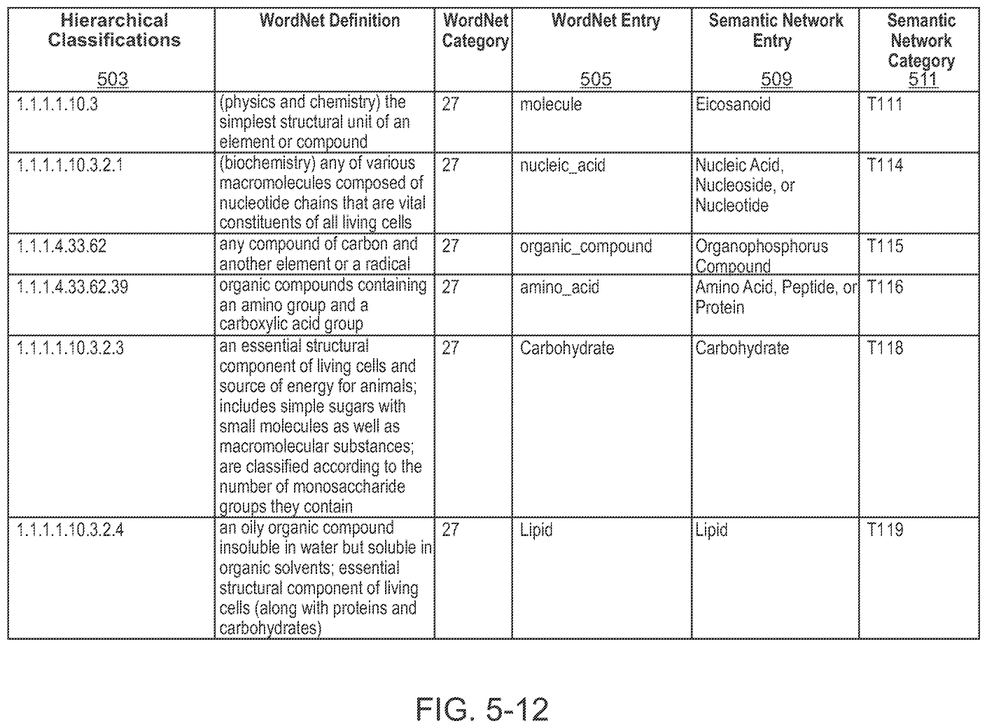

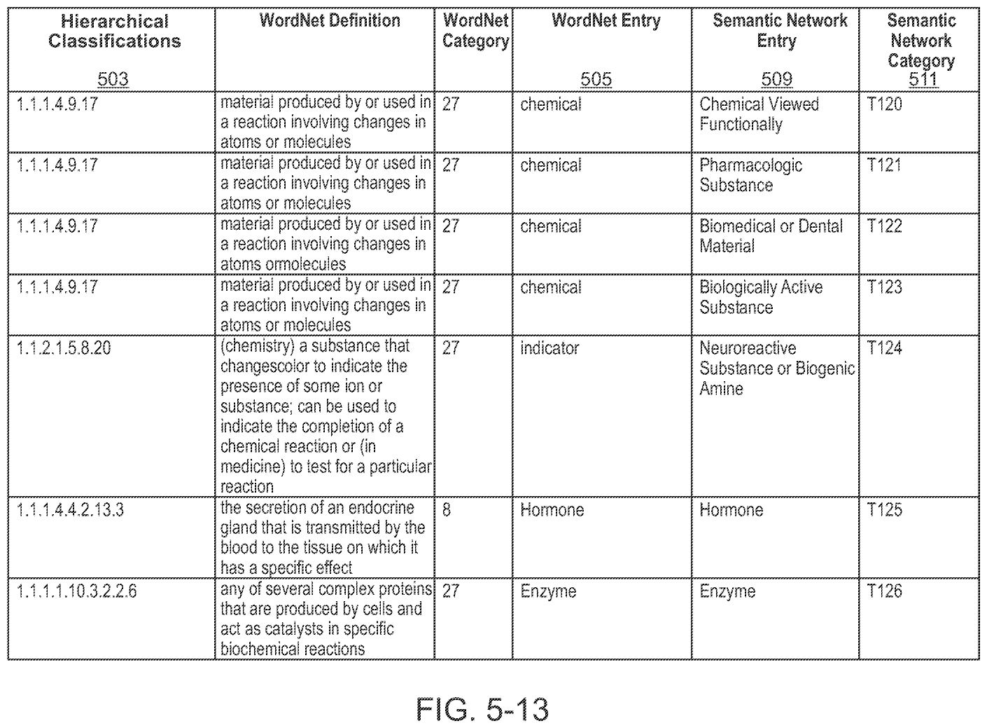

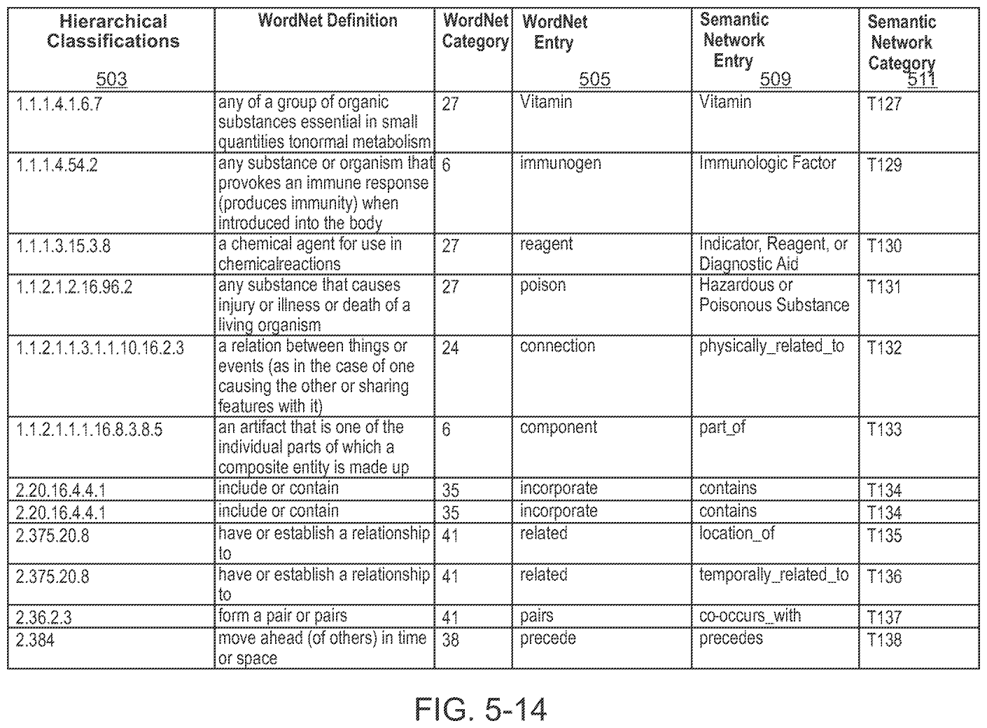

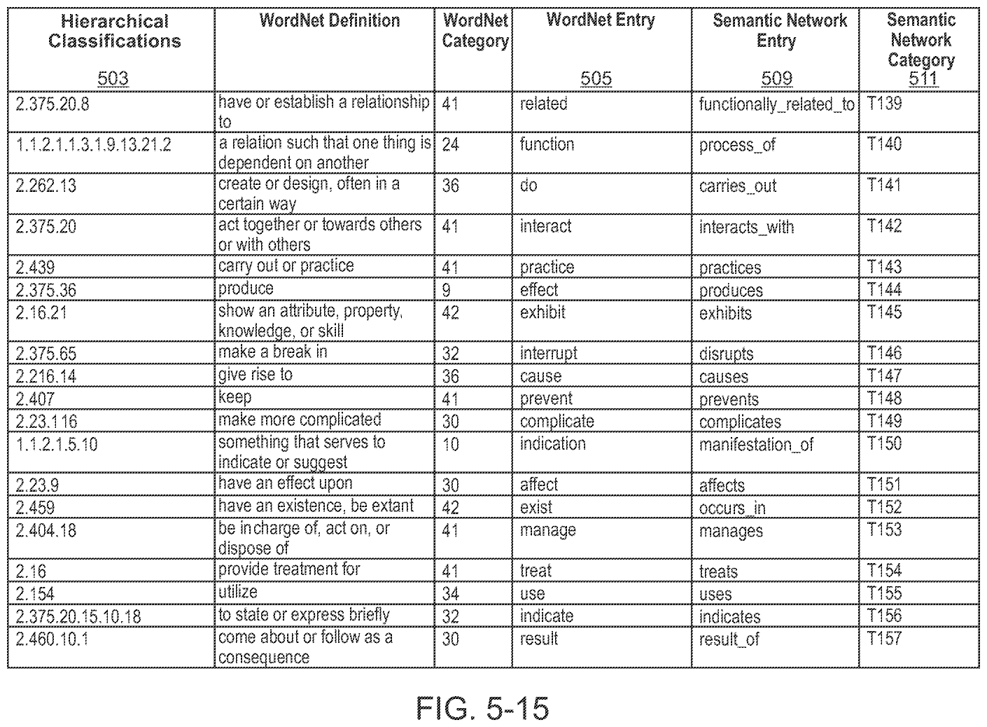

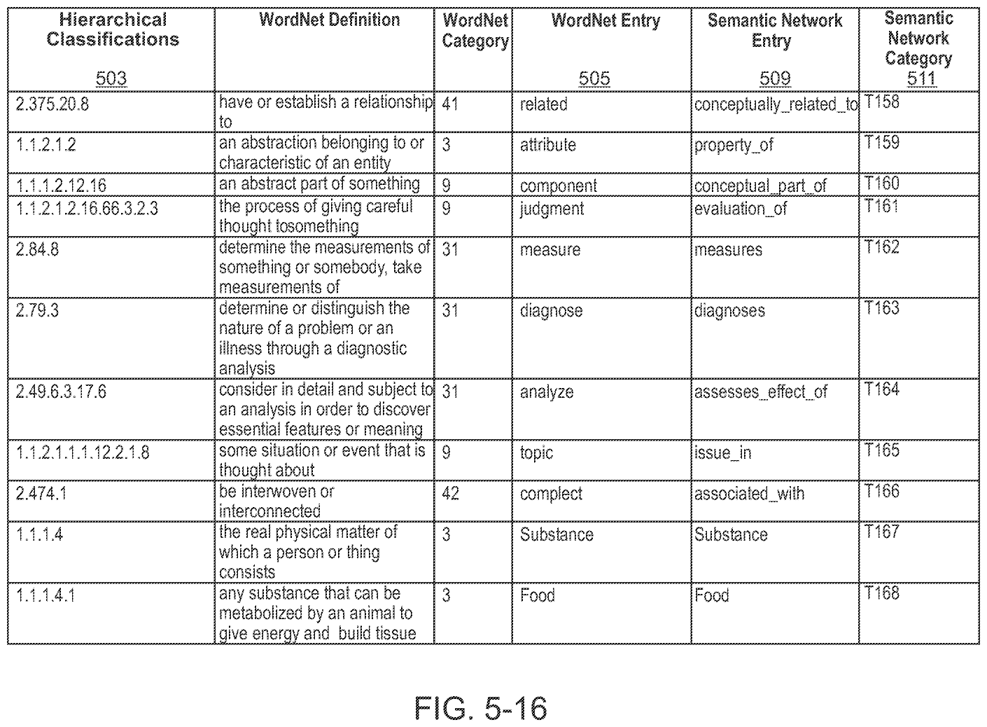

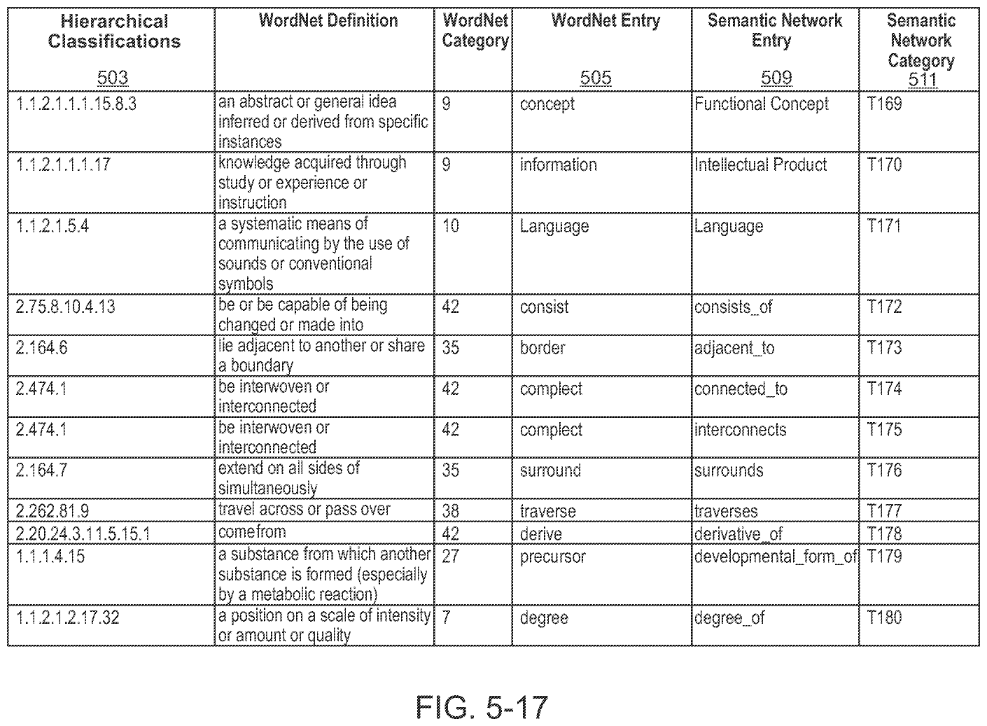

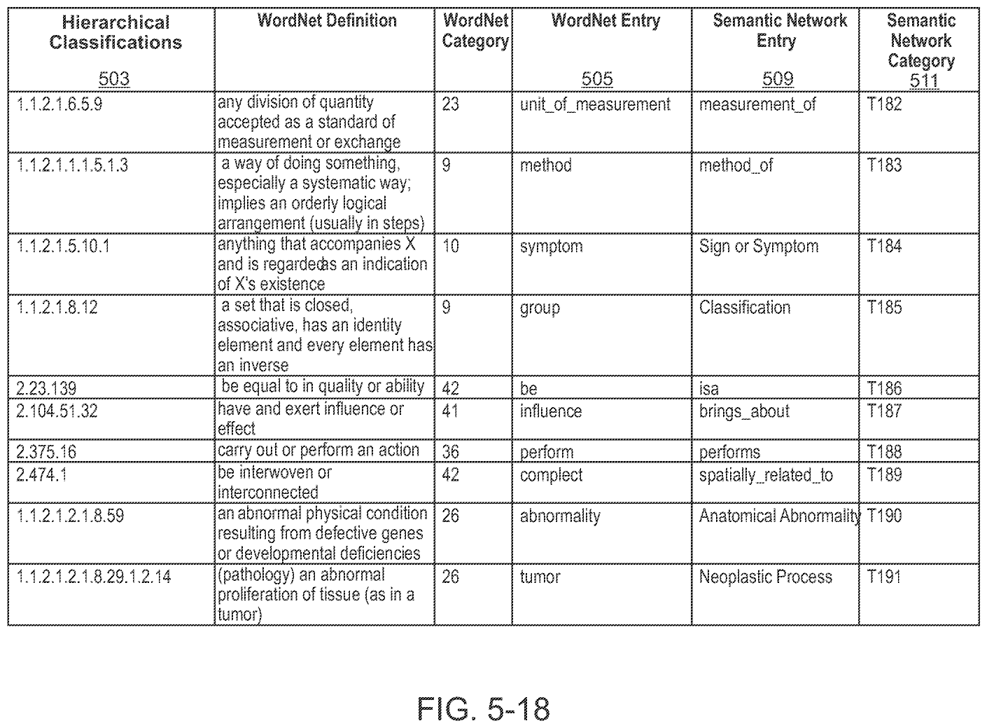

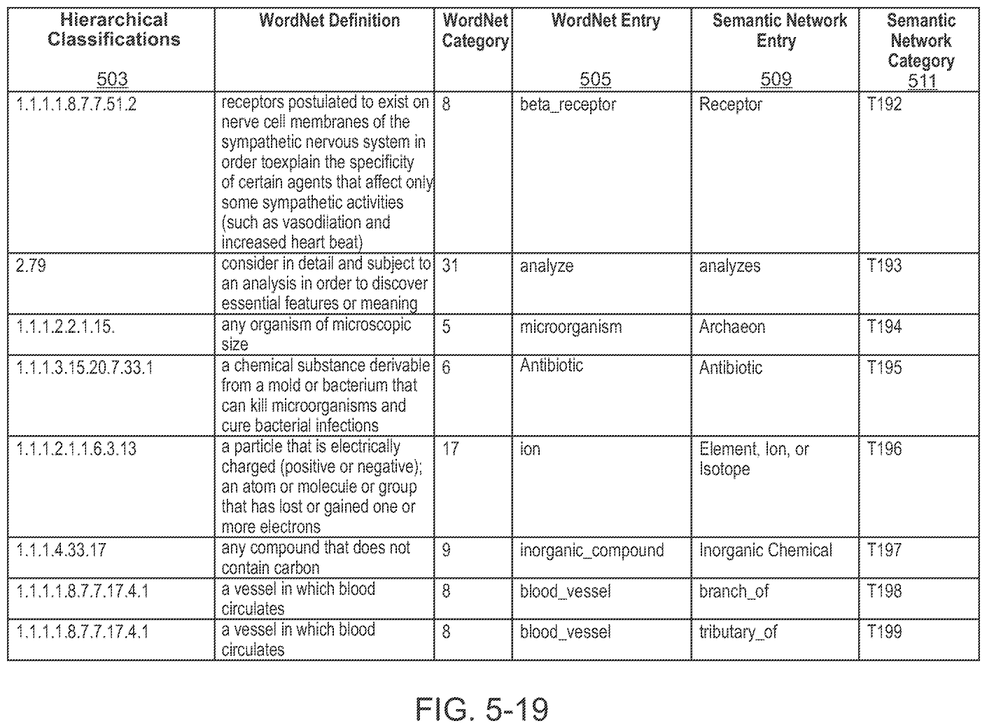

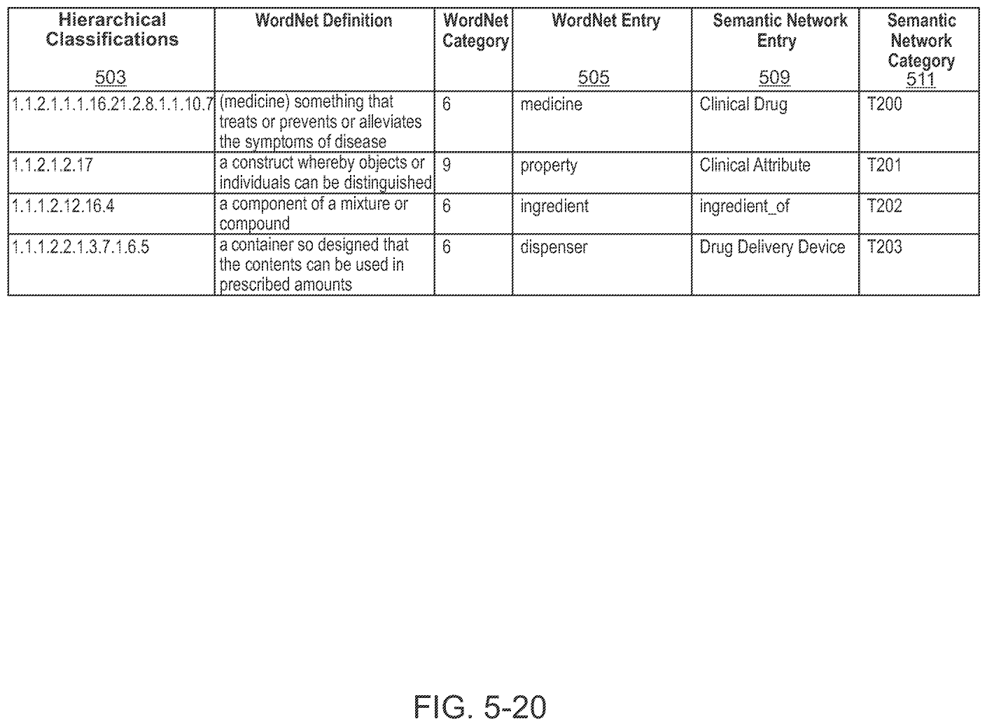

FIG. 5-1 is a table 500 of Wordnet® entries cross-mapped to semantic network entries according to an example embodiment. In the example embodiment, a Wordnet® entry 505 is cross-mapped to a semantic network entry 509 via the mapping system 417 of FIG. 4, disclosed above, namely via a semantic network category 511, such as “T” codes (e.g., T001 . . . . T203) of the semantic network, that is, the MSH (i.e., MeSH) in the example embodiment.

FIGS. 5-2 through 5-20 are continuations of the table of FIG. 5-1. Such entries (i.e., rows) of the table 500 of FIGS. 5-1 through 5-20, may be included in the lexical database accessed by the NLP analyzer and, as such, the FIG. 1B and FIG. 2 ingestion instances (126-1 and 226-1) and search instances (126-2 and 226-2) thereof. The entries of the lexical database are each assigned a hierarchical classification 503 (i.e., master lexicon hierarchy ID) that may be employed by the respective instance of the NLP analyzer (e.g., 126-1, 126-2, 226-1, 226-2) as the initial document hierarchical classifications assigned to the document SVO triplets (e.g., 128, 228) found by the ingestion instance of the NLP analyzer (e.g., 126-1, 226-1) or initial query hierarchical classifications assigned to the query SVO triplets (e.g., 138, 238) found by the search instance of the NLP analyzer (e.g., 126-2, 226-2), as disclosed above with regard to FIG. 1B and FIG. 2. As disclosed below with regard to FIGS. 6A and 6B, the NLP analyzer may be a multi-pass text analyzer in which case an instance thereof would also be a multi-pass text analyzer.

FIG. 6A is a block diagram of an example embodiment of a natural language processing (NLP) analyzer 626 with multiple passes 601, namely the passes 601-1 . . . 601-45. The NLP analyzer 626 may be employed as the NLP analyzer 26 of FIG. 1A or as any of the instances of an NLP analyzer (e.g., 126-1, 126-2, 226-1, 226-2) disclosed above with regard to FIG. 1B and FIG. 2. The NLP analyzer 626 is a multi-pass text analyzer. While a number of the multiple passes 601 of the NLP analyzer 626 shows forty-five passes in the example embodiment, it should be understood that the number of the multiple passes 601 may be more or less than forty-five.

The NLP analyzer 626 was implemented based on a customized version of a text analyzer, known as TAIParse, from Text Analysis International, Inc (TAI), doing business as Conceptual Systems, LLC California as of 2018. The TAIParse analyzer provides a multi-pass, multi-strategy architecture for NLP, with a commercial integrated development environment (IDE), namely VisualText®, and an associated NLP++™ programming language. VisualText integrates with (i) the NLP++ programming language for rapid analyzer building, (ii) a Conceptual Grammar™ knowledge base management system for representing linguistic, conceptual, and domain knowledge, (iii) a rule generation system that learns from samples, and (iv) a runtime analyzer engine.

### Natural to Machine Language Conversion

According to an example embodiment, the NLP analyzer 626 uses a standard linguistic progression, comprising lexical, syntactic and semantic processing. According to an example embodiment, the NLP analyzer 626 is configured to find SVO triplets, focusing on documents in the domain or domains pertinent to the lexicons cross-mapped into the Master Lexicon (e.g., see FIGS. 3C, 4, 5-1 through 5-20), such as scientific research papers for non-limiting example. SVOs represent a view of the core thoughts that appear in a document. The similarity in SVO content among documents postulated to be a good determiner of the closeness or relatedness of sets of documents.

According to an example embodiment, the NLP analyzer 626 employs multi-pass text analyzers. Each pass has its own rules and code, and can access/modify a parse tree and knowledge base. The passes execute sequentially or in parallel to elaborate a single parse tree, which represents the patterns found within the original text document. A single knowledge base (KB), such as the KB 682 of FIG. 6B, disclosed further below, serves as a repository of lexical information used by the NLP analyzer 626, and the KB may be updated dynamically to collect information derived from processing the current input document.

Unlike approaches that string together disparate “black box” systems, the passes of the NLP analyzer 626 cooperate within a uniform framework to analyze a text in a synergistic manner. Further, such passes may use distinct methods, such as pattern-based versus recursive grammar for non-limiting example. According to an example embodiment, passes may focus on processing within specific contexts, such as “noun phrases.” The NLP analyzer 626 may be referred to interchangeably herein as “Augustana,” an “Augustana” analyzer, or an “Augustana” NLP analyzer, and passes of the NLP analyzer 626, such as the multiple passes 601, may be referred to as “Augustana” passes and each pass may be referenced with a prefix “AUG.” As such, the passes 601-1 . . . 601-45 may be referred to as AUG 001 . . . . AUG 045, respectively.

Example embodiments of the passes 601-1 . . . 601-45 are disclosed below referenced as AUG 001 . . . . AUG 045, respectively:
AUG 001 tokenize
   The first processing pass which converts the input text to an initial parse tree including alphabetic, numeric, punctuation, control character, and whitespaces nodes. Such a hardwired pass may also add attributes from the KB to the initial parse tree. For example, possible syntax classes such as “noun” and “verb” may be added as attributes to an alphabetic node for the word “dog.”

| | | |
|---|---|---|
| AUG 002 | EUB_funs | Knowledge-Facilitator (Eubalaena) |
| | | specific functions |
| AUG 003 | funs2013 | TAIParse phrase lookup functions |
| AUG 004 | funs | TAIParse generic functions |
| AUG 005 | engfuns | TAIParse English-language functions |
| AUG 006 | posfuns | TAIParse part-of-speech functions |
| AUG 007 | semfuns | TAIParse semantic functions |
| AUG 008 | domfuns | TAIParse domain tie-in functions |
| AUG 009 | mhyfuns | Knowledge-Facilitator (Eubalaena) |
| | | SVO functions |
| AUG 010 | ini | |

An initialization pass that sets parameters and variables, such as where SVOs will be output for non-limiting example.
AUG 011 KBFIX100

A pass for updating the analyzer's KB with enhancements and corrections. This is a quick developer's alternative to the tedious process of rebuilding from scratch the entire KB for the analyzer.
AUG 012 Lines

The LINES pass segments the parse tree into _LINE and _BLANKLINE nodes. Subsequent passes can deduce whether lines belong in a paragraph, title, image caption, and so on.
AUG 013 NOSP_ZAPWHITE
   This pass removes all whitespace nodes from the parse tree, while flagging nodes that have no preceding whitespace. Those flags enable further tokenization and lexical actions that may “glom” multiple nodes into a single lexeme. For non-limiting example, “CARBON-14” may be grouped to a single lexeme in a subsequent pass. Removing whitespace substantially reduces the size of the parse tree, thus speeding the analysis.
AUG 014 form100
   These passes look for and group well-known formats, such as “PHONE:” or “KEYWORDS” for non-limiting example, so as to accurately characterize these parts of the text.
AUG 015 form200
   These passes look for and group well-known formats, such as “PHONE:” or “KEYWORDS” for non-limiting example, so as to accurately characterize these parts of the text.
AUG 016 xzone100
   Characterize and group zones such as paragraphs of text. These passes dissolve the LINE nodes produced by the earlier LINES pass.
AUG 017 xzone200
   Characterize and group zones such as paragraphs of text. These passes dissolve the LINE nodes produced by the earlier LINES pass.
AUG 018 tok100
   Rule-based tokenization, as opposed to the initial hardwired TOKENIZE pass.
AUG 019 sent50
   Responsible for determining sentence boundaries and grouping sentences within paragraphs.
AUG 020 xsent100
   Responsible for determining sentence boundaries and grouping sentences within paragraphs.
AUG 021 xlex50
   Lexical processing immediately preceding the phrase lookup machinery.
AUG 022 PHRASELOOKUP100
   Lookup phrases in a specialized part of the KB, and group matched phrases within the parse tree.
AUG 023 PHRASELOOKUP200
   Lookup phrases in a specialized part of the KB, and group matched phrases within the parse tree.
AUG 024 xlex100
   Further lexical processing, focusing on nodes that were NOT incorporated into phrases. For example, attributes are added to nodes representing irregular verbs for non-limiting example.
AUG 025 xlookup100
   Lookup individual words in a dictionary within the KB. Focuses on words NOT incorporated into phrases.

| | | |
|---|---|---|
| AUG 026 | VF_textxone100 | Word lookup and stemming. |
| AUG 027 | VF_author100 | Recognize author formatting. |
| AUG 028 | xpos10 | |

Passes concerned primarily with English syntax. They assign a single syntactic class (verb, noun, adjective, adverb, etc.) to words based on contextual, semantic, and other cues, as well as grouping noun, verb, adjectival, adverbial, and other phrases.
AUG 029 xpos25
   Passes concerned primarily with English syntax. They assign a single syntactic class (verb, noun, adjective, adverb, etc.) to words based on contextual, semantic, and other cues, as well as grouping noun, verb, adjectival, adverbial, and other phrases.
AUG 030 xpos35
   Passes concerned primarily with English syntax. They assign a single syntactic class (verb, noun, adjective, adverb, etc.) to words based on contextual, semantic, and other cues, as well as grouping noun, verb, adjectival, adverbial, and other phrases.
AUG 031 xpos50
   This pass uses a recursive grammar method to assure that syntactic processing is as complete as possible.
AUG 032 xpos100
   Passes concerned primarily with English syntax. They assign a single syntactic class (verb, noun, adjective, adverb, etc.) to words based on contextual, semantic, and other cues, as well as grouping noun, verb, adjectival, adverbial, and other phrases.
AUG 033 default100
   Further processing and default syntax class assignments to any nodes that remained ambiguous after the multiple syntactic processing passes.
AUG 034 xpos200
   Final syntactic processing, now that all possible syntax class assignments have been made.
AUG 035 xpos300
   Final syntactic processing, now that all possible syntax class assignments have been made.
AUG 036 hilite_alpha Developer's highlighting of unhandled tokens.
AUG 037 xclause100
   Identify and group “clauses” (or simple sentence fragments) within complex and compound sentences.
AUG 038 xclause200
   Identify and group “clauses” (or simple sentence fragments) within complex and compound sentences.
AUG 039 xclause_fin
   Identify and group “clauses” (or simple sentence fragments) within complex and compound sentences.
AUG 040 xclause_trav100
   Traverse and gather information about clauses and their interrelationships.
AUG 041 xclauses100
   Examine multiple clauses within each sentence.
AUG 042 xclausesem100
   Identify and output SVO triplets within each clause. The pass identifies most of the SVOs as well as finding “SVOs” for prepositional phrases. For non-limiting example, processing of “banana of monkey” would produce the SVO “monkey have banana.”
AUG 043 multi_np
   Identify and output SVO-like constructs within each noun phrase. As such, this pass finds “SVOs” for non-noun phrases. For non-limiting example, “opioid use disorders,” becomes a “noun verb noun” SVO. As processed by this pass, however, the SVO may be expressed as “disorders due to opioid use.”
AUG 044 COUNT100
   Count verb groups and the like within clauses.
AUG 045 fin
   Final analyzer processing and outputs for the current text.

An example of use of a number of the passes disclosed above is provided in the document entitled “Supplement: System and Method for Facilitating Expansion of Knowledge” (e.g., at pages 8 through 22) and filed as part of U.S. Provisional Application No. 63/378,559 filed on Oct. 6, 2022, the entire teachings of which are incorporated herein by reference.

Continuing with reference to FIG. 6A, the multiple passes 601 of the NLP analyzer 626 are made available for document processing in the ingestion engine (124, 224), and query execution in the search engine (136, 236), by an application programming interface (API) contained in each. As disclosed above, the ingestion engine (124, 224) and search engine (136, 236) include or communicate with instances of the NLP analyzer, such as the ingestion instance of the NLP analyzer (126-1, 226-1) and search instance of the NLP analyzer (126-2, 226-2).

The multiple passes 601 of the NLP analyzer 626 may be configured to execute sequentially or in parallel to elaborate a parse tree, such as represented via the parse tree document structure 755 of FIG. 7, disclosed further below. With reference to FIGS. 1, 2, 6A, and 6B, the multiple passes 601 may be further configured to cooperate to enable the ingestion instance of the NLP analyzer (126-1, 226-1) and search instance of the NLP analyzer (126-2, 226-2) to process the document text (130, 230) and query text (140, 240), respectively, in order to find the document SVO triplets (128, 228) or query SVO triplets (138, 238), respectively. In the example embodiment of FIG. 6A, the NLP analyzer 626 receives document text 630 or query text 640 from an NL document 632 or user query 616, respectively.

The parse tree may represent patterns found within the document text 630 or query text 640 by the NLP analyzer 626. The multiple passes 601 may include respective rules (not shown). The multiple passes 601 may be configured to execute respective methods (not shown). The respective methods may be configured to employ the respective rules, such as disclosed further below in greater detail. A final pass, such the pass 601-45 of the example embodiment, may be configured to provide the NLP analyzer SVO output 633 that may include tokens representing initial document hierarchical classifications or initial query hierarchical classifications assigned to word components of document SVO triplets or query SVO triplets, respectively, such as the document tokens 634 or query tokens 635, respectively.

Such document tokens 634 and query tokens 635 may be output in JSON format for non-limiting example. The multiple passes 601 may be configured to access the parse tree, modify the parse tree, access a knowledge base (KB) (referred to interchangeably herein as a lexical database), modify the KB, or combination thereof. An example embodiment of the KB is described below with regard to FIG. 6B.

FIG. 6B is a block diagram of the NLP analyzer of FIG. 6A and an example embodiment of a KB management system 619. The KB management system 619 comprises a lexical database, namely the KB 682. The KB 682 is a lexical database serving as a repository of lexical information. In the example embodiment of FIG. 6B, the lexical database, that is, the KB 682, includes the WordNet® database 672 and, thus, entries thereof, as well as supplemental entries (e.g., optional). The supplemental entries include word content (e.g., lexicons for non-limiting example) sourced from at least one language resource specific to at least one type of knowledge domain, such as from a physical sciences domain 607, life sciences domain 607b, . . . domain N 607n, or combination thereof. Such entries of the KB 682 have hierarchical classifications assigned thereto in the KB 682, such as the hierarchical classifications 303 and hierarchical classifications 503, disclosed above with regard to FIG. 3C and FIG. 5, respectively.

With reference to FIG. 6A and FIG. 6B, the NLP analyzer 626 and, thus, an instance thereof, such as the ingestion instance of the NLP analyzer (126-1, 226-1) and search instance of the NLP analyzer (126-2, 226-2), disclosed above with regard to FIG. 1B and FIG. 2, may be further configured to employ the KB 682 to assign the initial document hierarchical classifications or initial query hierarchical classifications, respectively. The NLP analyzer 626 may be configured to modify the KB 682, dynamically, based on information derived by the respective instance of the NLP analyzer 682 via processing of the document text 630 or query text 640 by the multiple passes 601.

As disclosed above, the multiple passes 601 of the NLP analyzer 626 are configured to execute respective methods. At least one method of the respective methods may be configured to process the document text 630 or query text 640 based on at least one grammatical context. The at least one grammatical context may include noun phrases for non-limiting example. A method of the respective methods may be configured to output the document SVO triplets or query SVO triplets found in the document text 630 and query text 640, respectively, and provide same in the SVO output 633. The method may be further configured to output the document SVO triplets or query SVO triplets in JSON format for non-limiting example, such as shown in the SVO output 733 of FIG. 7, disclosed below.

According to an example embodiment, the document SVO triplets may be reoriented such that the object precedes the verb to take advantage of the hierarchy (hypernymy) present in nouns to produce a modified SVO triplet (MSOV) for which the initial hierarchical classifications assigned to the components is maintained. Machine language coding may be applied based on string lengths of permutations of same. Such methodology may be employed in building a compiler in which the stored SVOs/MSOVs may be machine coded from the outset and could, for non-limiting example, be employed by the NLP analyzer 626 for producing an output of document SVO triplets or query SVO triplets in JSON format for non-limiting example, such as in the SVO output 733 of FIG. 7, disclosed below.

FIG. 7 is a labeled screen shot of an example embodiment of a development environment 700 for the NLP analyzer 626 of FIGS. 6A and 6B, disclosed above. According to an example embodiment, the NLP analyzer 626 can be modified to embellish the nodes of the parse tree itself, such as the parse tree 755 of the developer environment 700. In the developer environment 700 (interpreted environment), a programmer can dynamically (“on the fly”) write new code and test it by rerunning the NLP analyzer 626 on the current input text. No programming language compilation and no rebuilding of the NLP analyzer 626 is required. Code can refer to parse tree nodes and other analysis data structures available to it. According to an example embodiment, specialized capabilities may be built into the code of the NLP analyzer 626 to reference the nodes that matched an element of a current rule, the nodes built by the rule, context nodes that dominate the nodes that matched the current rule, nodes associated with thereto, and global data structures for the analysis of the current input text. A layout of an analyzer pass file defines the machinery for executing the rules and the code for the associated analyzer pass. Such a file defines the contexts in which rules will be applied and associates code with the rules and with the act of finding contexts in the parse tree.

In the development environment 700, full analysis, from input text, such as the document text 730, to output SVOs, such as shown in the SVO output 733 window, is shown. Such analysis is performed via the multiple analyzer passes 701, respective code and rules thereof, operating on a parse tree, such as represented via the parse tree document structure 755 for non-limiting example. The SVO output 733 may be provided to an instance of an SVO analyzer (262-1, 262-2), disclosed above with regard to FIG. 2, such as by providing the SVO output 733 in an intermediate JSON format or other data format to an SVO parsing function of the instance of the SVO analyzer, such as the SVO parsing function of the “JJ5” processing step of FIG. 8B, disclosed further below with regard to FIG. 8A, disclosed below.

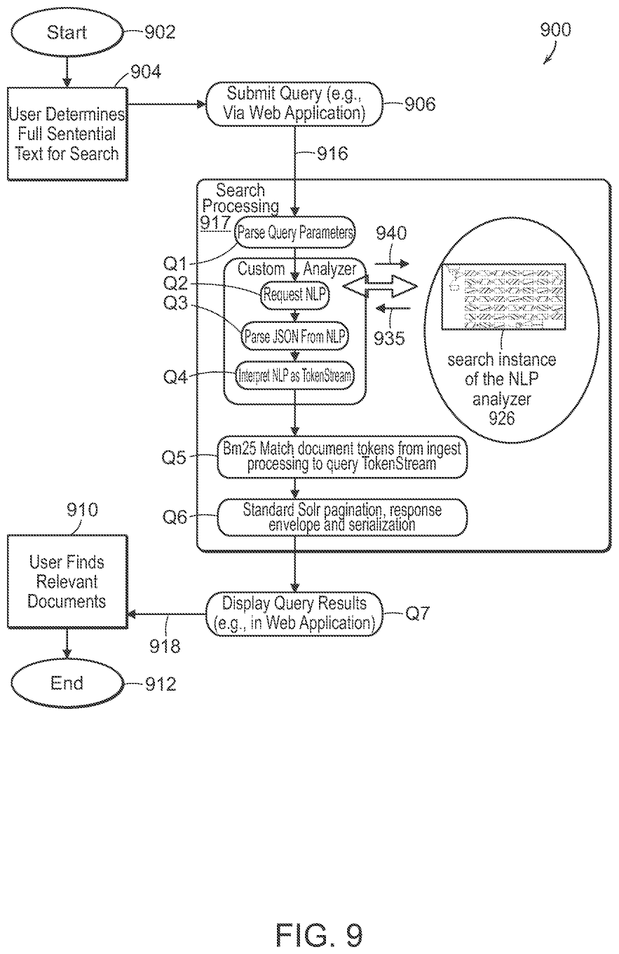

FIG. 8A is a data flow diagram 800 of an example embodiment of data flow and processing in a system disclosed herein, such as the system 90, system 102, or system 202, disclosed above with regard to FIG. 1A, FIG. 1B, and FIG. 2, respectively. Such data flow and processing occurs prior to a query, such as the query 116 and 216, disclosed above with regard to FIG. 1B and FIG. 2, respectively, and the corresponding query processing is disclosed with reference to FIG. 9, further below. In the data flow diagram 800, data 881 from a repository 882, such as the public PubMed® repository 882 for non-limiting example, may be manually downloaded 883 to a data source 822, such as a data disk, database, SharePoint®, ftp site, etc. for non-limiting examples.

An NL document 832 may be pushed or pulled from the data source 822 for processing by the ingestion engine 824 that may be employed as the ingestion engine 124 or ingestion engine 224 disclosed above. Such processing may include an extract, transform, and load (ETL) procedure 850 on the NL document 832 in order to produce a document token stream 844 for ingestion by the search engine 836. The document token stream 844 may be formatted using standard Solr document encoding for ingestion by the search engine 836 that may be based on an Apache® Solr open-source search platform. It should be understood, however, that the search engine may be based on another type of search platform, such as Elasticsearch or a custom search platform accepting queries to be matched against an inverted index. As such, the document token stream 844 need not be formatted using standard Solr document encoding. The ETL procedure 850 as implemented by the ingestion engine 824 may be referred to herein as “JesterJ ingestion”-it should be understood however, that the ETL procedure need not employ JesterJ for implementing same. A flow diagram of an example embodiment of the ETL procedure 850 is disclosed below with regard to FIG. 8B.

FIG. 8B is a flow diagram of an example embodiment of the ETL procedure 850 that may be implemented by an ingestion engine disclosed herein, such as the ingestion engine 124 and 224, disclosed above with regard to FIG. 1B and FIG. 2, respectively. The ETL procedure 850 may be referred to as a method 850 interchangeably herein. In the example embodiment of FIG. 8B, the method 850 begins (852) and performs the following steps labelled as JJ1 . . . . JJ15 with corresponding method names (non-limiting) that may be taken during document ingestion and pre-analysis:
JJ1 ScanFiles
   Walks the local file system of the data source 822 looking for data files.
JJ2 StaxExtract
   Parses the XML files found and extracts information such as journal name, abstract. and author lists (for the non-limiting example of journal articles).
JJ3 TikaExtract
   Removes the XML tags and supplies a plain text version of the source document 830 (note that the use of Apache Tika™ is a non-limiting example and alternate tools or custom code may perform this function). Any number of further steps may be added before or after this extraction step to improve the source data or extracted plain text. This may serve to make processing in JJ5 more effective or may serve to acquire further metadata, but are not topical for the purposes of this disclosure. Non-limiting examples might include removal or extraction of text corresponding to data tables, removal or special treatment of math-equation-related content, restoration of continuity for sentences broken across pages, or special treatment of titles and headings, or a combination thereof.
JJ4 CopyToText
   Copies the extracted text to the default search field for non-SVO search purposes (i.e., standard, common analysis, and search as provided by existing search software, such as Solr, Elasticsearch, etc. for non-limiting examples).
JJ5 SVOParse
   Consumes the extracted text (i.e., document text) 830, passes it to an external process, namely the ingestion instance of the NLP analyzer 826, that may be running native code via Java Native Interface (JNI) for non-limiting example. The external process executes steps AUG 001 through AUG 045, disclosed above with regard to FIGS. 6A and 6B, to produce the SVO output 834 in, for example, intermediate JSON format for non-limiting example. The SVO output 834 in the intermediate JSON format is returned to the SVOParse step JJ5 where it is parsed and converted to the standard Solr pre-analyzed text format expressed as JSON for non-limiting example.
   According to an example embodiment, the NLP analyzer 826 may be implemented as of a pool of Java processes or threads executing JNI code to perform NLP on request.
JJ6 CopyPreJson
   Stores a separate copy of the pre-analyzed file in JSON format from JJ5 for debugging purposes only.
JJ7 FormatAccessed
   Formats the accessed date (from the *.nxml file) to a standard ISO_INSTANT format.
JJ8 FormatCreated
   Formats the created date (from the *nxml file) to an standard ISO_INSTANT format.
JJ9 FormatModified
   Formats the modified date (from the *nxml file) to an standard ISO_INSTANT format.
JJ10 FormatByteSize
   Applies numeric format to the size in bytes.
JJ11 FormatFileSize
   Applies numeric format to the file size.
JJ12 FormatDocRawSize
   Applies numeric format to the DocRawSize.
JJ13 TrimPubYear
   Ensures the pub_year field does not have extraneous whitespace.
JJ14 CopyJournalField
   Makes a String typed copy of the Journal field.
JJ15 SentToSolr
   Transmits the final analyzed document to the search engine 836 (e.g., implement using Solr) for storage in an inverted index, such as the inverted index 242 of FIG. 2, disclosed above. Note that steps JJ7 through JJ14 are specific to the journal article based example embodiment and may vary as required for various other use cases.

In the method 850, data flow between steps JJ1 through JJ15 may be in the form of document objects within a Java virtual machine (JVM) for non-limiting example, carrying data as transformed or extracted by each step in the process. Following the JJ15 step, the method 850 thereafter ends 852 in the example embodiment, having enabled the search engine 836 to store a representation of the NL document 132 in an inverted index for matching to a query via search processing in the search engine 836, such as disclosed below with regard to FIG. 9.

FIG. 9 is a flow diagram of an example embodiment of a method 900 for producing a response to a query. The method 900 begins (902) and a user determines a full sentential text for a search (904) and submits same via a Web application (906) for non-limiting example to a search engine, such as the search engine 836, disclosed above with regard to FIG. 8, or the search engine 136 or search engine 236, disclosed above with regard to FIG. 1B and FIG. 2, respectively. The query 916 is received by search engine and search processing 917 is performed via steps Q1 through Q6 disclosed below with respective non-limiting method names. While the Q1-Q6 are describe below with regard to Solr, it should be understood that the search processing 917 is not limited to being implemented via Solr.
Q1 ParseQueryParameters
   Standard Solr parameter processing, with df=svo_content to search against the svo_content field.
Q2 Request NLP
   Passes the query text 940 to the search instance of the NLP analyzer 926 that may be implemented as an external process running JNI native code for non-limiting example. The external process, namely, the search instance of the NLP analyzer 926, executes steps AUG 001 through AUG 045 disclosed above with regard to FIGS. 6A and 6B and produces the SVO output 935 (also known as SVO output 635) that may be in an intermediate JSON format.
Q3 ParseJSON from NLP
   Converts the JSON data into java objects.
Q4 Interpret NLP as Token stream
   Converts the Java Objects into a Lucene™ Token Stream for non-limiting example.
Q5 BM25 Match processing
   Query tokens created in Q4 are matched against index tokens created by JJ5 of FIG. 8, disclosed above, using the standard BM25 matching method for non-limiting example. The standard BM25 method is pluggable in Lucene/Solr. Alternatively, a classic term frequency (TF)-inverse document frequency (IDF) or custom similarity method may be employed.
Q6 Pagination, response envelope and serialization
   Standard Solr capabilities to return the response in JSON/XML or “JavaBin” format.
Q7 Display Results
   Application displays results to the user.

As such, the response 918 has been returned to the user, for example, via a visual display screen of an electronic device for non-limiting example, and the user finds the relevant documents (910) that are relevant to the query 916, and the method 900 thereafter ends (912) in the example embodiment, having facilitated expansion of knowledge for the user.

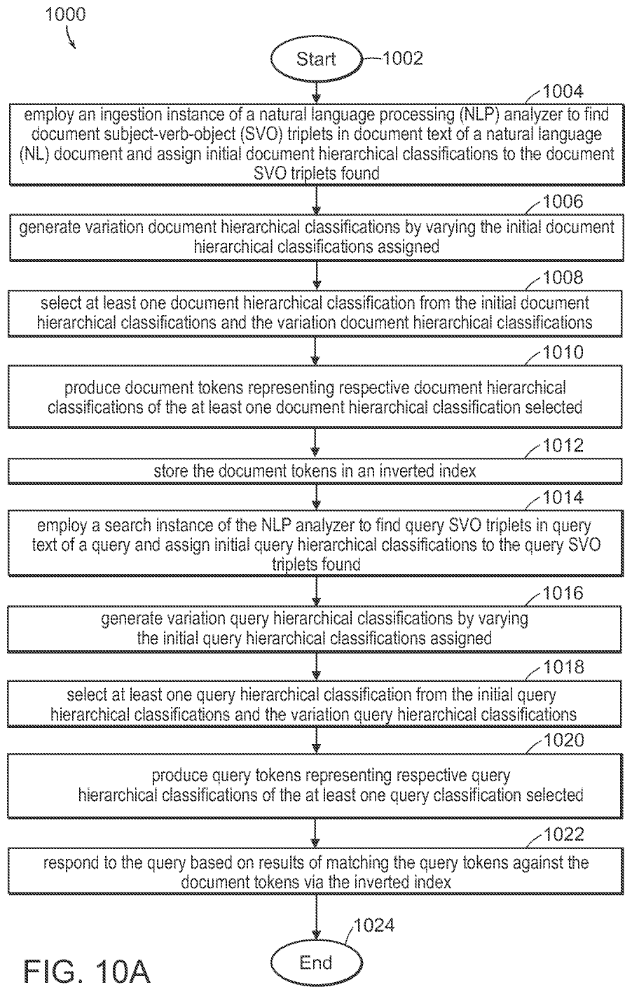

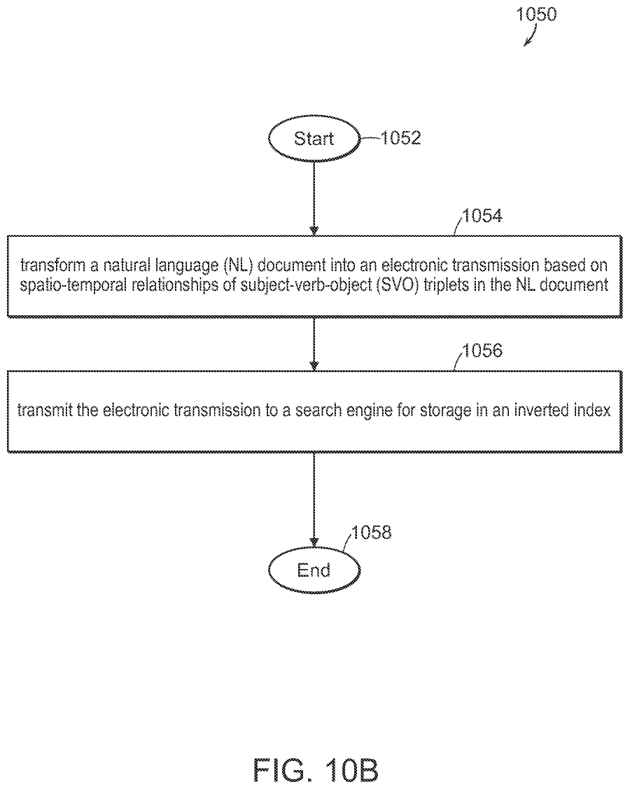

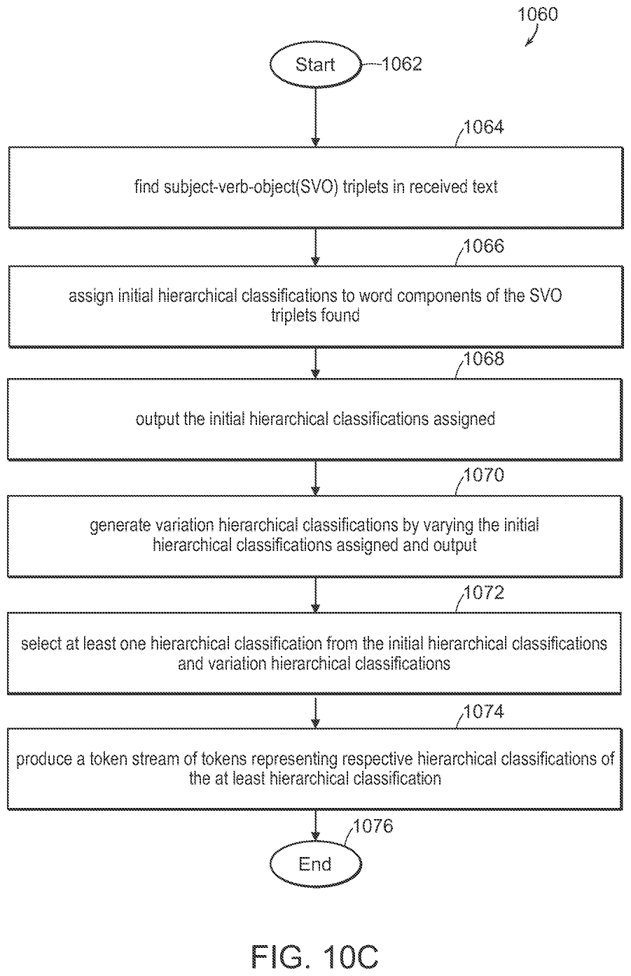

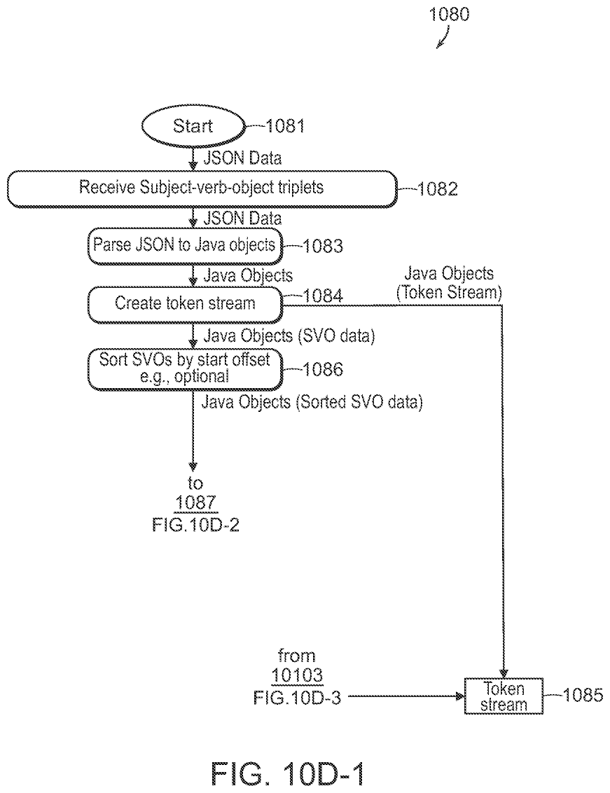

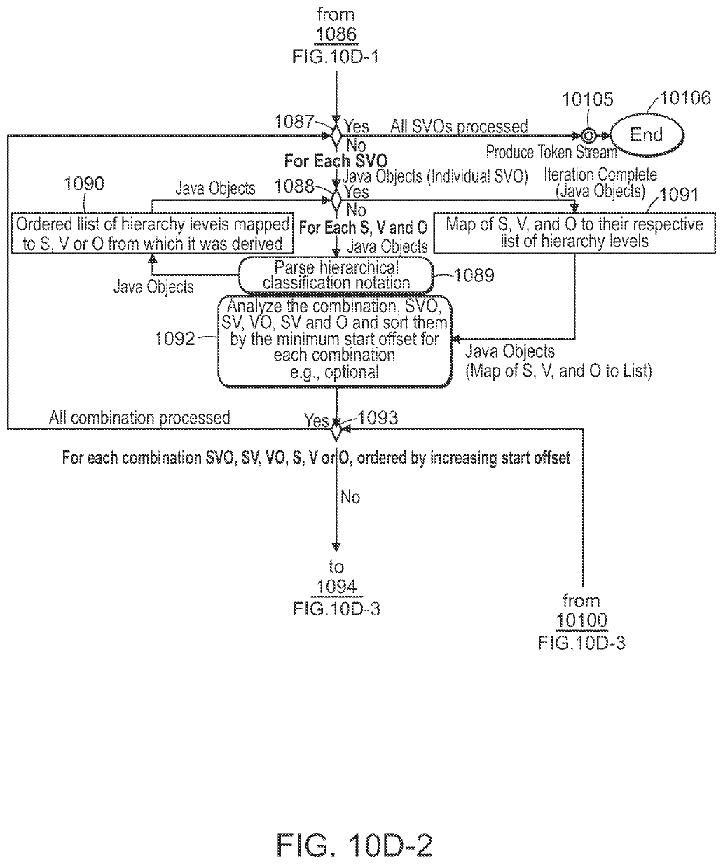

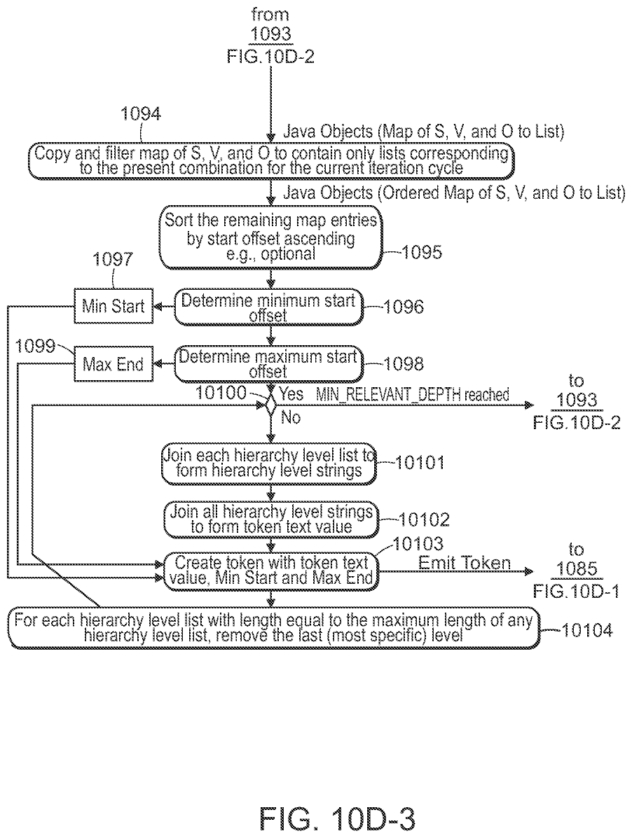

FIG. 10A is a high-level flow diagram of an example embodiment of a computer-implemented method 1000 that may be implemented in a system disclosed herein, such as the system 90, system 102, or system 202, disclosed above with regard to FIG. 1A, FIG. 1B, and FIG. 2, respectively. The method begins (1002) and, employs an ingestion instance of a natural language processing (NLP) analyzer to find document subject-verb-object (SVO) triplets in document text of a natural language (NL) document and assign initial document hierarchical classifications to the document SVO triplets found (1004). The method generates variation document hierarchical classifications by varying the initial document hierarchical classifications assigned (1006). The method selects at least one document hierarchical classification from the initial document hierarchical classifications and the variation document hierarchical classifications (1008). The method produces document tokens representing respective document hierarchical classifications of the at least one document hierarchical classification selected (1010) and stores (1012) the document tokens in an inverted index. The method employs a search instance of the NLP analyzer to find query SVO triplets in query text of a query and assigns initial query hierarchical classifications to the query SVO triplets found (1014). The method generates variation query hierarchical classifications by varying the initial query hierarchical classifications assigned (1016). The method selects at least one query hierarchical classification from the initial query hierarchical classifications and the variation query hierarchical classifications (1018). The method produces query tokens representing respective query hierarchical classifications of the at least one query hierarchical classification selected (1020), and responds to the query based on results of matching the query tokens against the document tokens via the inverted index (1022). The computer-implemented method 1000 thereafter ends (1024) in the example embodiment. FIG. 10A depicts a high-level view of the overall process, that is, the method 1000. An automated process driving the actions 1004, 1006, 1008, 1010, and 1012 may be entirely distinct from the actions 1014, 1016, 1018, 1020, and 1022. Furthermore, it should be understood that an arbitrary amount of time passes between 1012 and 1014 and this time gap is normally expected to be many orders of magnitude larger relative to a small-time gap between other actions. Actions such as 1004 through 1012 may be at least partially automated without user input, whereas 1014 through 1022 may be driven (for non-limiting example) in response to a user's search request. It should be understood however, that the actions 1014 through 1022 may be driven, automatically, absent user input. Driving the entire method 1000 via a single request/process is theoretically possible, but unlikely to be useful in real world applications.

Alternative method embodiments parallel those described above in connection with the example embodiments of the system 102 and system 202 of FIG. 1B and FIG. 2, respectively.

FIG. 10B is a flow diagram of another example embodiment of a computer-implemented method 1050 that may be implemented in a system disclosed herein, such as the system 90, system 102, or system 202, disclosed above with regard to FIG. 1A, FIG. 1B, and FIG. 2, respectively. The computer-implemented method 1050 begins (1052) and comprises transforming (1054) a natural language (NL) document into an electronic transmission based on spatio-temporal relationships (e.g., linguistic positional, proximity, and ordering relationships) of subject-verb-object (SVO) triplets in the NL document. The electronic transmission includes hierarchical classifications assigned to component words of the SVO triplets. The spatio-temporal relationships are represented by positional and ordering relationships of the SVO triplets in the NL document. The computer-implemented method further comprises transmitting (1056) the electronic transmission to a search engine for storage in an inverted index. The hierarchical classifications enable the search engine to determine, via the inverted index, relevancy of the NL document to a query and direct a user to the NL document based on the relevancy to the query determined. The computer-implemented method 1050 thereafter ends (1058) in the example embodiment.

FIG. 10C is a flow diagram of another computer-implemented method 1060 that may be implemented in a system disclosed herein, such as the system 90, system 102, or system 202, disclosed above with regard to FIG. 1A, FIG. 1B, and FIG. 2, respectively. The computer-implemented method begins (1062) and finds (1064) subject-verb-object (SVO) triplets in received text. The computer-implemented method assigns (1066) initial hierarchical classifications to word components of the SVO triplets found and outputs (1068) the initial hierarchical classifications assigned. The computer-implemented method generates (1070) variation hierarchical classifications by varying the initial hierarchical classifications assigned and output. The computer-implemented method selects (1072) at least one hierarchical classification from the initial hierarchical classifications and variation hierarchical classifications. The computer-implemented method produces (1074) a token stream of tokens representing respective hierarchical classifications of the at least one hierarchical classification selected. The computer-implemented method thereafter ends (1076) in the example embodiment.

FIG. 10D-1 is a flow diagram of an example embodiment of a computer-implemented method 1080 for producing a token stream, such as the token stream 94 of FIG. 1A, disclosed above, or any other token stream referenced herein.

FIG. 10D-2 is a continuation of FIG. 10D-1.

FIG. 10D-3 is a continuation of FIG. 10D-2.

With reference to FIG. 10D-1, the method begins (1081) and receives (1082) subject, verb, and object triplets (i.e., SVOs) corresponding to each sentence, clause, or clause inferred from a phrase (such as inferred, for non-limiting example, by the AUG 042 pass, that is, the xclausesem100 of the NLP analyzer, disclosed above). Each subject, verb, and object may be individually annotated with hierarchical classifications, and start/end offsets indicating position in the original text including the SVO triplet. Such SVO triplets may be document or query SVO triplets, such as disclosed above, and may be received (with the associated hierarchical classifications and start/end offsets) as JSON data, for non-limiting example, from an NLP analyzer, such as the NLP analyzer 626, disclosed above.

The NLP analyzer may generate the SVO triplets and associated initial hierarchical classifications and start/end offsets based on processing text data, for example, from full text including multiple sentences supplied, for non-limiting example, as a query, such as disclosed above. Continuing with reference to FIG. 10D-1, the method parses (1083) the JSON data to Java objects. It should be understood, however, that the method is not limited to JSON format and that another type of data format may be used. Similarly, while the use of Java may be convenient due to the availability of the Apache Lucene open source software, it should be understood that the method may be implemented in other languages where a token stream can be conceptualized. Additionally, the several sorting actions, e.g., by start offset, disclosed below, should be understood to be optional as such sorting may be performed to satisfy a limitation of the Apache Lucene software, whereas another implementation may not require sorting.

Following the parsing (1083), the method creates (1084) a token stream 1085 that may include the Java objects that are able to accept tokens. The method then proceeds to perform actions for generating the tokens for emitting to same. The method may sort (1086) the SVOs, by start offset for non-limiting example, to produce Java objects sorted by SVO data thereof, and the method proceeds to process each SVO as disclosed in FIG. 10D-2. With reference to FIG. 10D-2, the method proceeds to iteratively process each SVO until a check (1087) indicates that all SVOs have been processed, in which case the method produces (10105) the token stream 1085 and the method thereafter ends (10106) in the example embodiment.

As such, the check (1087) may serve as an entry point into a first loop that iterates for each SVO and, within that first loop, the check (1088) may serve as an entry point into a second loop that iterates for each subject (i.e., S), verb (i.e., V), and object (i.e., O) of each of the Java objects. The second loop parses (1089) the hierarchical classification notation for each S, V, and O of a SVO (e.g., of a Java object) into an ordered list (1090) of hierarchical levels mapped to the S, V, or O from which it was derived. Once the iteration is deemed complete (at 1088), the method proceeds to transform (1091) the ordered lists to a map of lists representation, for example, a map of each S, V, and O to their respective list of hierarchical levels. The method then proceeds to analyze (1092) the combinations of SVO, SV, VO, SV, and O, for non-limiting example, and may, optionally, sort such combinations by the minimum start offset for each combination.

The method may then proceed to process each combination SVO, SV, VO, S, V, or O, ordered, optionally, by increasing offset and check (1093) if all combinations of a SVO have been processed. If yes, the method may again check (1087) if all SVOs (e.g., all Java objects) have been processed, as disclosed above. If, however, all combinations of the SVO have not been processed, the method proceeds to process each combination SVO, SV, V, or O, ordered, optionally, by increasing start offset as disclosed with reference to FIG. 10D-3. Such combinations may represent variation hierarchical classifications and the method may select at least one hierarchical classification from the initial hierarchical classifications and the variation hierarchical classifications. It should be understood that the list of combinations at 1093 may be varied to tune the desired relevancy. Such tuning (selecting) may be based on at least one configuration parameter or user input.

With reference to FIG. 10D-3, the method proceeds to copy and filter (1094) the map of S, V, and O to contain only lists that correspond to the present combination for the current iteration cycle. The method sorts (1095), optionally, the remaining map entries by start offset (e.g., ascending) and determines (1096) the minimum start offset (i.e., the min start 1097) and determines (1098) the maximum end offset (i.e., the max end 1099).

The method then checks (10100) whether a minimum relevant depth (i.e., MIN_RELEVANT_DEPTH) parameter value has been reached. The minimum relevant depth parameter is a tuning parameter that prevents overly general tokens from being generated. The minimum relevant depth may represent a minimum number of hierarchical levels among all lists for the SVO. If the check (10100) indicates that the minimum relevant depth has been reached, the method returns to check (1093) if all combinations have been processed, as disclosed above with regard to FIG. 10D-2.

Continuing with reference to FIG. 10D-3, if the check (1093) determines that the minimum relevant depth has not been reached, the method joins (10101) each hierarchical level list to form hierarchical level strings and joins (10102) all hierarchical level strings to form a token text value. Such joining may include joining with a character separating same, such as a pipe (“|”) character for non-limiting example. The method then creates (10103) a token with the token text value, min start 1097, and max end 1099, and emits the token to the token stream 1085 of FIG. 10D-1. Such token may, for example, be emitted to a Java object of the token stream 1085. According to an example embodiment, any token may be skipped (e.g., not selected) or the same token may be emitted to the token stream multiple times to tune relevancy. Additional payloads may be added to tokens as text labels, integers, floating point numbers or vectors/matrices of numbers (non-limiting examples). Such payloads may be calculated by undisclosed proprietary methods, third-party software, or other methods known in the art at the present time or developed in the future and such payloads may be used to influence a custom similarity scoring, noted above, and elsewhere. It should be understood that the attachment of payloads to tokens is a standard feature in Apache Lucene.

The method continues and may, for each hierarchical level list with a length equal to the maximum length of any hierarchical level list, remove (10104) the last (most specific) hierarchical level, and check (10100) whether the minimum relevant depth has been reached. If not, the method may again perform the (10101, (10102), and (10103) actions and emit additional tokens while the max length among all hierarchical level lists in the ordered map S, V, or O list is greater than or equal to the minimum relevant depth.

As such, once the minimum relevant depth has been reached, the method returns to the check (1093) to determine whether all combinations for the SVO have been processed, as disclosed above with regard to FIG. 10D-2, and, if so, the method checks (1087) if all SVOs have been processed. If not, the method processes another SVO via the first loop, and proceeds as disclosed above. If, however, all SVOs have been processed, the method produces (10105) the token stream, that is the token stream 1085 of FIG. 10D-1 having the Java objects populated with tokens emitted thereto, and the method thereafter ends (10106) in the example embodiment. FIGS. 12-1 through 12-18, disclosed further below, include a listing of example JSON representing such a token stream for the SVO triplet of FIG. 11, disclosed below.

FIG. 11 is a listing of example JavaScript object notation (JSON) 1100 produced for an example subject-verb-object (SVO) triplet 1162 from a sentence according to an example embodiment. In the example embodiment, the example subject-verb-object (SVO) triplet 1162 includes a subject 1171 component “interaction,” verb 1172 component “generates,” and object 1173 component “roughness” from the sentence: “The interaction of plasma with polymeric substrates generates both roughness and charging on the surface of the substrates.” It should be understood that the sentence and SVO triplet 1162 thereof are for non-limiting example. In the example embodiment, components of the SVO triplet, namely the subject 1171, verb 1172, and object 1173 components, have been assigned hierarchical classifications 1103-1, 1103-2, and 1103-3, respectively. Such hierarchical classifications 1103-1, 1103-2, and 1103-3 (e.g., designated as a hierarchy identifier “hid” in FIG. 11) may be retrieved from the knowledge based that may have entries assigning same to the subject 1171, verb 1172, and object 1173 components. Such hierarchical classifications 1103-1, 1103-2, and 1103-3 may be referred to as initial hierarchical classifications.

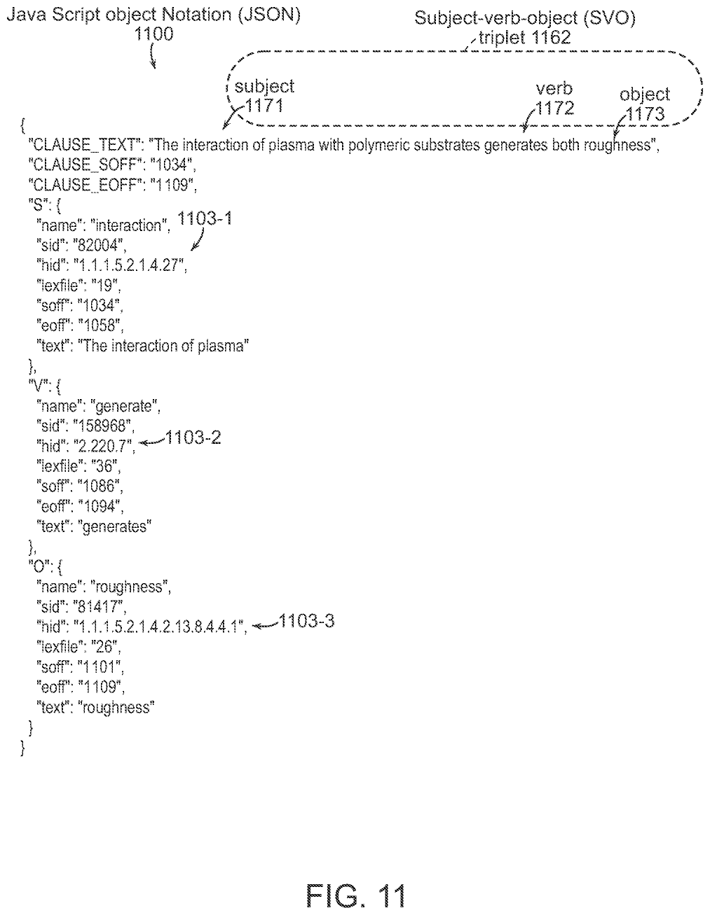

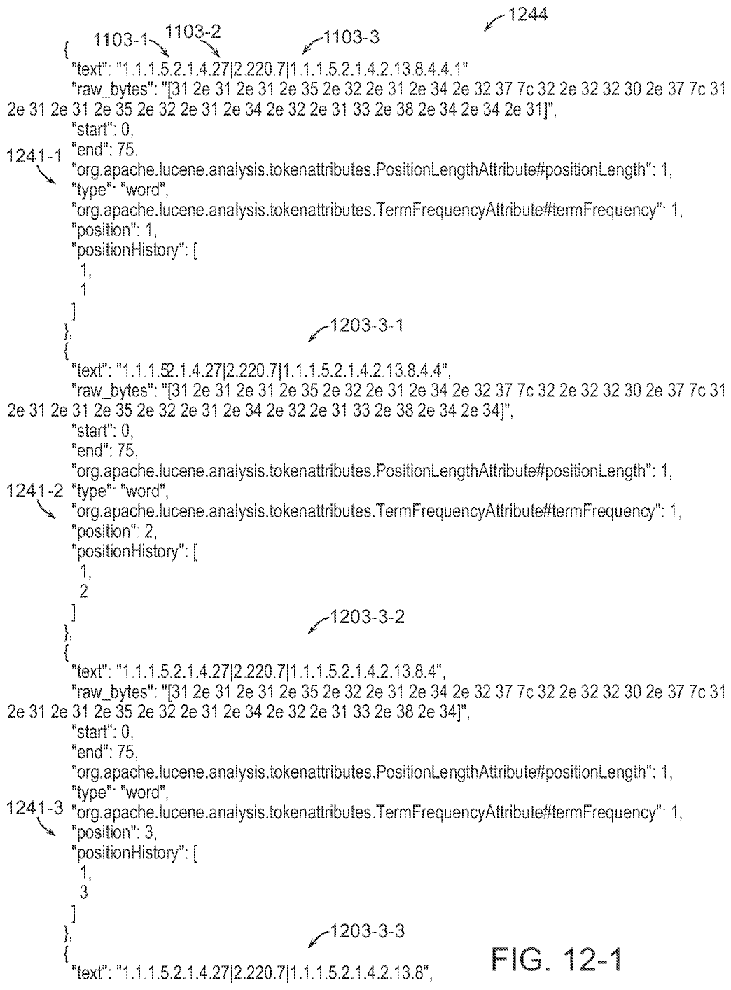

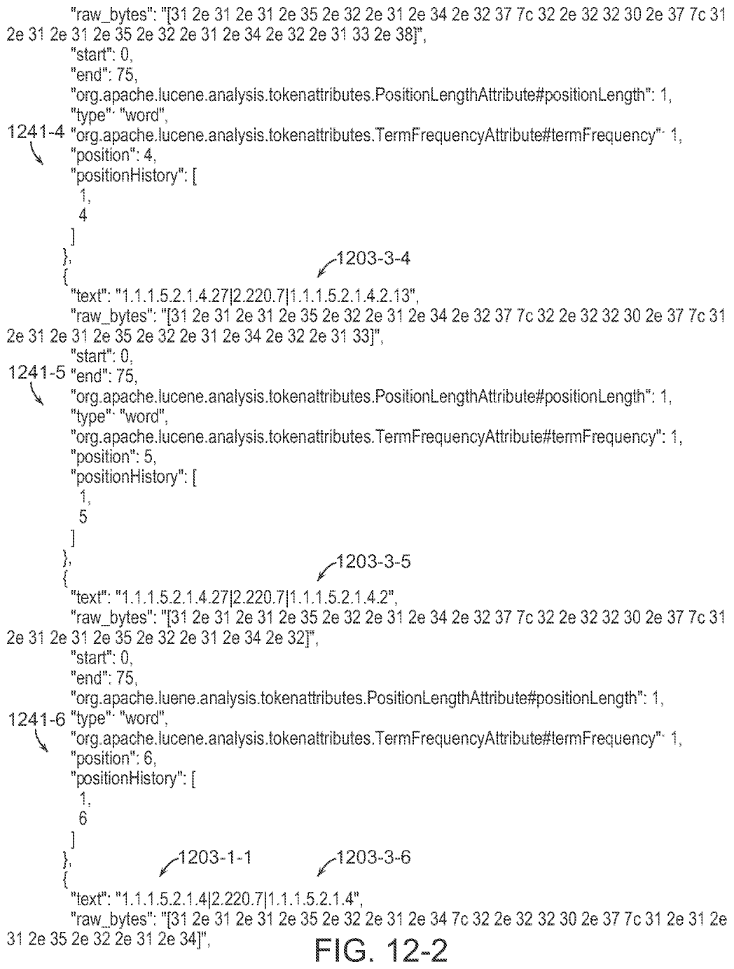

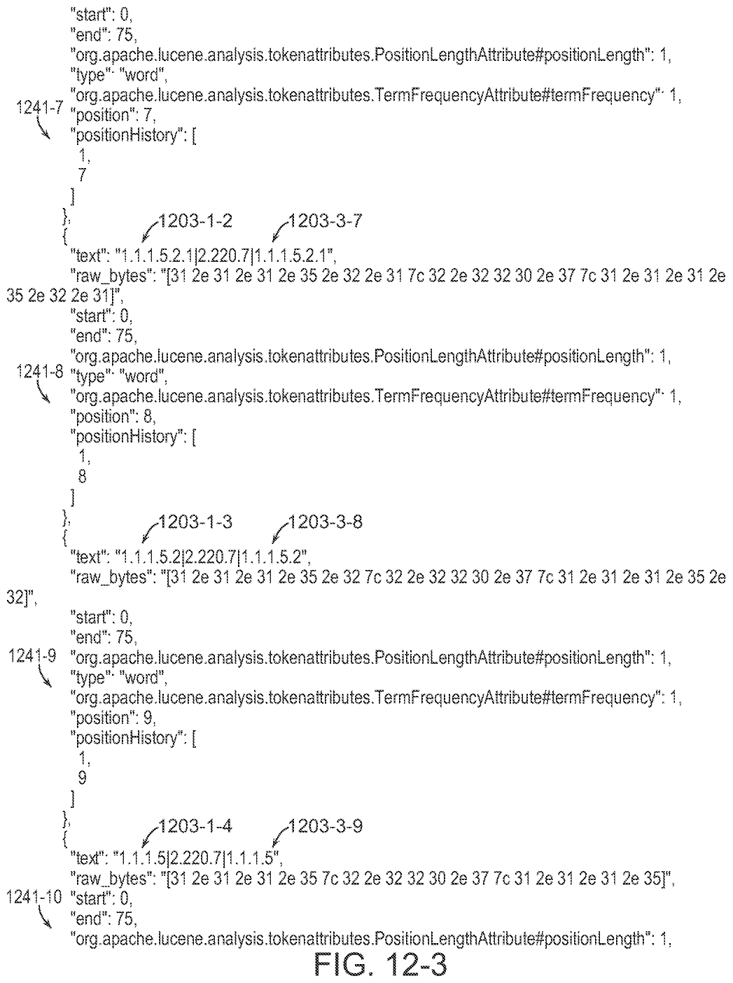

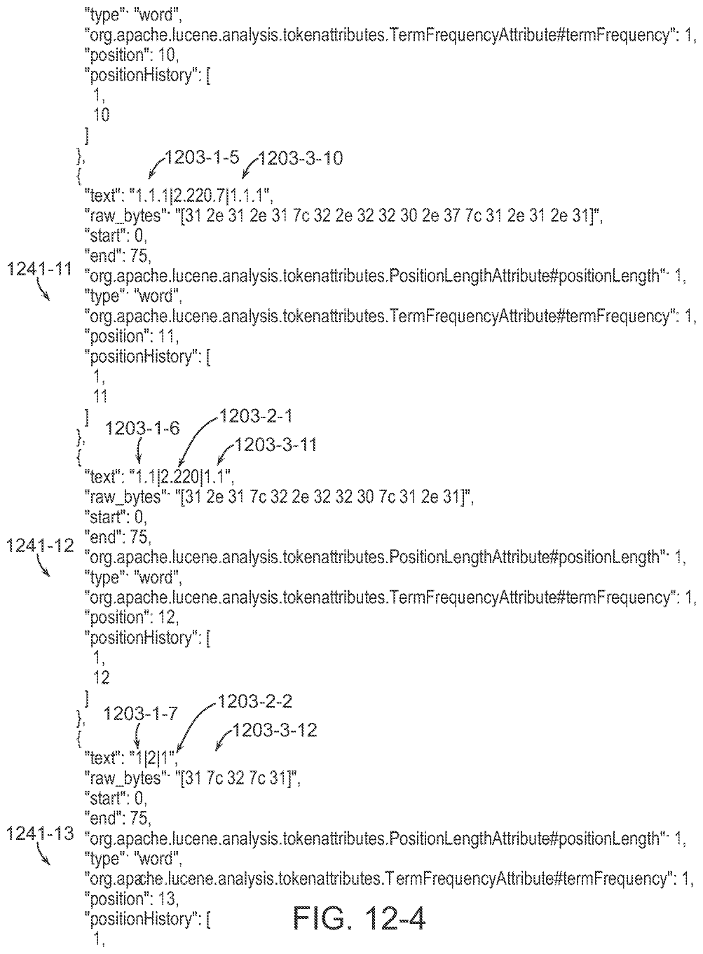

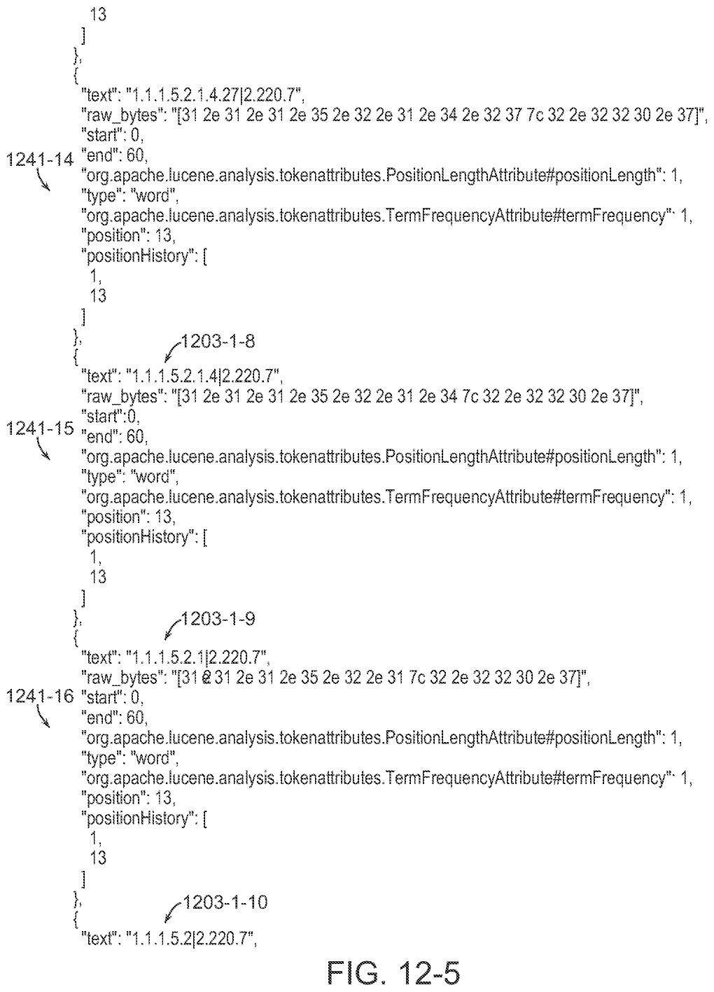

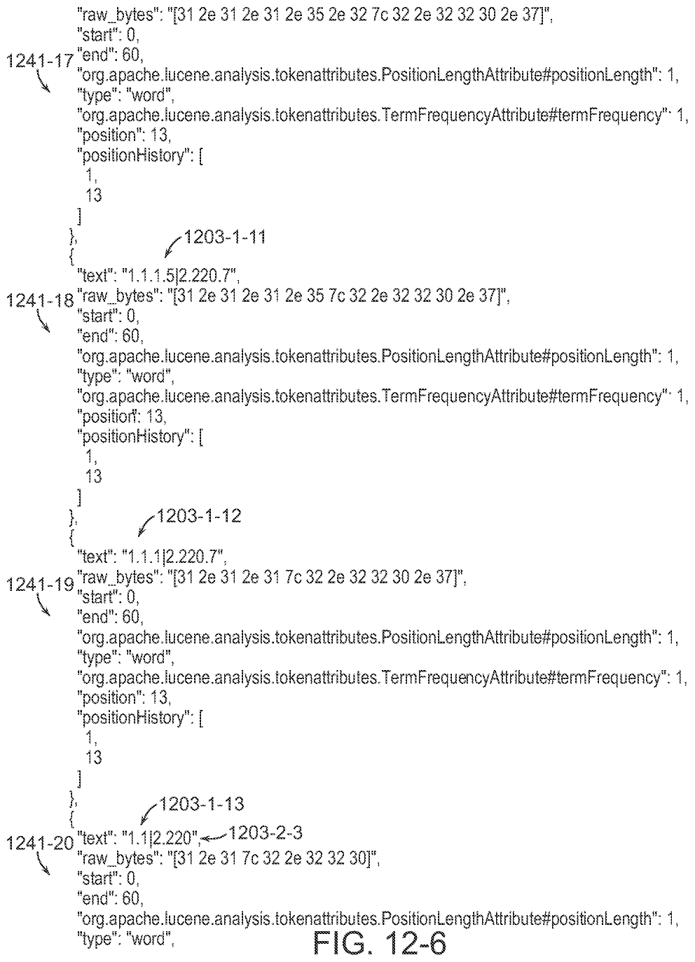

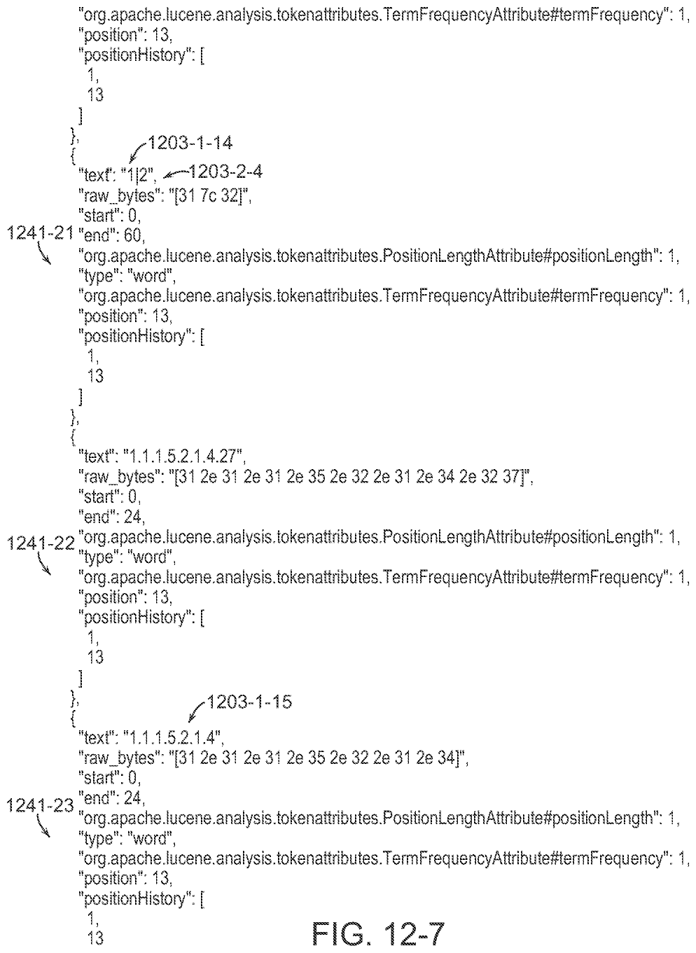

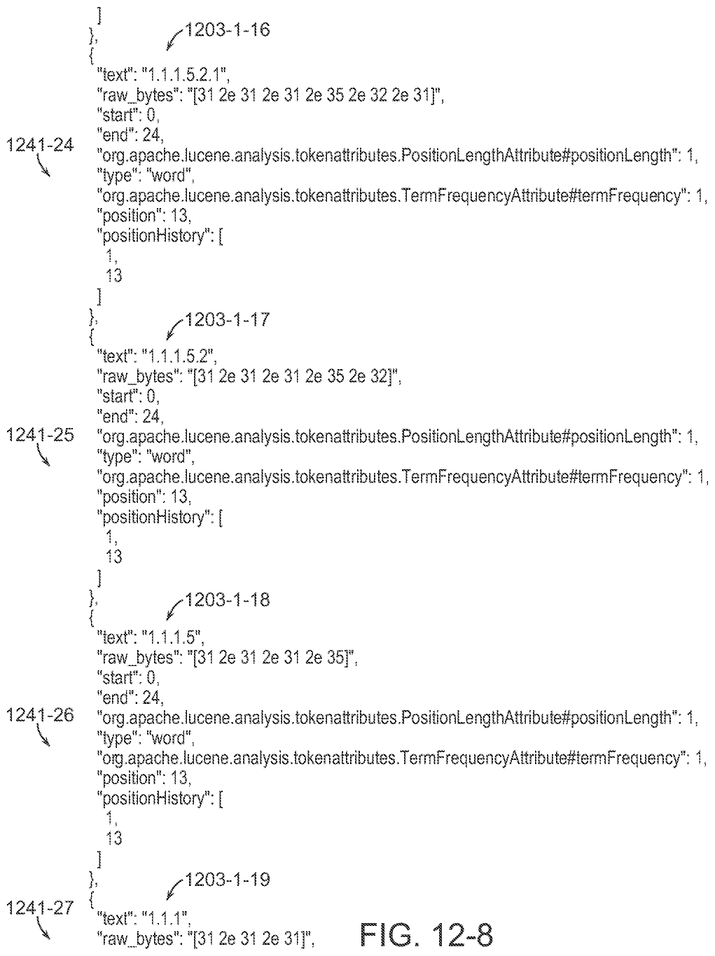

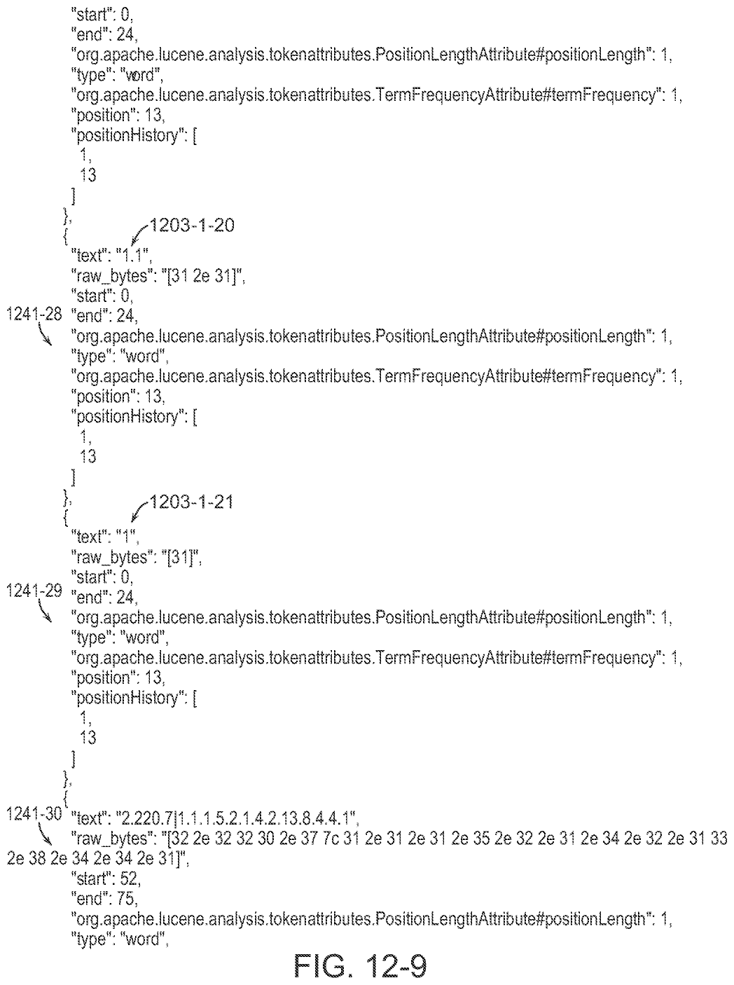

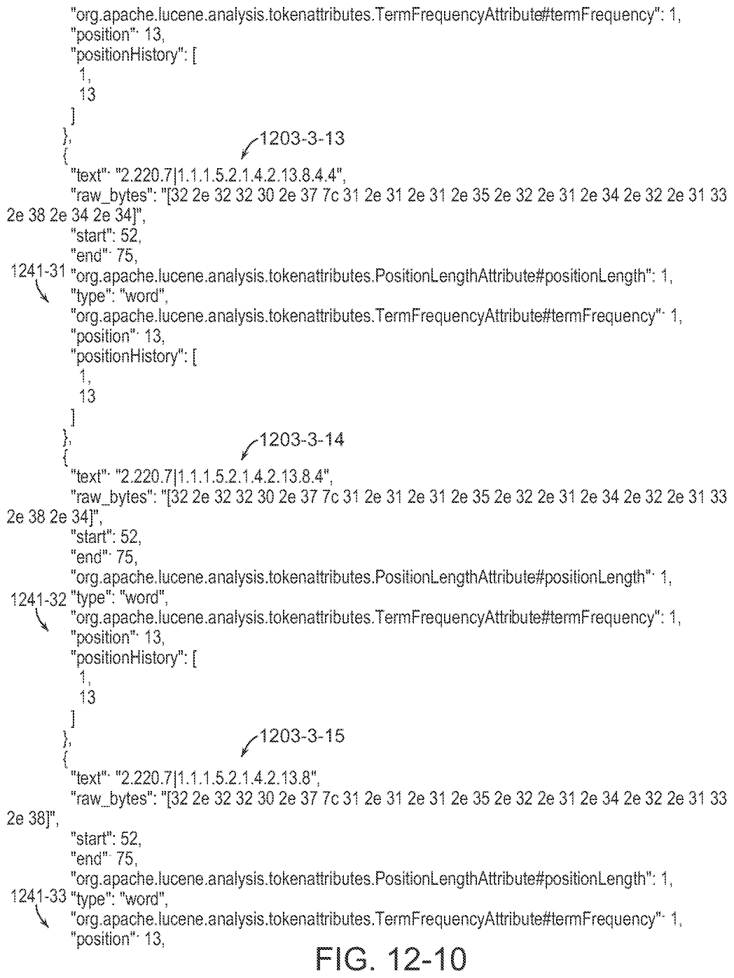

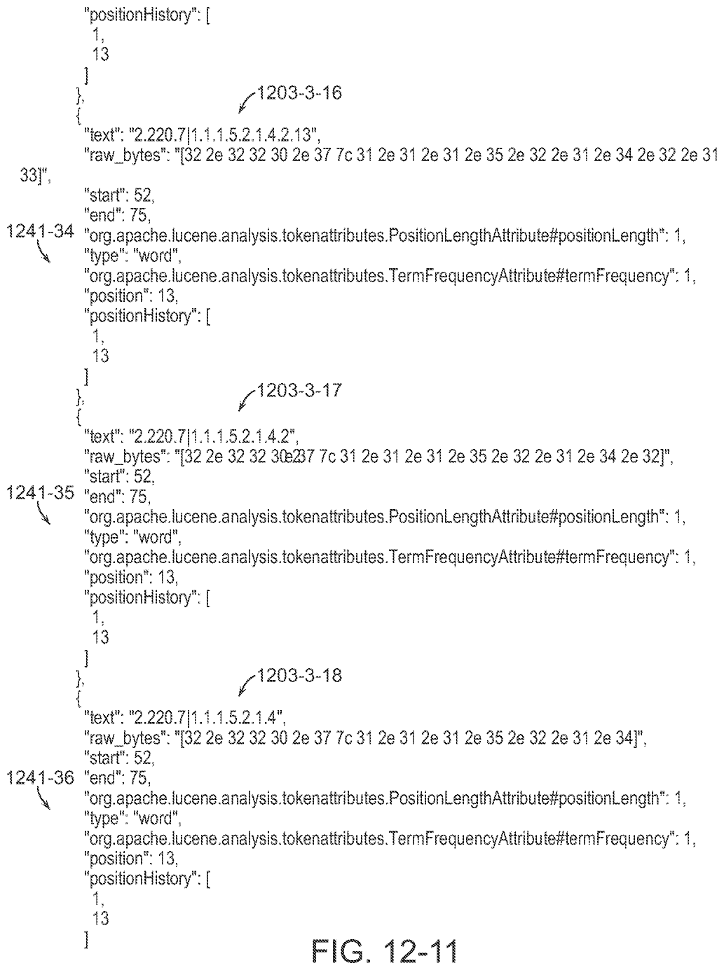

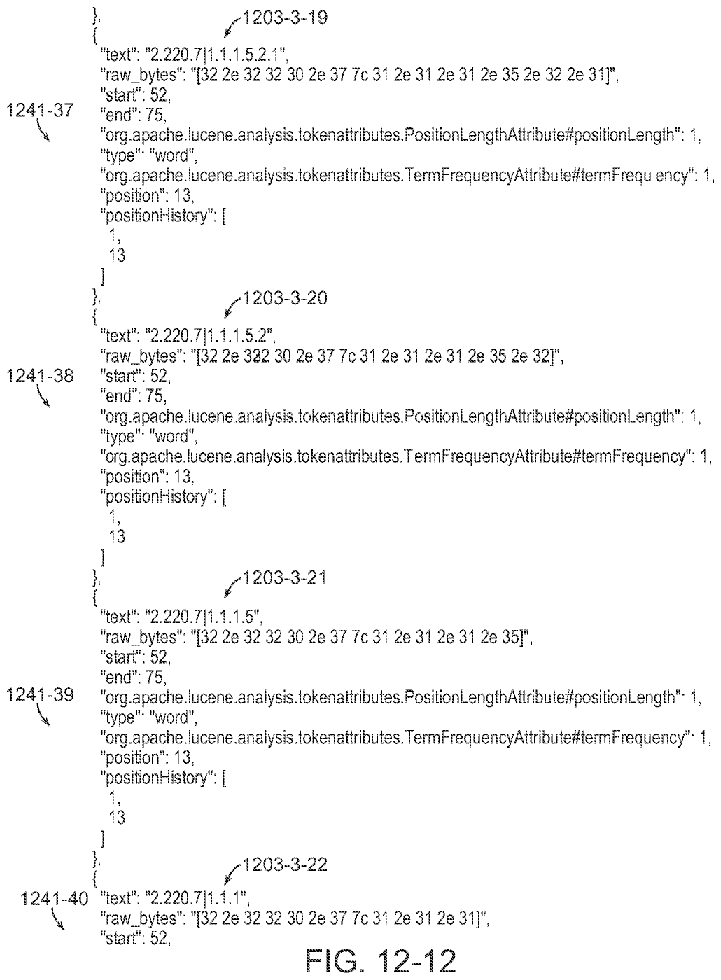

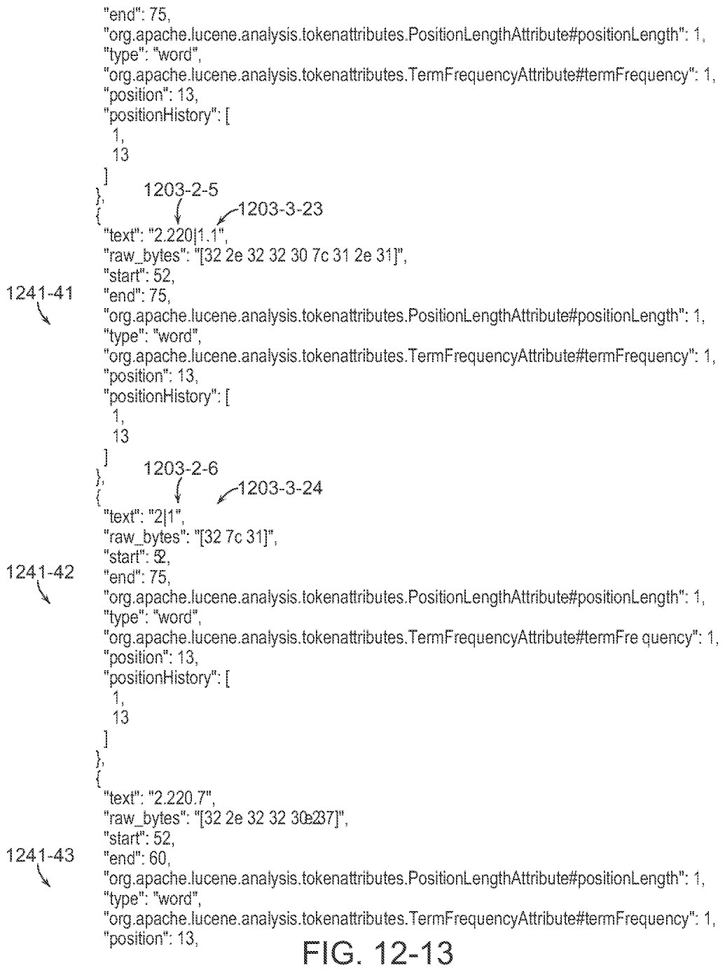

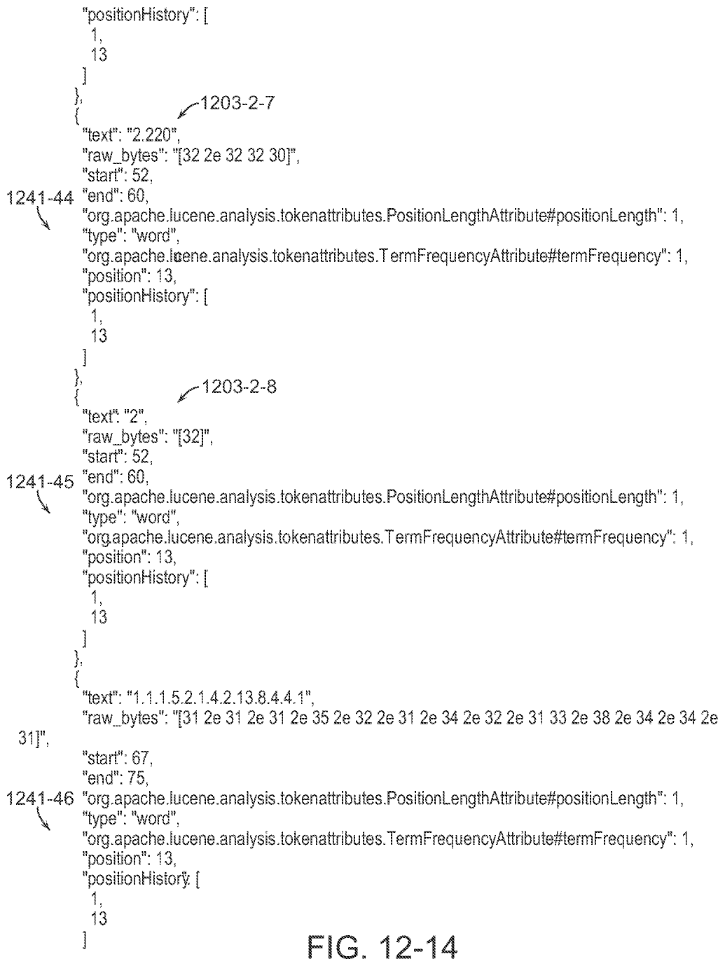

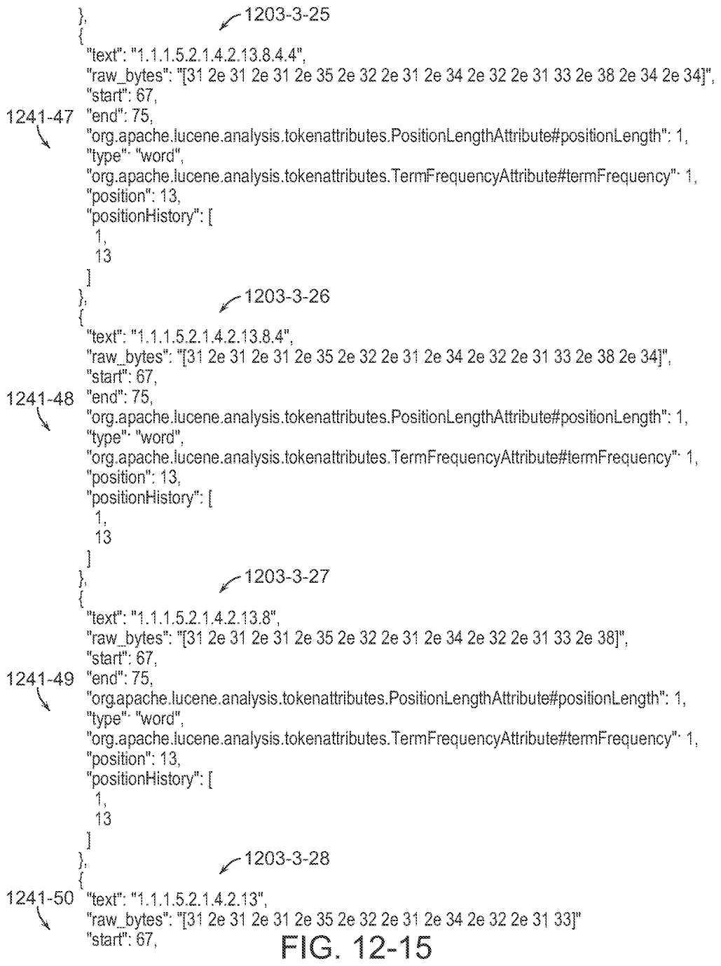

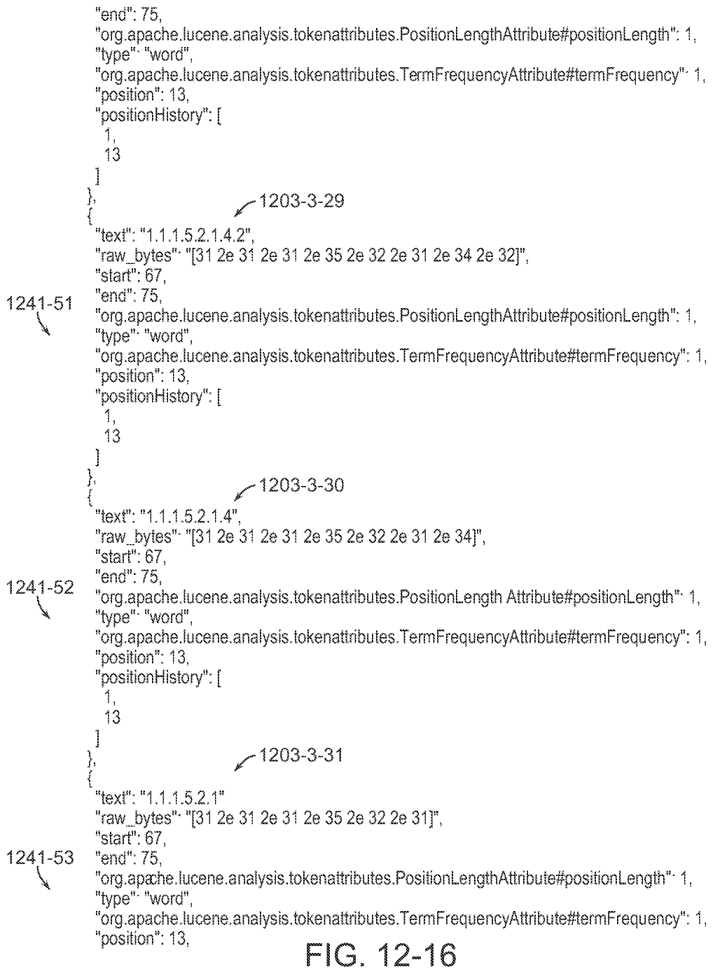

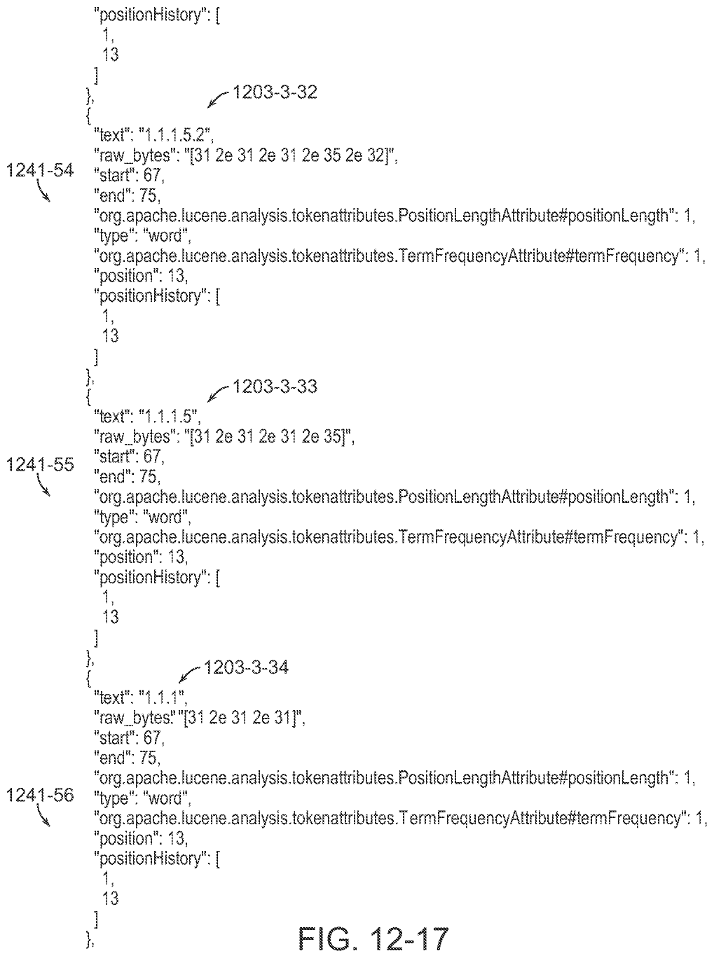

With reference to FIGS. 1, 2, and 11, the ingestion engine (124, 224) includes an ingestion instance of a natural language processing (NLP) analyzer (126-1, 226-2) and such ingestion instance finds document subject-verb-object (SVO) triplets, such as the SVO triplet 1162 for non-limiting example, in document text (130, 230) of a natural language (NL) document (132, 232), and assigns initial document hierarchical classifications to the document SVO triplets found, such as the initial hierarchical classifications 1103-1, 1103-2, and 1103-3 assigned to the subject 1171, verb 1172, and object 1173 components, respectively, for non-limiting example. The JSON 1100 is, in turn, expanded by the ingestion engine (124, 224) to a document token stream (134, 234), such as disclosed below with regard to FIG. 12-1.

FIG. 12-1 is a listing of example JSON representing a token stream 1244 for the SVO triplet 1162 of FIG. 11 for non-limiting example. With reference to FIGS. 1A, 1B, 2, 11 and 12-1, the JSON 1100 has been expanded to the token stream 1244 which is represented as verbose JSON in the example embodiment. It should be understood, however, that the JSON 1100 may be represented in memory (not shown) of the ingestion engine (124, 224) by a more compact binary form and transmitted to the search engine (136, 236) (e.g., Solr) in a more compact JSON, XML, or other data format. In the example embodiment of FIG. 12-1, the “raw-bytes” format is for debugging purpose and may be ignored. It should also be noted that the sentence shown in “CLAUSE_TEXT” in FIG. 11 is from the middle of an example document, as should be appreciated from the value of 1034 for “soff” in the “S” element, indicating that the “T” in “The interaction . . . ” was the 1034^{th} character in the document. For purposes of capturing the JSON formatted token stream data for this example, FIG. 12 was produced by executing the above disclosed processing on the sentence only. (This was done in an extracted subset of the code that does not send the JSON data of FIG. 12 to Solr, but writes it for display instead.) Due to the different processing regimes useful to capture both forms for display, the start and end offset values (e.g., values associated with “start,” “end,” in FIG. 11 respective to “soff,” and “eoff” values in FIG. 11) are mismatched by a constant value of 1034. This mismatch would not exist for a coherent end to end execution of the disclosed system.

FIG. 12-2 through 12-18 are continuations of the listing of FIG. 12-1. FIGS. 12-1 through 12-2 list the JSON 1100 of FIG. 11 that has been expanded to the token stream 1244 and includes permutations of the hierarchical classifications corresponding to multi-sense meanings derived for the subject 1171, verb 1172, and object 1173 components derived by the ingestion instance of the natural language processing (NLP) analyzer (126-1, 226-1) or search instance of the natural language processing (NLP) analyzer (126-2, 226-2). Such permutations of the hierarchical classifications may be referred to herein as variation hierarchical classifications.

With reference to FIG. 1A and FIGS. 12-1 through 12-18, disclosed above, the token stream 1244 includes tokens representing at least one hierarchical classification selected from the initial hierarchical classifications 93 assigned to word components of an SVO triplet found by the NLP analyzer 26 and the variation hierarchical classifications that may be generated by the SVO analyzer 62. For example, the token stream 1244 includes a first token 1241-1 that represents the initial hierarchical classifications assigned, namely the initial hierarchical classifications 1103-1, 1103-2, and 1103-3 that are assigned to the subject 1171, verb 1172, and object 1173, respectively, of the SVO triplet 1162. The token stream 144 further includes the subsequent tokens 1241-1 . . . 1241-58 that include respective variations of the assigned hierarchical classifications 1103-1, 1103-2, and 1103-3, and such variations may be referred to herein as variation hierarchical classifications. It should be understood that the hierarchical classifications, order of such hierarchical classifications, and a number of tokens, etc., of the token stream 1244 are for non-limiting example.

Continuing with reference to FIGS. 1A, 1I, and 12-1 through 12-18, the initial hierarchical classifications 93 assigned include an initial subject hierarchical classification, initial verb hierarchical classification, and initial object hierarchical classification assigned to a subject, verb, and object, respectively, of a SVO triplet of the SVO triplets found, that is, for non-limiting example, the initial hierarchical classification 1103-01 (i.e., 1.1.1.5.2.1.27) assigned to the subject “interaction,” the initial hierarchical classification 1103-2 (i.e., 2.220.7) assigned to the verb “generate,” and the initial hierarchical classification 1103-3 (i.e., 1.1.1.5.2.1.5.2.13.8.4.4.1) assigned to the object “roughness.” The initial subject, verb, and object hierarchical classifications, such as the initial hierarchical classifications 1103-1, 1103-2, and 1103-3, represent an initial subject sense, initial verb sense, and initial object sense for the subject, verb, and object, respectively, of the SVO triplet found, that is, “interaction-generate-roughness” in the example embodiment for non-limiting example.

In an event the at least one hierarchical classification selected includes the initial hierarchical classification, the token stream 1244 produced includes a token 1241-1 that represents the initial subject, verb, and object hierarchical classifications, in combination, namely, the initial hierarchical classifications 1103-1, 1103-2, and 1103-3 of FIG. 11.

In an event the at least one hierarchical classification selected includes at least one variation hierarchical classification generated by varying the initial hierarchical classification, the token stream 1244 produced includes at least one other token representing the at least one variation hierarchical classification, such as any of the subsequent tokens 1241-1 . . . 1241-58, that represent a variation hierarchical classification of the variation hierarchical classifications generated. The at least one variation hierarchical classification may represent at least one of: a different subject hierarchical classification, different verb hierarchical classification, or different object hierarchical classification. The different subject, verb, and object hierarchical classifications are different from the initial subject, verb, and object hierarchical classifications, respectively, namely the initial hierarchical classifications 1103-1, 1103-2, and 1103-3 in the example embodiment.

The different subject, verb, and object hierarchical classifications represent a different subject sense, different verb sense, and different object sense, respectively, for the subject, verb, and object, respectively. The different subject, verb, and object senses are different from the initial subject, verb, and object senses, respectively. The different subject, verb, and object senses may be classified in the lexical database disclosed above as being “more general” word sense for the subject, verb, and object senses relative to the initial subject, verb, and object senses, respectively. An example of a “more general” sense can be seen in FIG. 3C where “strait” (1.1.1.1.5.1.6 in column 303) is a more general sense for “Strait_of_Hormuz” (1.1.1.1.5.1.6.3); “channel” (1.1.1.1.5.1) is a more general sense for “strait”; and “body of water” (1.1.1.1.5) is a more general sense for “channel”. This is the core of how matching and relevancy on higher order concepts is enabled by the methods disclosed herein.

As should be appreciated from FIGS. 12-2 through 12-18, only a subset of the possible permutations of (S|V|O|SV|SO|VO|SVO) are produced. For example, in FIGS. 12-2 through 12-18 there are no variations corresponding to SO, that is, subject-object. Any such permutation might be included or excluded to obtain a relevancy suitable for an intended application. Furthermore, individual variations within the above-noted permutations may be omitted where this seems to improve relevancy. A specific likely example can be seen in 1241-29, where 1203-1-21 is denoted as “1,” which is the most general word sense that matches every word and, therefore, is not useful for finding relevant documents.

Similarly, the query token generation may be tuned separately versus the indexing token generation to filter out more general tokens prior to matching based on a desired level of specificity/generality based on static configuration of a particular pre-tuned system or dynamically as communicated via a query parameter for non-limited example. Such tuning could be done independently for the subject, object, or verb, which may be useful because verbs tend to have shorter hierarchical notations. Implementation of the above may be based on at least one configuration parameter employed by the query token generation; a filtering stage in JesterJ; or implementation of a Lucene TokenFilter in Solr.

Continuing with reference to FIGS. 12-2 through 12-18, the at least one other token 1241-2 represents a variation hierarchical classification that is the initial subject hierarchical classification and initial verb hierarchical classification, namely the hierarchical classifications 1103-1 and 1103-2, respectively, in combination with the different object hierarchical classification 1203-3-1 (i.e., “1.1.1.5.2.1.4.2.13.8.4.4”). Other tokens in which the variation hierarchical classification represents the initial subject hierarchical classification (1103-1), initial verb hierarchical classification (1103-2) in combination with a different object hierarchical classification are the tokens 1241-3 . . . 1241-6 that include the different object hierarchical classifications 1203-3-2 . . . 1203-3-5, respectively.

The variation hierarchical classification may represent the initial subject hierarchical classification assigned or variation thereof. For example, the token 1241-22 of the token stream 1244 represents the initial subject hierarchical classification assigned, namely the hierarchical classification 1103-1 assigned to the subject 1171, whereas the tokens 1241-23 . . . 1241-29 represent variations (e.g., higher levels) of the subject hierarchical classification assigned, that is, variations (1203-1-15 . . . 1203-1-21) of the hierarchical classification 1103-1 that may be referred to herein as variation hierarchical classifications.

The variation hierarchical classification may represent the initial verb hierarchical classification assigned or variation thereof. For example, the token 1241-43 of the token stream 1244 represents the initial verb hierarchical classification assigned, namely the initial hierarchical classification 1103-2 assigned to the verb 1172, whereas the tokens 1241-44 and 1241-45 represent variations (e.g., higher levels) of the verb hierarchical classification assigned, that is, variations (1203-2-7 and 1203-2-8) of the hierarchical classification 1103-2 that may be referred to herein as variation hierarchical classifications.

The variation hierarchical classification may represent the initial object hierarchical classification assigned or variation thereof. For example, the token 1241-46 of the token stream 1244 represents the initial object hierarchical classification assigned, namely the initial hierarchical classification 1103-3 assigned to the object 1173, whereas the tokens 1241-47 . . . 1241-58 represent variations (e.g., higher levels) of the object hierarchical classification assigned, that is, variations (1203-3-25 . . . 1203-3-36) of the hierarchical classification 1103-3 that may be referred to herein as variation hierarchical classifications.

The variation hierarchical classification may represent the initial subject hierarchical classification assigned in combination with the initial verb hierarchical classification assigned. For example, the token 1241-14 of the token stream 1244 represents the initial subject hierarchical classification assigned, namely the hierarchical classification 1103-1 assigned to the subject 1171, in combination with the initial verb hierarchical classification assigned, namely the hierarchical classification 1103-2 assigned to the verb 1172.

The variation hierarchical classification may represent the initial subject hierarchical classification assigned in combination with the initial verb hierarchical classification assigned and a variation of the object hierarchical classification assigned. For example, the tokens 1241-2 . . . 1241-6 of the token stream 1244 represent the initial subject hierarchical classification assigned, namely the initial hierarchical classification 1103-1 assigned to the subject 1171, in combination with the initial verb hierarchical classification assigned, namely the initial hierarchical classification 1103-2 assigned to the verb 1172, and variations of the initial object hierarchical classification assigned, that is, variations (1203-3-1 . . . 1203-3-5) of the initial hierarchical classification 1103-3 assigned to the object 1173.

The variation hierarchical classification may represent a variation of the initial subject hierarchical classification assigned in combination the initial verb hierarchical classification assigned and a variation of the initial object hierarchical classification assigned. For example, the tokens 1241-7 . . . 1241-11 of the token stream 1244 represent variations of the initial subject hierarchical classification assigned, that is, variations (1203-1-1, 1203-1-2, 1203-1-3, 1203-1-4, or 1203-1-5) of the initial hierarchical classification 1103-1 assigned to the subject 1171, in combination with the initial verb hierarchical classification assigned, namely the initial hierarchical classification 1103-2 assigned to the verb 1172, and variations of the initial object hierarchical classification assigned, that is, variations (1203-3-6, 1203-3-7, 1203-3-8, 1203-3-9, or 1203-3-10) of the initial object classification 1103-3 assigned to the object 1173.

The variation hierarchical classification may represent the variation of the initial subject hierarchical classification assigned in combination with a variation of the initial verb hierarchical classification assigned and the variation of the initial object hierarchical classification assigned. For example, the tokens 1241-12 and 1241-13 of the token stream 1244 represent variations of the initial subject hierarchical classification assigned, that is, variations (1203-1-6 or 1203-1-7) of the initial hierarchical classification 1103-1 assigned to the subject 1171, in combination with variations of the initial verb hierarchical classification assigned, that is, variations (1203-1 or 1203-2-2) of the initial hierarchical classification 1103-2 assigned to the verb 1172, and variations of the initial object hierarchical classification assigned, that is, variations (1203-3-11 or 1203-3-12) of the initial object hierarchical classification 1103-3 assigned to the object 1173.

The variation hierarchical classification may represent a variation of the initial subject hierarchical classification assigned in combination the initial verb hierarchical classification assigned. For example, the tokens 1241-15 . . . 1241-19 of the token stream 1244 represent variations of the initial subject hierarchical classification assigned, namely variations (1203-1-8 . . . 1203-1-12) of the initial hierarchical classification 1103-1 assigned to the subject 1171, in combination with the initial verb hierarchical classification assigned, namely the initial verb hierarchical classification 1103-2 assigned to the verb 1172.

The variation hierarchical classification may represent the variation of the initial subject hierarchical classification assigned in combination the variation of the initial verb hierarchical classification assigned. For example, the tokens 1241-20 and 1241-21 of the token stream 1244 represent variations of the initial subject hierarchical classification assigned, that is, variations (1203-1-13 or 1203-1-14) of the initial subject hierarchical classification 1103-1 assigned to the subject 1171, in combination with variations of the initial verb hierarchical classification assigned, that is, variations (1203-2-3 or 1203-2-4) of the initial verb hierarchical classification 1103-2 assigned to the verb 1172.

The variation hierarchical classification may represent the initial verb hierarchical classification assigned in combination with the initial object hierarchical classification assigned. For example, the token 1241-30 of the token stream 1244 represents the initial verb hierarchical classification assigned, namely the hierarchical classification 1103-2 assigned to the verb 1172, in combination with the initial object hierarchical classification assigned, namely the initial object hierarchical classification 1103-3 assigned to the object 1173.

The hierarchical classification variation may represent the initial verb hierarchical classification assigned in combination with a variation of the initial object hierarchical classification assigned. For example, the tokens 1241-31 . . . 1241-40 of the token stream 1244 represent the initial verb hierarchical classification assigned, namely the initial verb hierarchical classification 1103-2 assigned to the verb 1172, in combination with variations of the initial object hierarchical classification assigned, that is, variations (1203-3-13 . . . 1203-3-22) of the initial object hierarchical classification 1103-3 assigned to the object 1173.

The variation hierarchical classification may represent the variation of the initial verb hierarchical classification assigned in combination with the variation of the initial object hierarchical classification assigned. For example, the tokens 1241-41 and 1241-42 of the token stream 1244 represent variations of the initial verb hierarchical classification assigned, that is, variations (1203-2-5 or 1203-2-6) of the initial verb hierarchical classification 1103-2 assigned to the verb 1172, in combination with a variation of the initial object hierarchical classification assigned, that is, variations (1203-3-23 or 1203-3-24) of the initial verb hierarchical classification 1103-3 assigned to the object 1173.

As such, FIGS. 12-2 through 12-18, show a subset of permutations (variations) of (S|V|O|SV|SO|VO|SVO) that are produced for non-limiting example. Specifically, FIGS. 12-2 through 12-18 show the following possible permutations that are produced, with * denoting variations: S, V, O, S|V, S|V|O*, S*|V|O, S*|V*|O*, S*|V, S*|V*, V|O, V|O*, and V*|O* for non-limiting example. An example embodiment disclosed herein is not, however, limited to producing such permutations and may for example produce permutations such as S*, V*, O*, S|V* V*|O, S|O, S*|O, S|V|O, S|V*|O, S*|V*|O, S*|V|O*, and/or S|V*|O*. According to an example embodiment, a method employed for generating permutations of (S|V|O|SV|SO|VO|SVO) may target generation of a subset of permutations of a complete set of permutations. It should be understood, however, that while a remaining subset of permutations of the complete set of permutations may not be specifically targeted for generation, such non-targeted permutations may still be produced as result of a depth (number of delimiters) of an original element of the permutation and the manner (e.g., non-proportional subtraction of depth) in which the method for generating such permutation is implemented.

According to an example embodiment, a variation hierarchical classification of the at least one variation hierarchical classification generated is generated for a respective hierarchical classification of the hierarchical classifications assigned. For example, the variation hierarchical classification 1203-3-1 (i.e., “1.1.1.5.2.1.4.2.13.8.4.4”) is generated for the object hierarchical classification 1103-3 (i.e., “1.1.1.5.2.1.4.2.13.8.4.4.1”) represented by the token 1241-1 of FIG. 12-1, disclosed above for non-limiting example. The initial hierarchical classification has a depth. The variation hierarchical classification includes a portion of the initial hierarchical classification and has a different depth relative to the depth. For example, the variation hierarchical classification 1203-3-1 has a different depth relative to the initial object hierarchical classification 1103-3 because it is at a higher level relative to same.

As such, the variation hierarchical classifications generated may include at least one higher-level hierarchical classification. The at least one higher-level hierarchical classification may be higher in a hierarchy relative to an initial hierarchical classification of the initial hierarchical classifications assigned. The initial hierarchical classification is assigned to a subject, verb, or object of a SVO triplet of the SVO triplets found.

According to an example embodiment, at least one higher-level hierarchical classification may be a truncated version of the initial hierarchical classification. For example, the variation 1203-3-1 (i.e., “1.1.1.5.2.1.4.2.13.8.4.4”) is a truncated version of the initial object hierarchical classification 1103-3 (i.e., “1.1.1.5.2.1.4.2.13.8.4.4.1”) and at a higher level with respect to same in a hierarchy of entries of a lexical database. The lexical database has the initial hierarchical classification and variation hierarchical classification thereof assigned to entries in the hierarchy. The at least one higher-level hierarchical classification, such as the variation hierarchical classification 1203-3-1 (i.e., “1.1.1.5.2.1.4.2.13.8.4.4”) for non-limiting example, and the initial hierarchical classification, such as the initial object hierarchical classification 1103-3 (i.e., “1.1.1.5.2.1.4.2.13.8.4.4.1”) are associated with a same syntactic category associated with the hierarchy.

Variation hierarchical classifications created by the method 1080, disclosed above with regard to FIGS. 10D-1 through 10D-3, are based on the absolute depth, represented as the number of dots in the example embodiments shown in FIG. 11 and FIGS. 12-2 through 12-18. The example embodiment of FIGS. 10D-1 through 10D-3 could be modified to remove S, V, and O hierarchy levels by other methods as well. An example embodiment of such a method may include culling, proportionally, such that a same percentage of initial hierarchical depth is retained at each pass and produce a token where, for non-limiting example, ⅓ of each level hierarchical categorization has been removed such as: 1.1.1.1.5.2.1|2.220|1.1.1.1.5.2.1.4.2.13). Varying the hierarchy level removal strategy is another means by which to tune relevancy for a particular application of the methods disclosed herein.

Knowledge Facilitation through Combinatorial Optimization and Quantum Computing Techniques

An example embodiment may extract additional knowledge from language by viewing such sentential permutations of SVOs, such as included in the tokens of FIGS. 12-1 through 12-18, disclosed above, as strings of values representing Hamiltonians, which are measurements of the energy contained in physical systems.

### Knowledge Creation Through Combinatorial Optimization and Quantum Annealing of Language

Twentieth-century philosopher Ludwig Wittgenstein, known for his beliefs that knowledge could be discovered through language, offered this characterization of such possibilities:
The old logic contains more convention and physics than has been realized. If a noun is the name of a body, a verb is to denote a movement and an adjective to denote a property of a body, it is easy to see how much that logic presupposes; and it is reasonable to conjecture that those original presuppositions go still deeper into the application of the words, and the logic of propositions.
   Ludwig Wittgenstein, Linguistic Philosophy

Language is designed to transfer knowledge in the form of thoughts. According to an example embodiment, completed thoughts reduced to an oral or written container can be viewed not only formally (what they “say”) but substantively as well (what they “mean”) by (i) capturing quantitative attributes which are encompassed in the definitions of and rules applicable to the components of an SVO produced, as disclosed above, and (ii) applying rules of physics applicable to physical phenomena to such components.

According to an example embodiment, rules of physics can assist in the extraction of additional knowledge from language by viewing sentential permutations of SVOs as strings of values representing Hamiltonians, which are measurements of the energy contained in physical systems. Each SVO is seen as a proxy for a physical subsystem (clause), and each document which contains SVOs can be viewed as a surrogate for an entire system (graph) which can be measured and compared with other systems (documents) according to the Hamiltonians of the SVOs of each.

An example embodiment further enhances aspects of the system 90, system 102, and system 202, disclosed above with regard to FIG. 1A, FIG. 1B, and FIG. 2, respectively, in order to further leverage the value of SVOs as measurable physical entities and to subject them to combinatorial optimization in order to:
Disambiguate among various SVO permutations (which could result from multiple meanings of their components) and thereby identify the meaning intended by an author; and
Utilize the classic and quantum computing capabilities of computers, such as the D-Wave Advantage for non-limiting example, for the processing of formal, dual numeric-and-language attribute-based dynamic document container systems, such as those found in electronic medical records (EMRs) for non-limiting example.

### Combinatorial Optimization for Disambiguation

An example embodiment applies laws applicable to physical phenomena to thoughts (abstractions) represented by language statements contained in SVOs by treating the SVOs produced by the system 90, system 102, and system 202, disclosed above with regard to FIG. 1A, FIG. 1B, and FIG. 2, respectively, as embodiments of physical equivalents which can be measured and compared by their resulting Hamiltonians. Such measurements can be effected by applying simulated quantum annealing methods for arbitrage determination with the resulting optimized result reflecting the least ambiguous meaning of the components of an SVO.

An example embodiment leverages the application of laws of physical phenomena to language by implementing their application to SVOs through quantum annealing. This process, based in turn on principles of quantum mechanics, allows for efficient, rapid, and comprehensive analysis of quantum information through a tunneling process which uses physical attributes that are quantified through an embedding in the physical architecture of a quantum computer. The proxy Hamiltonian attributes captured from SVOs in the disambiguation process align well with this requirement and also permit for concurrent, rather than sequential evaluation, of documents which reflects a dynamic rather than static environment.

In another example embodiment, a similar result could be derived from the application of Gate Model computing techniques.

### Applying Physical Phenomena Rules to Language for Disambiguation

The initial step toward the application of rules for physical phenomena to language analysis is the creation of a mapping protocol which assigns hierarchical classifications, such as physically-realistic numeric values for non-limiting example, to lexicon entries. FIG. 3C, described above, discloses same in which the hierarchical classifications are numeric values which are represented in dot notation for non-limiting example.

### Verbs

In linguistics, transitivity describes a relationship between (or among) a verb and one or more subjects and objects. As Wittgenstein surmises, that relationship can be thought of as the passage of energy from subject to object via a verb.

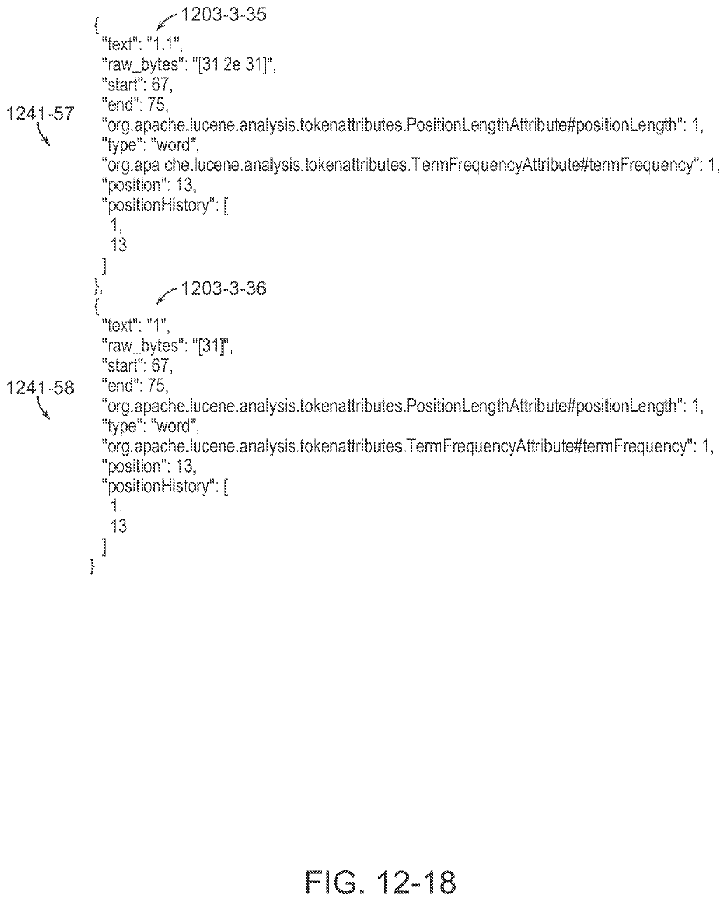

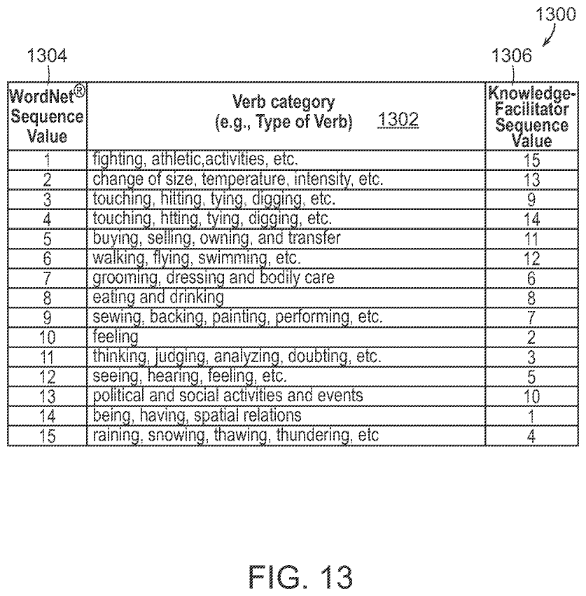

The WordNet® database approach to verbs reflects the relative absence of hypernymy among them, but it also creates verb categories that “collect” comparable activities. In the WordNet® database, the 15 verb categories are assigned in a non-orthogonal sequence. According to an example embodiment, however, the categories may be reordered to reflect a lowest-to-highest type of energy transfer. In such a method, the transitivity of a verb represents its contribution to understanding the transfer of energy from subject to object. The higher its number, the higher its contribution for non-limiting example, such as disclosed below with regard to FIG. 13.

FIG. 13 is a table 1300 of example WordNet® verb categories reordered to reflect transitivity according to an example embodiment. For example, in the table 1300, the verb category 1302 includes 15 WordNet® verb categories. Each verb category of the verb category 1302 is assigned a respective WordNet® sequence value 1304 in a sequential manner in a non-orthogonal sequence. Such WordNet® verb categories are, however, reordered to reflect transitivity according to the respective Knowledge-Facilitator sequence value 1306. For example, the verb category 1302 for “fighting, athletic activities, etc.” is assigned a Knowledge-Facilitator sequence value 1306 of 15, while the verb category 1302 for “being, having, and spatial relations” is assigned a Knowledge-Facilitator sequence value 1306 of 1 to reflect a lower contribution of energy transfer relative to “fighting, athletic activities, etc.” While such ordering to represent “energy” is a univariate ordering, it should be understood that multivariate methods expressing a distance on more than one axis may be employed. It should also be understood that a machine learned (neural network (NN) or evolutionary for non-limiting example) method for finding an optimal order/distancing may be employed. Such machine learning may be based on training vs. word-sense disambiguation (WSD) success rate, rather than expected neighbor words.

### Abstract Entity Nouns

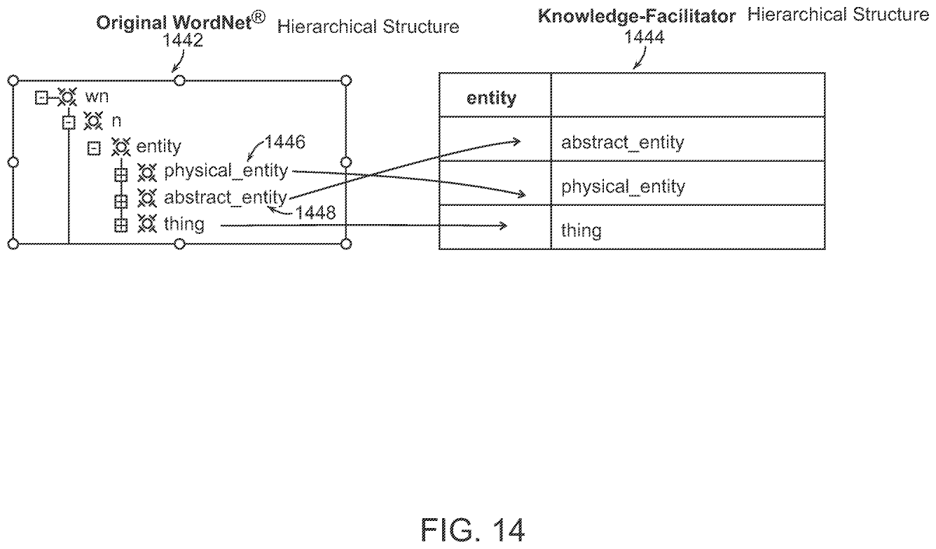

By definition, abstract entities in the WordNet® hierarchy do not transfer energy. According to an example embodiment, the hierarchical classification, such as the hierarchical classifications 303 (master lexicon hierarchy IDs) represented via dot notation for non-limiting example in FIG. 3C, disclosed above, assigned to entries of the WordNet® database, can be enhanced such that the hierarchical classifications 303 reflect a hierarchy based on transfer of energy, such as disclosed below with regard to FIG. 14.

FIG. 14 is a block diagram of an example embodiment of reordering for the WordNet® noun categories “abstract entity” and “physical entity.” FIG. 14 includes an original WordNet® hierarchal structure 1442 of noun categories and a Knowledge-Facilitator hierarchical structure 1442 of the same noun categories. In the Knowledge-Facilitator hierarchical structure 1442, the abstract_entity 1448 and physical_entity 1448 noun categories have been reordered relative to their respective positions in the original WordNet® hierarchical structure 1442 so such that abstract entity nouns (not shown) of the abstract_entity 1448 noun category are numbered prior to the physical entity nouns (not shown) of the physical_entity 1446 noun category to represent their lesser energy transfer capability relative to the physical entity nouns.

Also, because an abstract entity noun is “a general concept formed by extracting common features from specific examples” (WordNet® definition of “abstraction”), an example embodiment may assign a hierarchical classification value of the reference to which it is bound by anaphora or cataphora. If no prior or subsequent reference is available, then the hierarchical classification numbering (represented in dot notation for non-limiting example) of the abstract entity may be assigned to the abstract entity noun.

### Physical Entity Nouns

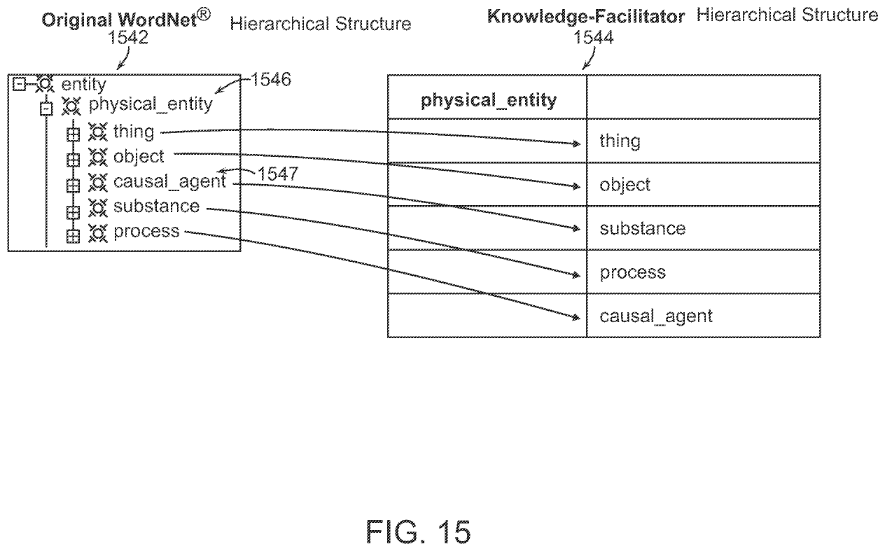

In the WordNet® hierarchical structure of nouns, after the entries under “causal agent” are shifted to the final position under the “physical entity” hierarchy, the hypernymic order for WordNet® nouns serves as a suitable orientation that reflects an ascending ladder of physically-realistic (energy) values as the levels of the hierarchy are traversed in descending order, such as shown in FIG. 15, disclosed below.

FIG. 15 is a block diagram of an example embodiment of reordering for the WordNet® noun category “causal_agent.” FIG. 14 includes an original WordNet® hierarchal structure 1542 of noun categories and a Knowledge-Facilitator hierarchical structure 1542 of the same noun categories. In the Knowledge-Facilitator hierarchical structure 1542, the causal_agent 1547 noun category has been reordered relative to its respective position in the original WordNet® hierarchical structure 1542 under the physical_entity 1546 noun category to reflect its respective physically-realistic (energy) transfer value relative to physically-realistic (energy) transfer values of other noun categories of the physical_entity 1546 noun category. Within the physical_entity 1546 noun category hierarchy, a further distinction between animate and inanimate entities can be made according to an example embodiment, as disclosed below.

### (a) Animate Entity Nouns

According to an example embodiment, values for each noun representing a form of animate physical entity may be assigned (lowest biological level to highest biological level), thus, indicating the hierarchical level of an entity in the taxonomy.

### (b) Inanimate Entity Nouns

Ilya Prigogine's (Ilya Prigogine; Isabelle Stengers (2018). Order Out of Chaos, MAN'S NEW DIALOGUE WITH NATURE. Verso. ISBN 9781786631008) work shows that every form of energy is made up of an intensive variable and an extensive variable, as disclosed on the Internet in Wikipedia's description of “Intensive and extensive properties” (en.wikipedia.org/wiki/Intensive_and_extensive_properties). Measuring these two factors and taking the product of these two variables yields a value that may represent an amount for that particular form of energy. If one takes the energy of expansion, the intensive variable is pressure (P), and the extensive variable is volume (V), and PxV yields the energy of expansion. Likewise, one can do this for density/mass movement, where density and velocity (intensive), and volume (extensive), essentially describe the energy of the movement of mass, as summarized in Wikipedia's description of “Intensive and extensive properties” (en.wikipedia.org/wiki/Intensive_and_extensive_properties).

Other energy forms can be derived from this relationship, such as electrical, thermal, sound, and springs. Within the quantum realm it appears that energy is made up of intensive factors mainly. For example, frequency is intensive. It appears that as one pass to the subatomic realms the intensive factor is more dominant. The example is the quantum dot where color (intensive variable) is dictated by size, size is normally an extensive variable. There appears to be integration of these variables. This then appears as the basis of the quantum effect, as noted in Wikipedia's description of “Intensive and extensive properties” (en.wikipedia.org/wiki/Intensive_and_extensive_properties).

As such, the difference in the intensive variable yields the entropic force and the change in the extensive variable yields the entropic flux for a particular form of energy. A series of entropy production formula can be derived as summarized in Wikipedia's description of “Intensive and extensive properties” (en.wikipedia.org/wiki/Intensive_and_extensive_properties):

$$\begin{matrix}{ΔS}_{heat} = [ {( 1 / T )}_{a} - {( 1 / T )}_{b} ] \times Δ thermal energy \\ {ΔS}_{expansion} = [ {( pressure / T )}_{a} - {( pressure / T )}_{b} ] \times Δ volume \\ {ΔS}_{electric} = [ {( voltage / T )}_{a} - {( voltage / T )}_{b} ] \times Δ current\end{matrix}$$

These equations have the form:
ΔSₛ=[(intensive)ₐ−(intensive)_{b}]33 Δ extensive, where the a and b are two different regions.
This is the long version of Prigogine's equation: ΔSₛ=XₛJₛ, where Xₛ is the entropic force and Jₛ is the entropic flux. Note that in thermal energy, in the entropy production equation, the intensive factor's numerator is 1. While the other equations above have numerators of pressure and voltage, the denominator is still temperature. This means lower than the level of molecules there are no definite stable units. It is possible to derive a number of different energy forms from Prigogine's equation.
   According to an example embodiment, prigogine values (the product of the intensive and extensive properties of the entity) may be assigned to each noun representing an inanimate physical entity. Alternatively, such values may be treated as elements in a vector representing “features.”

### Combinatorial Optimization for Disambiguation

Ambiguities can benefit the Knowledge-Facilitator since they help to produce alternative meanings for SVOs which, in turn, can be used to produce additional search (e.g., Solr search) benefits. For example, the “cat chased the dog” SVO can actually be deconstructed into at least 27 alternative-meaning SVOs. Word sense disambiguation (WSD), while it has eluded many others for many years, should be attained: disambiguated knowledge is that which the user knows to contain the author's intended meaning notwithstanding the vagaries of the English language. An example embodiment of a process described herein begins with the use of the machine language explications of SVOs which take into account a hierarchical ordering of nouns by their energy and continues with converting the resulting mathematical values into “Hamiltonians” of the respective alternative meanings of the candidate SVOs. These may then be evaluated using the arbitraging techniques by which alternative currency values are calculated and the most appropriate (highest energy) are selected. Disambiguated SVOs contain the highest values with the fewest penalty points.

According to an example embodiment, disambiguating an SVO may be formulated as a problem of finding optimal arbitrage opportunities as a quadratic unconstrained binary optimization problem as disclosed in (Gili Rosenberg, “Finding Optimal Arbitrage Opportunities Using a Quantum Annealer,” 2016 1QB Information Technologies) (hereinafter, “Rosenberg”) with regard to a financial application which, as disclosed by Rosenberg in same, is a problem that can be solved using a quantum annealer. As described by Rosenberg, formulations may be based on finding the most profitable cycle in a graph in which the nodes are the assets and the edge weights are the conversion rates. The edge-based formulation is simpler, whereas the node-based formulation allows for the identification of specific optimal arbitrage strategies, while possibly requiring fewer variables.

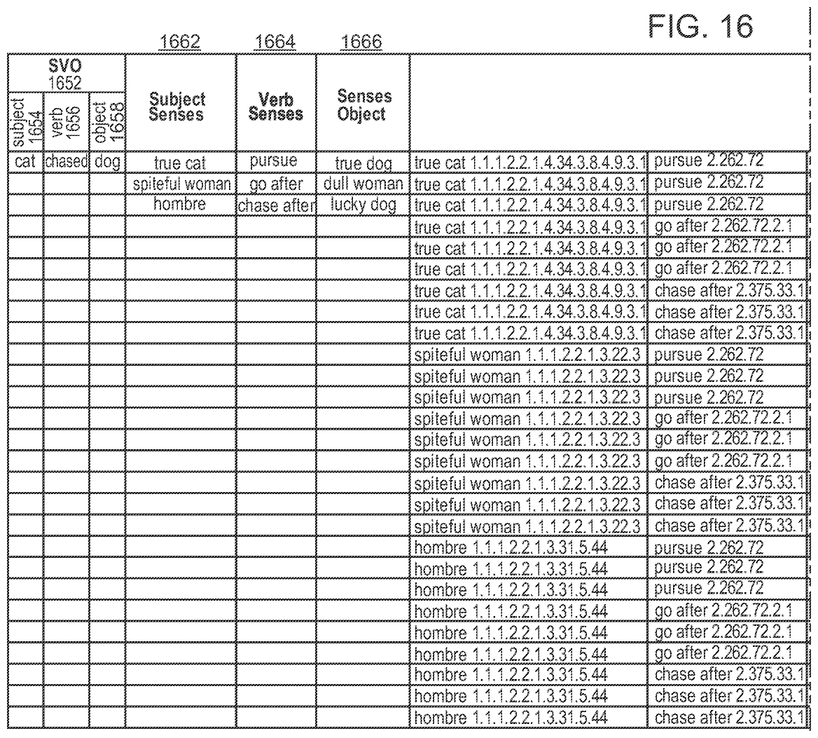

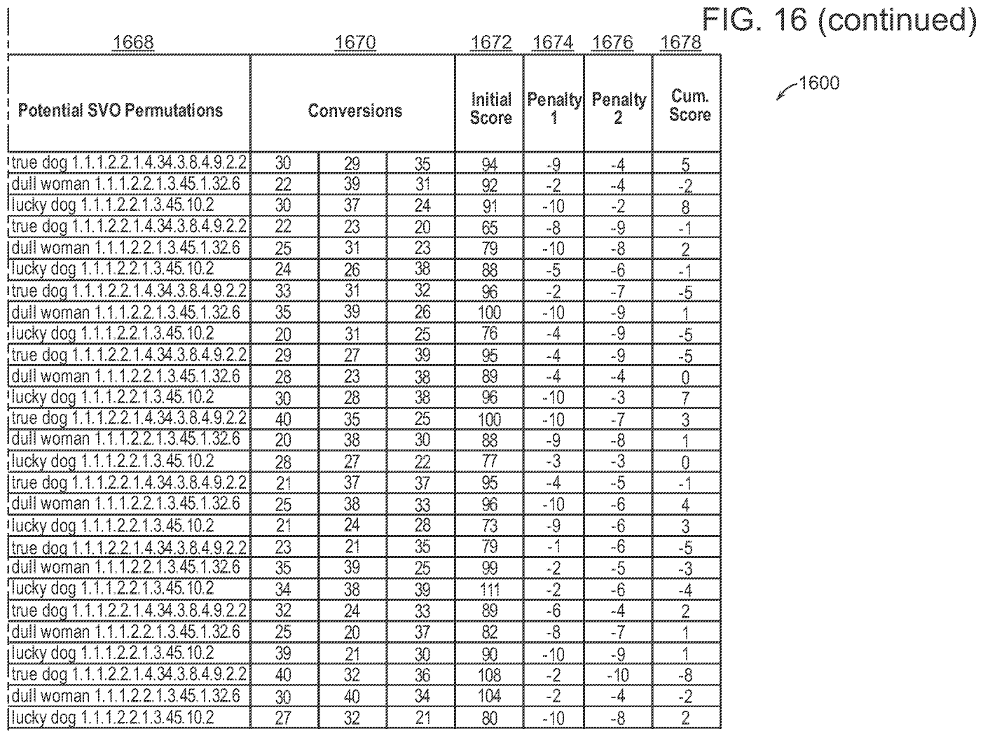

As should be appreciated from the matrix 1600 of FIG. 16, disclosed below, each component of an SVO, namely, the subject, verb, and object components, can have multiple sense meanings. According to an example embodiment, such multiple sense means may be disambiguated using an arbitraging method as disclosed further below.

FIG. 16 is a matrix 1600 with example disambiguated results for an SVO triplet 1652, referred to simply as the SVO 1652, according to an example embodiment. An arbitraging method may be applied to the multiple sense meanings of the SVO to produce such disambiguated results as disclosed further below. The matrix 1600 can be created from at least a portion of all possible permutations which result from multiple sense meanings for each component of the SVO 1652, namely, the subject 1654, verb 1656, and object 1658 components that are “cat,” “chased,” and “dog,” respectively for non-limiting example in the matrix 1600.

The matrix 1600 includes multiple sense meanings for the subject 1654, verb 1656, and object 1658 of the SVO 152, namely the subject senses 1662, verb senses 1664, and object senses 1666, respectively. The matrix 1600 further includes potential SVO permutations 1668 for the SVO 1652 derived from permutations of the subject senses 1662, verb senses 1664, and object senses 1666. Such SVO permutations 1668 include WordNet® terms and hierarchical classifications assigned thereto according to an example embodiment. The matrix 1600 further includes a first penalty 1674 and second penalty (i.e., penalty 2) 1676.

The first penalty 1674 (i.e., penalty 1) represents a weighted average of the congruity of the hierarchical classifications of the respective SVO components of the SVO permutations 1668 in the respective row associated with the respective value for penalty 1, to UMLS “T” combinations and to the WordNet® lexicographic combinations. The second penalty 1676 (i.e., penalty 2) represents the inverse of the number of times the candidate SVO appears in the repository. Values for the initial score 1672, cumulative score 1678, conversions 1670, first penalty 1674, and second penalty 1676 are for non-limiting example (produced using a “randbetween” function for non-limiting example).

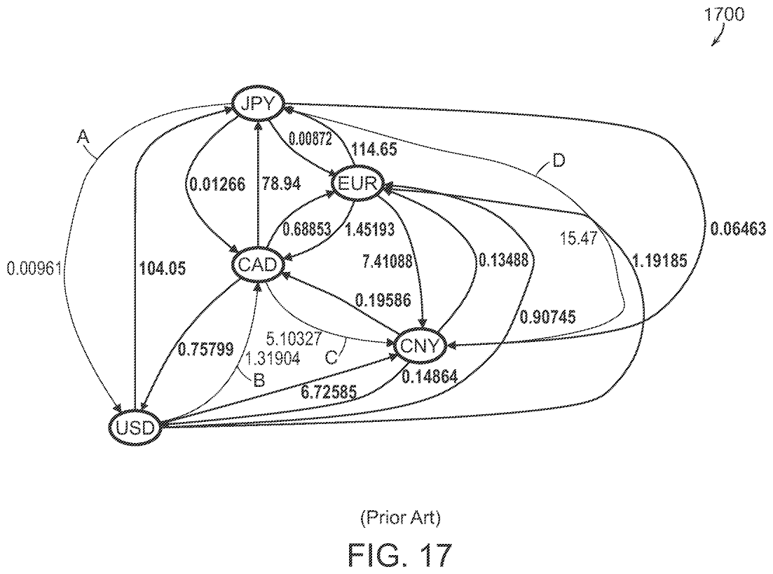

According to an example embodiment, the matrix 1600 may be evaluated by a computer-implemented method for word-sense disambiguation (WSD) which determines the least ambiguous of all SVO triplets that could result from multi-sense meanings of all the components of the SVO 1652, namely all of the potential SVO permutations 1668. The matrix 1600 may be a graph for non-limiting example. According to an example embodiment, combinatorial optimization techniques commonly applied to currency arbitraging can be applied to such a graph, that may be represented in a similar manner as the prior art arbitraging graph 1700 of FIG. 17, disclosed below.

FIG. 17 is a prior art arbitraging graph 1700. The arbitraging graph 1700 is an example asset and conversion rate graph. The arbitraging graph 1700 includes five currencies, namely USD, CAD, CNY, EUR, and JPY, all of which can be converted into each other, giving twenty conversion rates shown. The best (most profitable) arbitrage opportunity (lines marked as A, B, C, and D), involved four assets and a potential gain of 0.074%. (Gili Rosenberg, “Finding Optimal Arbitrage Opportunities Using a Quantum Annealer,” page 5, 2016 1QB Information Technologies).

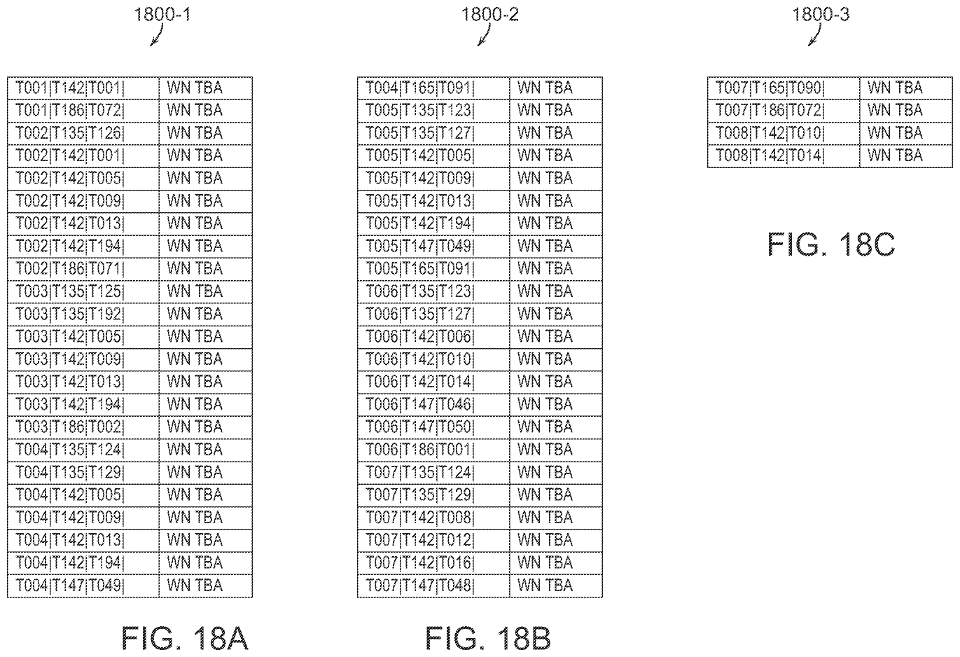

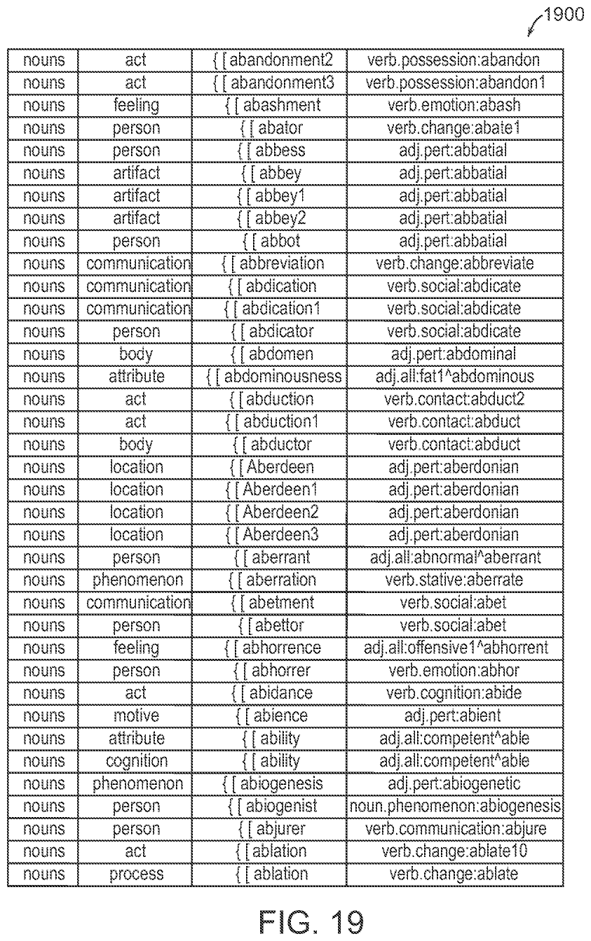

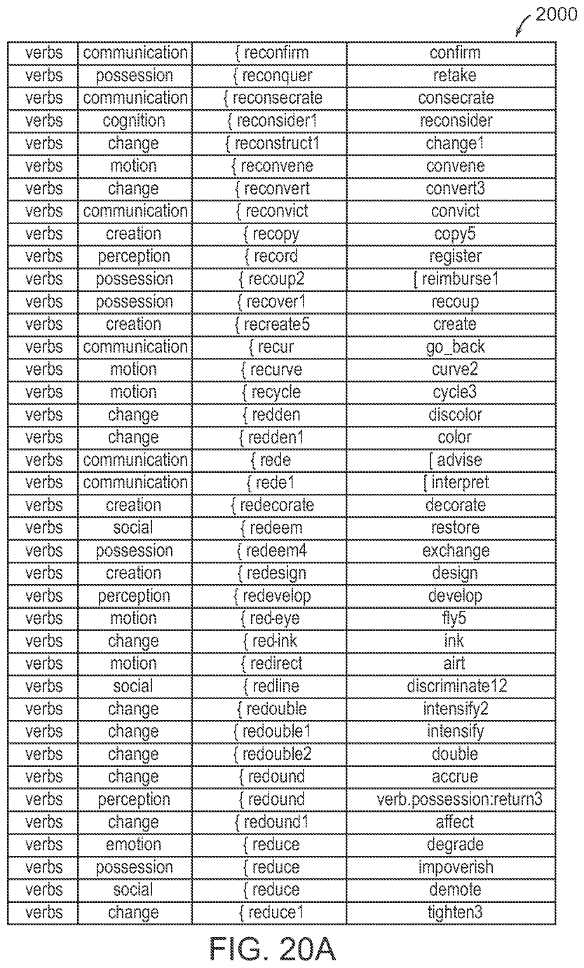

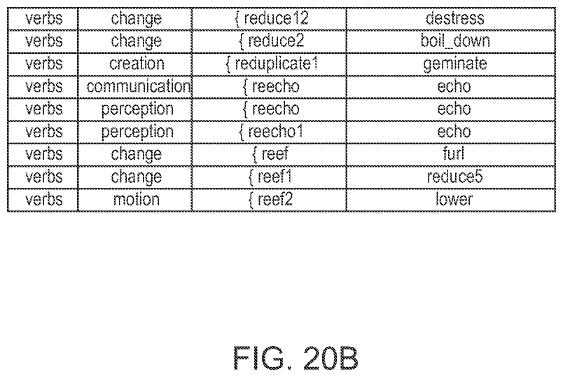

Like alternative currency valuations, the token streams produced by each ambiguous SVO triplet may be ranked from most to least by measuring the Hamiltonian of each as reflected in the SVO's hierarchical classification (e.g., dot notation number) (the combination of all three of the subject, verb and object components), after the application of “conversion penalties” for the degree of an SVO's nonconformance with the following attributes:
recognized permutations in the domain of endeavor; some taxonomic collections explicitly extend the mapping of words (as concepts) to categories of meaning. For example, the Semantic Network contained in the Universal Medical Language System makes such connections by creating “T” categories as preferred curated (collected) categories for linguistic components, such as the “T” categories of the Semantic Network Category 511 of FIGS. 5-1 through 5-20, disclosed above, and in FIGS. 18A-C, disclosed below. Again, SVO triplets which do not match such assignments can be penalized for their nonconformance.
permitted lexicographic combinations; WordNet® contains substantial “preferred cross-mapping” between verbs and nouns which indicates relationships among and between them which have been curated according to their meanings, such as shown in FIG. 19 and FIGS. 20A-B, disclosed below. Pursuant to these interrelationships, it is possible to “penalize” verb-noun relationships which do not conform to them: the closer the conformance, the higher the score.
   As such, UMLS and Wordnet may have noun-verb association indicators, however, an example embodiment may “boost” (increase) a score associated with an SVO if the SVO includes a noun and verb belonging to the same association and/or “penalize” (decrease) the score in event the noun and verb do not belong to the same association.

### Disambiguating SVOs

Disambiguating individual words in SVOs is valueless, because words generally acquire their meanings in relation to other words. Evaluating relationships in the context of each ambiguity in unconnected sequence removes those relationships. Disambiguation therefore is useful when each ambiguity in an entire statement (SVO) be concurrently resolved. Thus, resolving the disambiguation problem at the time of the natural-language extraction process according to an example embodiment, is useful in order to avoid misidentification of the components and likely miscategorization of the statement (SVO) as well as, perhaps, the entire document.

### Ambiguous SVOs and Quadratic Unconstrained Binary Optimization

Disambiguation has traditionally been viewed as complex and is commonly deemed to be among the most computationally difficult problems. Recent developments have shown that “that a mathematical formulation known as QUBO, an acronym for a Quadratic Unconstrained Binary Optimization problem, can embrace an exceptional variety of important CO [combinatorial optimization] problems”. Briefly, the QUBO approach attempts to optimize solutions by evaluating alternative outcomes without necessarily burdening the process with “constraints.” It has been found, however, that the QUBO can be tailored to include “additional constraints that must be satisfied as the optimizer searches for good solutions. Many of these constrained models can be effectively re-formulated as a QUBO model by introducing quadratic penalties.” If one considers ambiguities as presenting available alternative interpretations of apparently equivalent SVOs, it follows that the use of QUBOs to which constraints (that is, downgrades for possible explanations) are added can offer meaningful disambiguation opportunities.

### Disambiguation Via Arbitraging

According to an example embodiment, a Hamiltonian of an entire SVO may be viewed as a hierarchical classification, such as a numeric string for non-limiting example, whose alternative values can be computed. A series of steps can be executed to effect that opportunity through the use of the currency arbitraging method of Rosenberg for non-limiting example.

Briefly, the initial step is to recognize the distinctions between “simulated annealing” and “quantum annealing”. While the former employs traditional computing equipment, the latter relies primarily on quantum annealing computing. Interestingly, 1QBit has developed an environment that seems to be an amalgam of the two which executes what it describes as “Simulated Annealing via Quantum Annealing.” The framework is intended to mimic quantum computing but operates in a classic computing environment.

Into this framework, an arbitraging method also developed by 1QBit and premised on its ability to treat alternative currency valuations as the equivalent of a physical energy string (i.e., Hamiltonian) is inserted. In effect, rules of physics applicable to Hamiltonians are used to evaluate respective values, with the result that the highest hierarchical classification, such as a highest numeric value, represents the highest currency value, as disclosed above.

Such a method may be employed to resolve ambiguities in SVOs: if the default configurations of an SVO are viewed as the equivalent of the initial currency, then the various alternative permutations resulting from ambiguities in any of its subject, verb and object components can be seen as competing value combinations. After assigning the hierarchical classifications, such as numeric values suggested below for non-limiting example, to the components of an SVO, the resulting method may be capable of identifying among the various values the SVO permutation which contains the most appropriate (that is, highly valued) permutation which is the least ambiguous.

### Arbitraging Requirements

### Directed Graph

With the foregoing quantization, it is possible to create the first requirement of the arbitrage method: a directed graph. According to an example embodiment, the directed graph may be based on SVOs instead of currency.

### Conversion Costs

In addition to a directed graph, the algorithm requires that to effect a seamless “comparison” among the respective currencies it is necessary that conversion costs be factored into the process. In the method, these costs are referred to as penalties. This conversion must similarly be accounted for in the disambiguation process by adding appropriate penalties:

### Penalty M1

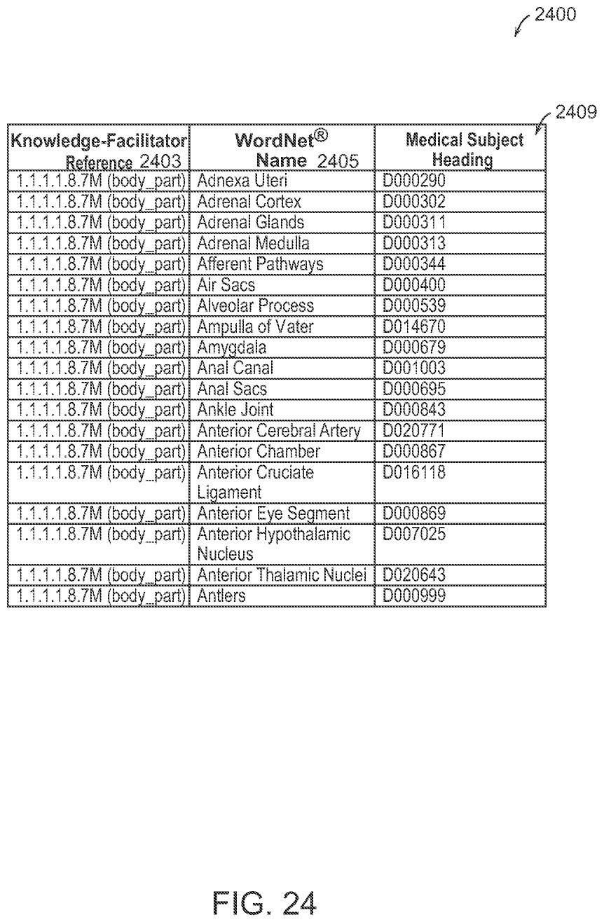

The Unified Medical Language System (UMLS) Semantic Network assigns “T” numbers to knowledge categories which, according to the example embodiment of FIG. 24, disclosed further below, have been linked to the appropriate WordNet® entries. The UMLS “T” numbers have been curated into a total of 6864 combinations. According to an example embodiment, these can be thought of as equivalent to SVO permutations (which in fact they become); thus, determining whether a proposed disambiguation solution is among these combinations becomes a basis for assigning conversion costs (e.g., least to most on a 10 to 1 scale for non-limiting example).

### Penalty M2

WordNet® lexicographers categorized the nouns and verbs in the WordNet® database with related entries that in effect state preferences for relations in the entries. Determining whether the proposed assignment varies from the lexicographer classification can, according to an example embodiment, become a basis for assigning conversion costs (e.g., 10 points for noncompliance for non-limiting example).

FIGS. 18A-C are tables with example conversions of Unified Medical Language System (UMLS) “T” categories to WordNet® (WN) categories according to an example embodiment. Such WN categories are listed as to-be-added (TBA) in table 1800-1, 1800-2, and 1800-3 of FIG. 18A, FIG. 18B, and FIG. 18C, respectively.

FIG. 19 is a table 1900 of example lexicographic relationships of nouns in the WordNet® database.

FIG. 20A is a table 2000 of example lexicographic relationships of verbs in the WordNet® database.

FIG. 20B is a continuation of the table of FIG. 20A.

### Quantum Computing Techniques for Dynamic Documents

### Quantum Annealing Computing

The computational environment 100, 200 disclosed above with regard to FIG. 1B and FIG. 2 may be based on classical computing techniques and oriented toward static repositories. As such, a disambiguation process implemented by same can be executed using traditional CPU technologies.

But the opportunity to employ physical phenomena measurement techniques for disambiguation provides an opening for using current developments in quantum computing to further leverage the applicability of such techniques. Admittedly, the importance of quantum computing has been heralded more by promise than by production. Nevertheless, computational technologies based on one form of quantum computing implementation—quantum annealing—can be the basis for further enhancement of system 90, system 102, and system 202 disclosed above with regard to FIG. 1A, FIG. 1B, and FIG. 2, respectively.

The quantum annealing technology offered by D-Wave Systems has particular appeal because it embraces traditional CPU resources for program control while at the same time utilizing quantum technology to handle computational complexity. Such quantum annealing technology may enhance the technology of system 102 and system 202 disclosed above by retaining the underlying methodology while providing the potential for polynomial processing of items which otherwise require substantial alternative computing resources.

Significantly, the D-Wave approach employs quantum annealing based on the adiabatic theorem to compare Hamiltonians:
“The initial Hamiltonian Hᵢₙᵢₜ is designed such that the system can be readily initialized into its known groundstate, while the groundstate of the final Hamiltonian H_{final} encodes the answer to the desired optimization problem.” (Choi, “Minor-Embedding in Adiabatic Quantum Computation: I. The Parameter Setting Problem,” D-Wave Systems Inc., Apr. 30, 2008).
   Briefly, candidate query profiles serve as the initial Hamiltonian while optimization by quantum annealing produces the most responsive Hamiltonian(s). The query and response capabilities of system 102 and system 202, disclosed above with regard to FIG. 1B and FIG. 2, respectively, particularly in domains of computational complexity, are well served by this capability.

Significantly, treating an SVO as an Hamiltonian of its components aligns well with the requirement in quantum annealing that the architecture reflected in the quantum information being processed—here, the SVO—aligns with the architecture of the quantum processing unit. Viewing each SVO as a clause assigned to each qubit satisfies that requirement. This minor embedding requirement becomes not a liability but an asset in quantum annealing because “couplings” are axiomatic to language.

Moreover, recent topology enhancements to the D-Wave Advantage offering portend significant benefits to the systems disclosed above, such as the system 90, system 102, and system 202 of FIG. 1A, FIG. 1B, and FIG. 2, respectively. The Pegasus architecture of the D-Wave Advantage permits 3D lattices of the type described here to benefit from increases in pairwise connectivity, thus increasing overall processing power. (King et al., “Performance benefits of increased qubit connectivity in quantum annealing 3-dimensional spin glasses,” D-Wave Systems, Sep. 29, 2020; D-Wave System Documentation regarding its Pegasus architecture for descriptions of its internal, external and odd couplers. (“D-Wave QPU Architecture: Topologies,” retrieved from the Internet on May 6, 2021 at https://docs.dwavesys.com/docs/latest/c_gs_4.html#pegasus-graph).

### Gate Model Quantum Techniques

A recent proposal suggested that quantum mechanics could be applied to achieve understanding by biological systems. (Weingarten, et al., “A New Spin on Neural Processing: Quantum Cognition,” Frontiers in Human Neuroscience, October 2016, Volume 10, Article 541). Although some rejected the proposition that the phosphorus-based “information” on which the proposal was based was chemically sound (Player et al., “Posner qubits: spin dynamics of entangled Ca9(P04)6 molecules and their role in neural processing,” J. R. Soc. Interface 15:20180494 (2018)), others accepted the theory for evaluation and concluded that properly applied the proposed protocol leveraged the two primary principles of quantum mechanics—superposition and entanglement—to offer meaningful opportunities for knowledge creation (Halpern et al., “Quantum information in the Posner model of quantum cognition,” University of New Mexico, Albuquerque, NM 87131, USA, May 30, 2019). Significantly, this conclusion does not appear to be limited solely to biological systems: if the protocol was properly instantiated for leveraging quantum bits (qubits), the resulting circuitry would satisfy all the known requirements for a spin-and-orbit system of quantum computing.

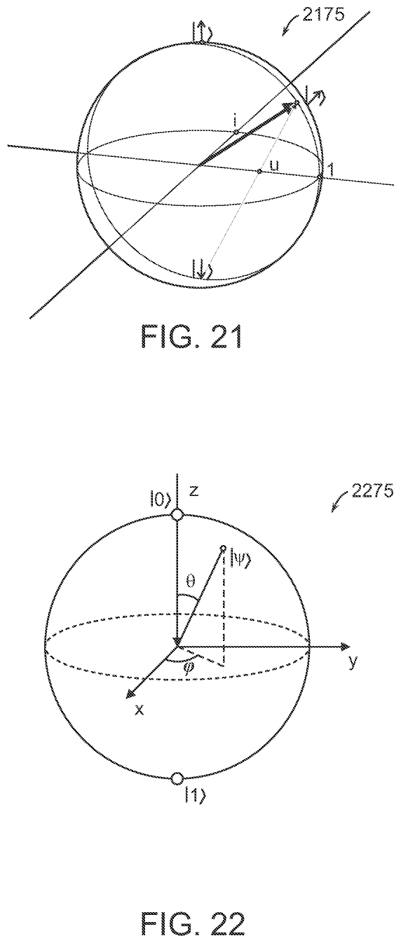

These include: a scalable physical system with well-characterized qubits; the ability to initialize the state of the qubits to a simple fiducial state; long relevant decoherence times; and a universal set of quantum gates (DiVincenzo et al., “The Physical Implementation of Quantum Computation,” IBM T.J. Watson Research Center, Yorktown Heights, New York, Feb. 1, 2008). These characteristics are clearly evident in static repositories of collected words; by definition irreversibility has attached to them. Also required is a “qubit-specific measurement capability.” A representation of a Bloch sphere, commonly divined as illustrative of a qubit, is disclosed below with regard to FIG. 21.

FIG. 21 is a schematic diagram of an example embodiment of a Bloch sphere 2100 representation of a qubit. In quantum mechanics and computing, the Bloch sphere is a geometrical representation of the pure state space of a two-level quantum mechanical system (qubit), named after the physicist Felix Bloch. The Bloch sphere is a unit 2-sphere, with antipodal points corresponding to a pair of mutually orthogonal state vectors. The north and south poles of the Bloch sphere 2100 are typically chosen to correspond to the standard basis vectors |0 [symbol] and |1 [symbol] , respectively, which in turn might correspond e.g. to the spin-up and spin-down states of an SVO according to an example embodiment.

The Bloch sphere 2175 is centered at the origin of [symbol] ³. A pair of points on it, |↑ [symbol] and |↓ [symbol] have been chosen as a basis. Mathematically they are orthogonal even though graphically the angle between them is π. In [symbol] ³ those points have coordinates (0, 0, 1) and (0, 0, −1). An arbitrary spinor | [symbol] on the Bloch sphere is representable as a unique linear combination of the two basis spinors, with coefficients being a pair of complex numbers; referred to as α and β. Let their ratio be u=β/α, which is also a complex number uₓ+iu_{y}. Consider the plane z=0, the equatorial plane of the sphere, as it were, to be a complex plane and that the point u is plotted on it as (uₓ, u_{y}, 0). Project point u stereographically onto the Bloch sphere 2175 away from the South Pole—as it were—(0, 0, −1). The projection is onto a point marked on the sphere as | [symbol] . (Wikipedia, “Bloch sphere,” retrieved from the Internet on May 6, 2021, https://en.wikipedia.org/wiki/Bloch_sphere)

FIG. 22 is a schematic diagram of an example embodiment of spin-orbit 2275 mapping of an SVO. According to an example embodiment, instead of being converted into bits for classical computing, knowledge in the form of SVO “thoughts” can be converted into qubit form which can then be manipulated via superposition (decoherence) and entanglement (concurrent relationships) to produce circuitry which permits significant improvements in processing times and throughput:
The three components of an SVO, namely the subject, verb, and object, can be mapped in three dimensions in qubits using respective hierarchical classifications (e.g., dot notations) assigned to same, such as the hierarchical classifications 303 (dot notation system for non-limiting example) that may further reflect transitivity as disclosed above;
the resulting Hamiltonian can also be mapped as its spin;
according to an example embodiment, the final orbit dimension—entanglement—may be supplied by an entry in the Knowledge Base (KB), such as the KB 682 of FIG. 6B, disclosed above, that links the hierarchical classifications (e.g., dot notation) to an appropriate classification in the knowledge domain of the KB. FIG. 24, disclosed further below, includes a table 2400 for an illustration of that process for Major and Minor Medical Subject Heading categories in the life sciences domain.

In addition to the foregoing requirements, quantum computing environments should have the following abilities:
to interconvert stationary and flying qubits faithfully to transmit flying qubits between specified locations (DiVincenzo et al., “The Physical Implementation of Quantum Computation,” IBM T. J. Watson Research Center, Yorktown Heights, New York, Feb. 1, 2008)
   The cross-mapping techniques disclosed herein provide definitive navigation among language entries on the “linguistic” plane and the implementations described above maintain that integrity during processing of the qubits.

### Quantum Annealing Optimization in Electronic Medical Records (EMRs)

According to an example embodiment, quantum annealing permits the chasm between thought and action to be bridged: the SVO permutations of documents can be closely aligned with physical attributes by treating instances of each type as individual clauses in an overall graph representing the entire contents of a record. That is, the optimization techniques described above can be further leveraged by treating static and dynamic attribute entries as clauses. Numeric (staging and assessments) and language attributes can be linked to each other through a knowledge base (KB), such as the KB 682 of FIG. 6B, disclosed above. Such a KB may include a table with entries providing across mapping from WordNet® names to Medical Subject Headings for non-limiting example, such as disclosed below with regard to FIG. 24. And dynamic (additions) and static (previous) contributions can be similarly related.

FIG. 24 is a table 2400 of entries showing cross mapping from WordNet® names 2405 to Medical Subject Headings 2409 according to an example embodiment. Each entry is assigned a hierarchical classification (e.g., in dot notation) 2403, also referred to as a Knowledge-Facilitator reference 2403.

In addition to the likely ability of quantum annealing machines to better address the computational complexity of such processes, the opportunity is presented to concurrently rather than sequentially process the contents in order to be better grasp the interrelationships reflected in the whole. Concurrent processing offers the opportunity of machine knowledge instead of machine learning, as Kant suggested in his theory on universality of categories.

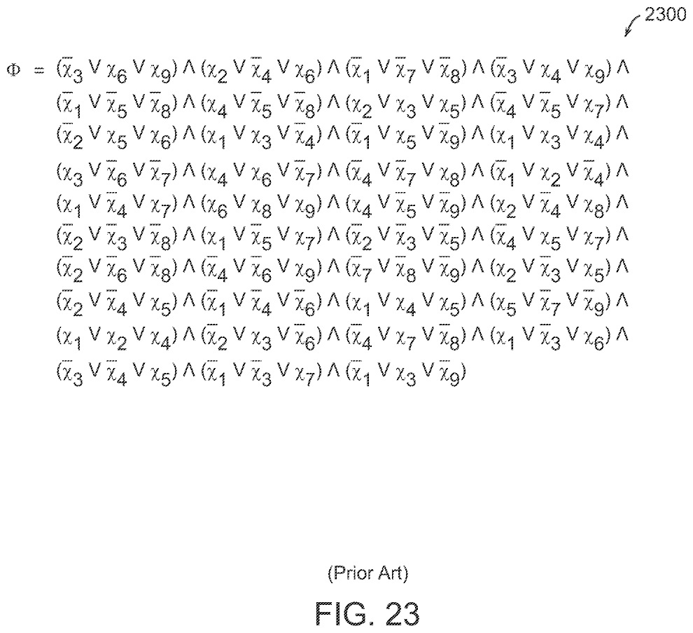

The initial step lies in selecting a candidate domain which provides the most effective opportunity for problem solving through quantum annealing optimization. The electronic medical record (EMR) is such an opportunity. While its “numeric” contents reflect staging and assessments common to medicine, it also contains “linguistic” entries in items such as clinical notes, reports and the like. It also reflects a continuing dynamic between patient and provider. The SVO can be viewed as a common denominator for each kind of clause and employed in an equation of clauses for quantum annealing, such as the prior art equation 2300 with clauses for quantum annealing of FIG. 23.

FIG. 23 is a prior art equation 2300 (Venegas-Andraca et al., “A cross-disciplinary introduction to quantum annealing-based algorithms,” Contemporary Physics, arXiv: 1803.03372v1, Mar. 9, 2018, 1-32) with clauses for quantum annealing. In the prior art equation 2300, Φ represents a Boolean expression written as a conjunction of disjunctions and is said to be written in conjunctive normal form. The K-SAT problem, a key decision problem in computer science, comprises determining whether a Boolean expression, such as Φ, is satisfiable or not, i.e., whether there is a set of values of {x₁, x₂, . . . , xₙ} for which Φ=1.

In the context of the prior art equation 2300, let S={x₁, x₂, . . . , xₙ, x̅₁, x̅₂ . . . x̅ₙ} be a set of Boolean variables and their negations and a clause c defined as a disjunction of binary variables in S (for example, c=x₃∇x̅₈∇x̅₁₃). In the prior art equation 2300, Φ is defined as the conjunction of clauses ci over S where each clause ci has K variables, i.e., Φ is a conjunction of disjunctions:

$$Φ = {∧}_{i} {c}_{i} = {∧}_{i} [ ( {{∨}_{j = 1}}^{K} x \text{?} ] ,$$

$$\text{?} \text{indicates text missing or illegible when filed}$$

Where αⱼ∈{1, 2, . . . n} and

$$x \text{?}$$

$$\text{?} \text{indicates text missing or illegible when filed}$$

is used to denote either or In the prior art equation 2300, is a set of binary values and Φ is an instance of 3-SAT (i.e., K-SAT with K=3). Finding the solutions (if any) of even a modest 3-SAT instance like that of prior art equation 2300 can become difficult quite easily (Φ's only solution is x₁=0, x₂=0, x₃=1, x₄=1, x₅=1, x₆=1, x₇=1, x₈=1, x₉=1) (Venegas-Andraca et al., “A cross-disciplinary introduction to quantum annealing-based algorithms,” Contemporary Physics, arXiv: 1803.03372v1, Mar. 9, 2018, 1-32).

According to an example embodiment, Φ of the prior art equation 2300 may represent a candidate electronic medical record (EMR), such as the EMR 110 of FIG. 1B, disclosed above. The clauses of the prior art equation 2300 may be SVOs of a directed graph, such as the graph 1700 of FIG. 17, disclosed above.

While not all problems can be solved in a quantum annealer, it appears that some difficult discrete optimization problems, such as the 3-SAT instance like that of prior art equation 2300 or the max-SAT problem, may be candidates for determining whether they can be computed more efficiently via quantum annealing than with traditional classical methods. An example embodiment for word sense disambiguation may employ quantum annealing. According to an example embodiment, token streams representing at least a portion of all possible SVO permutations which could result from multiple sense meanings of the components of an SVO, that is, SVO permutations of sense (SVOPS) may be converted to Hamiltonians representing transitivity of energy represented by such components. As such, SVOPS can, in turn, be ranked in order of highest energy levels, minus deductions for noncompliance with, for non-limiting example, lexicographic rules and/or orders of common usage meanings and accepted standards, in order to select a highest energy level representing a highest level of transitivity in the SVO and, thus, disambiguating a permutation of an SVO among a plurality of permutations of the SVO resulting from multiple-sense meanings of the respective subject, verb, object components of the SV).

Such Hamiltonians may be further converted into mathematical clauses, such as the clause c disclosed above with regard to FIG. 23, such that an entire token stream constituting a complete target profile (e.g., electronic medical record (EMR) or threat assessment profile) can be compared to all other comparable clause token streams to determine profiles most nearly matching the target profile.

The quantum annealing technique offered by the D-Wave Advantage system may be employed to enhance the technology disclosed above with regard to FIG. 1B and FIG. 2 by retaining an underlying methodology employed by same while providing the potential for reduced processing times of items which otherwise require substantial alternative computing resources.

Accordingly, an entire patient profile, such as the EMR 1102 can be compared with all other profiles available in the search repository, such as the EMRs 120 of FIG. 1B, disclosed above, to determine, for example, diagnostic assessments, successful therapies and systemic quality control. Thus, a system, method, and computer readable medium may facilitate knowledge creation through combinatorial optimization and quantum annealing of language as disclosed above.

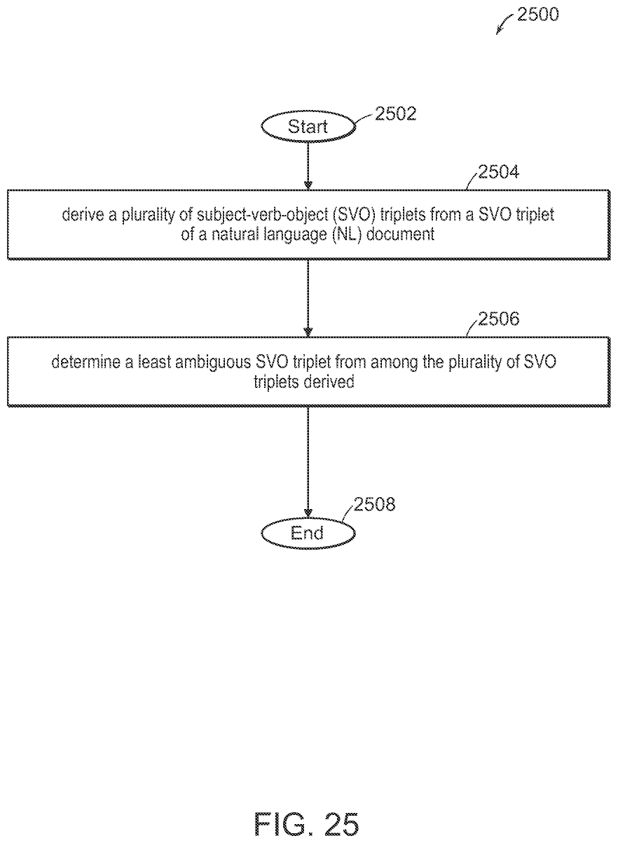

FIG. 25 is a flow diagram of a computer-implemented method 2500 for word-sense disambiguation. The computer-implemented method comprises deriving (2504) a plurality of subject-verb-object (SVO) triplets from a SVO triplet of a natural language (NL) document. The SVO triplet has a subject, verb, and object component. The deriving is based on respective multi-sense meanings for the subject, verb, and object components. The computer-implemented method further comprises determining (2506) a least ambiguous SVO triplet from among the plurality of SVO triplets derived. The least ambiguous SVO triplet represents respective meanings for the subject, verb, and object components of the SVO triplet as used within a context of the NL document. The computer-implemented method 2500 thereafter ends (2508) in the example embodiment.

The deriving may be based on respective hierarchical classifications assigned to the respective multi-sense meanings in a lexical database. The lexical database may include entries from a WordNet® database.

The entries may include noun entries, wherein the noun entries include a first set of entries describing abstractions and a second set of entries describing physical entities. The first set may be numbered prior to the second set effecting the first set of entries, describing the abstractions, to be at a higher hierarchical level relative to the second set of entries, describing the physical entities.

The noun entries may include a third set of entries describing causal agents. The third set may be numbered as a last hierarchical level of the second set of entries describing the physical entities.

The entries may include verb entries in each of the fifteen WordNet® verb categories. The verb entries may be numbered in an ascending numerical sequence from one to fifteen representing relative transitivity levels of the verb entries relative to one another, such as disclosed above with regard to FIG. 13.

The deriving may include creating a matrix in memory, such as disclose above with regard to FIG. 16. The matrix may depict at least a portion of all possible permutations resulting from the respective multi-sense meanings for the subject, verb, and object components of the SVO triplet.

The computer-implemented method may further comprise applying standard Hamiltonian mechanics to each SVO permutation in the matrix, the Hamiltonian mechanics ranking the SVOs from highest to least according to combinations of respective potential energies assigned to the subject and object components of the SVO triplet and a kinetic energy assigned to the verb component of the SVO triplet.

The determining may include applying mathematical optimization techniques to the matrix. The mathematical optimization techniques may be related to currency arbitraging. The applying enables the least ambiguous SVO triplet to be determined.

The application of mathematical optimization techniques may be commonly applied to currency arbitraging and may be employed so that token streams produced by each ambiguous SVO triplet are measured from most to least, beginning with the Hamiltonian of each, after the application of “conversion penalties” in the forms of conformance to permitted lexicographic combinations, recognized permutations in the domain of endeavor, and after the substitution of values from the subject, verb and object components attributed by anaphoric and cataphoric referencing, the highest measure being the least ambiguous.

While example embodiments disclosed herein may be applied to an application such as electronic medical records, it should be understood that example embodiments disclosed herein are not limited to same could, for non-limiting example, be employed in a double encryption application. For example, when a document has been processed in a Knowledge-Facilitator system, such as disclosed above, its contents are highly structured and available for detailed analysis. If such structured content were, in turn, encoded into, for example, the Gödel prime numbering system according to a one-time pad to produce encoded results which were then, in turn, used as a one-time pad for transmission, the ability to decode the document would be nil unless the person seeking to decode it had both the one-time pad keys. Thus, if the receiver of a Knowledge-Facilitator processed and encoded document had the one-time pads and a Knowledge-Facilitator installation, the requirements for unbreakable cryptography would be met for non-limiting example via: a transmitting analyzer, such as an ingestion NLP analyzer disclosed above, translating “text” into SVO permutations. Such a transmitting analyzer may translate “SVO permutations” into “prime gibberish” via a one-time pad key. Such “prime gibberish” may be sent via a quantum key distribution (QKD) code to a receiver which, in turn, converts the QKD code to “prime gibberish.” The receiver analyzer, such as the search instance NLP analyzer disclosed above, may be employed in the receiver and convert the “prime gibberish” to “text.” Other applications may include dynamic modeling (predicating risk from action) and logic assistance (and superseding knowledge) for non-limiting example. Example embodiments with regard to dynamic modeling are summarized below for non-limiting example.

Dynamic Modeling (Predicting Risk from Action)

The following non-limiting example embodiments apply to an application of Knowledge-Facilitator technology to the domain of action evidenced by the transfer of energy. A target domain may be selected and attributes reflecting the occurrence of destruction in the domain (model of destruction) may be assembled in columnar format which contains an entry (row) for each attribute which contributed energy involved in the destruction. Each row may focus on the actions of one actor. The first column may be the initial entropy in the critical infrastructure and key resources (CIKR) expressed as an absolute value. Each cell in each succeeding column may represent an entropy value determined at the measurement time (slice, whose unit is based on collection-cycle availability from the NLP analyzer) by deducting from the entropy value in the preceding column an enthalpy amount. The enthalpy amount may be calculated as follows:
an enthalpy value may be derived by calculating an array whose corners represent, respectively, enthalpy values of the subject (Actor), verb (Action), the object (Object) and time of creation, transfer or reception of the action (T) as described in the analyzer report; the result is stated as an absolute amount of enthalpy (“Reported Value”); and
an enthalpy value (“Projected Value”) may be similarly calculated for each possible SVO Token Category combination applicable to the Actor and the CIKR, and the greatest Projected Value may be determined among all possible SVO Token permutations,
the greater of the Reported Value or the highest value from Projected Values is selected and deducted from the preceding CIKR entropy to determine the current entropy; if the Projected Value is selected, the analyzer is instructed to reanalyze the information data to determine if an error has occurred in the Reported Value
the process is repeated until entropy in the CIKR is projected to be “0”
“NOT” counts as a full negation of both a Reported Value and a Projected Value
adjectival and adverbial attributes count: noun-adjectival phrases
when warranted by interrelationships among subject (Actor), verb (Action), the object (Object) and time of creation, transfer or reception of the action (T) (AAOT) components, each affected row may be aggregated into a system with its associated Hamiltonian by adding each overlapping component to each array for each row; adjectival and adverbial attributes from each may be assigned to every aggregated row.

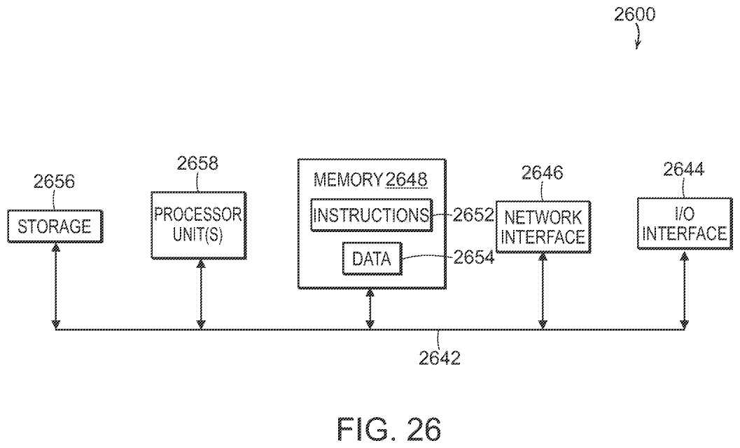

FIG. 26 is a block diagram of an example of the internal structure of a computer 2600 in which various embodiments of the present disclosure may be implemented. The computer 2600 contains a system bus 2642, where a bus is a set of hardware lines used for data transfer among the components of a computer or processing system. The system bus 2642 is essentially a shared conduit that connects different elements of a computer system (e.g., processor, disk storage, memory, input/output ports, network ports, etc.) that enables the transfer of information between the elements. Coupled to the system bus 2642 is an I/O device interface 2644 for connecting various input and output devices (e.g., keyboard, mouse, display monitors, printers, speakers, etc.) to the computer 2600. A network interface 2646 allows the computer 2600 to connect to various other devices attached to a network. Memory 2648 provides volatile or non-volatile storage for computer software instructions 2652 and data 2654 that may be used to implement embodiments (e.g., methods 1000, 1050, 1060, 1080, 2500) of the present disclosure, where the volatile and non-volatile memories are examples of non-transitory media. Disk storage 2656 provides non-volatile storage for computer software instructions 2652 and data 2654 that may be used to implement embodiments (e.g., methods 1000, 1050, 1060, 2500) of the present disclosure. A processor unit(s) 2658 is also coupled to the system bus 2642 and provides for the execution of computer instructions. For non-limiting example, the processor unit(s) may include a central processing unit (CPU), graphics processing unit (GPU), quantum processing unit (QPU), or combination.

Further example embodiments disclosed herein may be configured using a computer program product; for example, controls may be programmed in software for implementing example embodiments. Further example embodiments may include a non-transitory computer-readable-medium that contains instructions that may be executed by a processor, and, when loaded and executed, cause the processor to complete methods described herein. It should be understood that elements of the block and flow diagrams, such as disclosed in, may be implemented in software or hardware, such as via one or more arrangements of circuitry of FIG. 26, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein. It should be understood that example embodiments disclosed herein may be combined in a manner not explicitly disclosed herein.

While example embodiments have been particularly shown and described, it will be understood by those skilled in the art that various changes in form and details may be made therein without departing from the scope of the embodiments encompassed by the appended claims.

1.-40. (canceled)

41. A system comprising:
an ingestion engine including an ingestion instance of a natural language processing (NLP) analyzer, the ingestion instance configured to find document subject-verb-object (SVO) triplets in document text of a natural language (NL) document and assign initial document hierarchical classifications to the document SVO triplets found, the ingestion engine configured to:
generate variation document hierarchical classifications by varying the initial document hierarchical classifications;
select at least one document hierarchical classification from the initial and variation document hierarchical classifications; and
produce document tokens representing respective document hierarchical classifications of the at least one document hierarchical classification selected; and
a search engine configured to store the document tokens in an inverted index, the search engine including a search instance of the NLP analyzer, the search instance configured to find query SVO triplets in query text of a query and assign initial query hierarchical classifications to the query SVO triplets found, the search engine further configured to:
generate variation query hierarchical classifications by varying the initial query hierarchical classifications;
select at least one query hierarchical classification from the initial and variation query hierarchical classifications; and
produce query tokens representing respective query hierarchical classifications of the at least one query hierarchical classification selected; and
respond to the query based on results of matching the query tokens against the document tokens via the inverted index.

42. The system of claim 41, wherein the ingestion engine is further configured to pre-analyze the document to produce SVO triplets for indexing in the inverted index and output a document token stream including the document tokens, wherein the document token stream is encoded in JavaScript Object Notation (JSON) format or other data format, wherein the search engine is further configured to decode the JSON format or other data format to extract the document tokens from the document token stream and store the pre-analyzed document SVO triplets in the inverted index, wherein the document token stream includes or accompanies document metadata, wherein the document metadata includes information specifying where the NL document can be obtained, and wherein the search engine is further configured to store the document metadata in association with the document SVO triplets in the inverted index.

43. (canceled)

44. The system of claim 41, wherein the ingestion engine is further configured to produce a document token stream, wherein the document token stream includes the document tokens produced and metadata from the NL document, wherein the document token stream further includes absolute and relative locations of component words of the document SVO triplets found in the document text and associated with the at least one document hierarchical classification selected, and wherein the ingestion instance of the NLP analyzer is further configured to determine the absolute and relative locations.

45. The system of claim 41, wherein the search engine is further configured to produce a query token stream, wherein the query token stream includes the query tokens produced, wherein the query token stream further includes absolute and relative locations of component words of the query SVO triplets found in the query text and associated with the at least one query hierarchical classification selected, wherein the search instance of the NLP analyzer is further configured to determine the absolute and relative locations, and wherein the search instance of the NLP analyzer is further configured to process the query text in a same manner used by the ingestion instance to process the document text, the search instance enabling the query tokens representing the query SVO triplets and query hierarchical classifications assigned thereto to be produced in a format that is comparable to the document tokens for the matching.

46. (canceled)

47. The system of claim 41, wherein the query is received from a user and wherein the search engine is further configured to:
employ a similarity method configured to match the query tokens against the document tokens via the inverted index; and
output a response to the query, the response allowing at least a portion of the NL document to be located by the user in an event the similarity method determines that the at least a portion of the NL document is similar to the query based on the document and query hierarchical classifications assigned to the document SVO triplets and query SVO triplets, respectively, wherein the similarity method is a standard best matching (BM) 25 method, other standard best matching method, or custom similarity method.

48. (canceled)

49. The system of claim 47, wherein the at least a portion of the NL document includes at least one statement from the NL document, at least one paragraph from the NL document, a combination of the at least one statement and at least one paragraph from the NL document, or the NL document itself.

50. The system of claim 41, wherein the NLP analyzer is configured to employ a lexical database to assign the initial document hierarchical classifications and wherein the initial document hierarchical classifications assigned enable the document SVO triplets to be indexed in the inverted index based on respective categories to which component words of the document SVO triplets belong in the lexical database.

51.-73. (canceled)

74. A computer-implemented method comprising:
employing an ingestion instance of a natural language processing (NLP) analyzer to find document subject-verb-object (SVO) triplets in document text of a natural language (NL) document and assign initial document hierarchical classifications to the document SVO triplets found;
generating variation document hierarchical classifications by varying the initial document hierarchical classifications assigned;
selecting at least one document hierarchical classification from the initial document hierarchical classifications and the variation document hierarchical classifications;
producing document tokens representing respective document hierarchical classifications of the at least one document hierarchical classification selected;
storing the document tokens in an inverted index;
employing a search instance of the NLP analyzer to find query SVO triplets in query text of a query and assigning initial query hierarchical classifications to the query SVO triplets found;
generating variation query hierarchical classifications by varying the initial query hierarchical classifications assigned;
selecting at least one query hierarchical classification from the initial query hierarchical classifications and the variation query hierarchical classifications;
producing query tokens representing respective query hierarchical classifications of the at least one query hierarchical classification selected; and
responding to the query based on results of matching the query tokens against the document tokens via the inverted index.

75. The computer-implemented method of claim 74, further comprising:
pre-analyzing the document SVO triplets for indexing in the inverted index;
encoding a document token stream in JavaScript Object Notation (JSON) format or other data format, the document token stream including the document tokens;
decoding the JSON format or other data format to extract the document tokens from the document token stream encoded; and
storing the pre-analyzed document SVO triplets in the inverted index, wherein the document token stream includes or accompanies document metadata, wherein the document metadata includes information specifying where the NL document can be obtained, and wherein the computer-implemented method further comprises storing the document metadata in association with the document SVO triplets in the inverted index.

76. (canceled)

77. The computer-implemented method of claim 74, further comprising producing a document token stream, the document token stream including the document tokens produced and metadata from the NL document, the document token stream further including absolute and relative locations of component words of the document SVO triplets found in the document text and associated with the at least one document hierarchical classification selected, and wherein the computer implemented method further comprises determining, by the ingestion instance of the NLP analyzer, the absolute and relative locations.

78. The computer-implemented method of claim 74, further comprising producing a query token stream, wherein the query token stream includes the query tokens produced, wherein the query tokens include absolute and relative locations of component words of the query SVO triplets found in the query text and associated with the at least one query hierarchical classification selected, and wherein the computer-implemented method further comprising determining, by the search instance of the NLP analyzer, the absolute and relative locations.

79. The computer-implemented method of claim 74, further comprising processing, by the search instance of the NLP analyzer, the query text in a same manner used by the ingestion instance to process the document text, enabling the query tokens to be produced in a format that is comparable to the document tokens for the matching.

80. The computer-implemented method of claim 74, wherein the query is received from a user and the computer-implemented method further comprises:
employing a similarity method to match the query tokens against the document tokens via the inverted index; and
outputting a response to the query, the response allowing at least a portion of the NL document to be located by the user in an event the similarity method determines that the at least a portion of the NL document is similar to the query based on the document and query hierarchical classifications assigned to the document SVO triplets and query SVO triplets, respectively.

81. (canceled)

82. The computer-implemented method of claim 80, wherein the similarity method is a standard best matching (BM) 25 method, other standard best matching method, or custom similarity method, and wherein the at least a portion of the NL document includes at least one statement from the NL document, at least one paragraph from the NL document, a combination of the at least one statement and at least one paragraph from the NL document, or the NL document itself.

83. The computer-implemented method of claim 74, further comprising employing, by the NLP analyzer, a lexical database to assign the initial document hierarchical classifications, wherein the initial document hierarchical classifications assigned enable the document SVO triplets to be indexed in the inverted index based on respective categories to which component words of the document SVO triplets belong in the lexical database, and wherein the variation document hierarchical classifications enable variations of the document SVO triplets to be indexed in the inverted index based on respective categories to which component words of the document SVO triplets belong in the lexical database.

84.-111. (canceled)

112. A non-transitory computer-readable medium having encoded thereon a sequence of instructions which, when loaded and executed by at least one processor, causes the at least one processor to:
employ an ingestion instance of a natural language processing (NLP) analyzer to find document subject-verb-object (SVO) triplets in document text of a natural language (NL) document and assign initial document hierarchical classifications to the document SVO triplets found;
generate variation document hierarchical classifications by varying the initial document hierarchical classifications assigned;
select at least one document hierarchical classification from the initial document hierarchical classifications and the variation document hierarchical classifications;
produce document tokens representing respective document hierarchical classifications of the at least one document hierarchical classification selected;
store the document tokens in an inverted index;
employ a search instance of the NLP analyzer to find query SVO triplets in query text of a query and assigning initial query hierarchical classifications to the query SVO triplets found;
generate variation query hierarchical classifications by varying the initial query hierarchical classifications assigned;
select at least one query hierarchical classification from the initial query hierarchical classifications and the variation query hierarchical classifications;
produce query tokens representing respective query hierarchical classifications of the at least one query hierarchical classification selected; and
respond to the query based on results of matching the query tokens against the document tokens via the inverted index.

113. The system of claim 41, wherein:
an initial document hierarchical classification of the initial document hierarchical classifications assigned includes an initial document subject hierarchical classification, initial document verb hierarchical classification, and initial document object hierarchical classification assigned to a document subject, document verb, and document object, respectively, of a document SVO triplet of the document SVO triplets found, and wherein the initial document subject, document verb, and document object hierarchical classifications represent an initial document subject sense, initial document verb sense, and initial document object sense for the document subject, document verb, and document object, respectively, of the document SVO triplet; and
an initial query hierarchical classification of the initial query hierarchical classifications assigned includes an initial query subject hierarchical classification, initial query verb hierarchical classification, and initial query object hierarchical classification assigned to a query subject, query verb, and query object, respectively, of a query SVO triplet of the query SVO triplets found, and wherein the initial query subject, query verb, and query object hierarchical classifications represent an initial query subject sense, initial query verb sense, and initial query object sense for the query subject, query verb, and query object, respectively, of the query SVO triplet.

114. The computer-implemented method of claim 74, wherein:
an initial document hierarchical classification of the initial document hierarchical classifications assigned includes an initial document subject hierarchical classification, initial document verb hierarchical classification, and initial document object hierarchical classification assigned to a document subject, document verb, and document object, respectively, of a document SVO triplet of the document SVO triplets found, and wherein the initial document subject, document verb, and document object hierarchical classifications represent an initial document subject sense, initial document verb sense, and initial document object sense for the document subject, document verb, and document object, respectively, of the document SVO triplet; and
an initial query hierarchical classification of the initial query hierarchical classifications assigned includes an initial query subject hierarchical classification, initial query verb hierarchical classification, and initial query object hierarchical classification assigned to a query subject, query verb, and query object, respectively, of a query SVO triplet of the query SVO triplets found, and wherein the initial query subject, query verb, and query object hierarchical classifications represent an initial query subject sense, initial query verb sense, and initial query object sense for the query subject, query verb, and query object, respectively, of the query SVO triplet.

115. The system of claim 41, wherein the search engine is further configured to employ a similarity method configured to match the query tokens against the document tokens via the inverted index, wherein the similarity method is configured to:
determine respective depths of the initial document hierarchical classifications assigned, variation document hierarchical classifications generated, initial query hierarchical classifications assigned, and variation query hierarchical classifications generated, the respective depths determined being relative to a root of a hierarchy and representing respective indicators of word specificity; and
produce a score indicating greater similarity for matches among words with a higher word specificity and lesser similarity for matches among words with a lower word specificity, the lower word specificity lower relative to the higher word specificity.

116. The computer-implemented method of claim 74, further comprising employing a similarity method to match the query tokens against the document tokens via the inverted index, wherein the similarity method includes:
determining respective depths of the initial document hierarchical classifications assigned, variation document hierarchical classifications generated, initial query hierarchical classifications assigned, and variation query hierarchical classifications generated, the respective depths being relative to a root of a hierarchy and representing respective indicators of word specificity; and
producing a score indicating greater similarity for matches among words with a higher word specificity and lesser similarity for matches among words with a lower word specificity, the lower word specificity lower relative to the higher word specificity.
